(19) United States
(12) Patent Application Publication
(10) Pub. No.: US 2026/0096562 A1
(43) Pub. Date: Apr. 9, 2026

(54) SELF-EMULSIFIABLE CONCENTRATE

(71) Applicant: BIOTALYS NV, Sint-Denijs-Westrem (BE)

(72) Inventors: Elias Willy Lucien VANDEPUTTE, Sint-Denijs-Westrem (BE); Jan Jozef Lutgart GEERINCK, Sint-Denijs-Westrem (BE)

(21) Appl. No.: 19/144,009

(22) PCT Filed: Dec. 29, 2023
(86) PCT No.: PCT/EP2023/087981

§ 371 Date: Jun. 27, 2025

(30) Foreign Application Priority Data
Dec. 30, 2022 (EP) 22217328.8

(51) Int. Cl. A01N 63/50; A01N 25/04; A01P 1/00

(52) U.S. Cl. CPC A01N 63/50; A01N 25/04; A01P 1/00

(57) ABSTRACT

The invention relates to a self-emulsifiable concentrate comprising a protein-containing composition. The self-emulsifiable concentrates of this invention are suitable for application in agriculture for example as crop protection products. More specifically there are provided self-emulsifiable concentrates comprising a protein-containing composition wherein the protein-containing composition is derived from a microbial fermentation comprising dry matter containing a bioactive protein. The self-emulsifiable concentrates of the invention may contain a bioactive protein such as for example a VHH. The invention further relates to an agrochemical composition and a process for preparing said agrochemical composition using the self-emulsifiable concentrate of the invention. Finally, the invention relates to a method for protecting or treating a plant or a part of the plant from an infection or other biological interaction with a plant pathogen and where said method may be a post-harvest treatment method.

### FIELD OF THE INVENTION

The invention relates to formulations that may be used in agriculture. More specifically, the invention relates to self-emulsifiable concentrations or oil dispersions comprising a protein-containing composition.

### BACKGROUND

Agricultural formulations are generally designed based on customer need and the physiochemical properties of the active ingredient(s). Liquid formulations are generally preferred over solid formulations by customers due to their ease of handling in measuring, pumping, diluting and spraying operations.

Oil dispersions (OD) are one type of liquid formulation and are defined as stable suspensions of active ingredients in a water-immiscible fluid which may contain other dissolved active ingredients and is intended for dilution with water before use. OD allows the formulation of active ingredients in solid suspended form, which ingredients cannot be formulated in water because of hydrolytic instability. Recently, OD formulations have been the subject of studies by companies and formulators because of their advantages with respect to the agronomic performance in the field. In addition to customer preferences for liquid formulations, oil dispersion formulations are very suitable for the following scenarios: (1) water sensitive active ingredients, 2) compatibility issues with active ingredient mixtures and 3) the need for build-in adjuvancy. For example, agricultural biologicals have been becoming increasingly popular tools to combat plant pests, stimulate plant growth, increase plant stress resistance, and increase crop yields. These biologicals, be it microbial strains, bioactive proteins or extracts from microbial cultures, often suffer from degradation by for example oxidation or spoilage due to contaminations when stored in a liquid form. Such products would benefit greatly from alternative storage solutions such as oil dispersions.

The basic components of an agrochemical OD formulation are the oil phase and the dispersed solid phase. These basic components may include active ingredients, and agrochemically acceptable excipients such as naturally derived solvents, safeners, rheology modifiers, emulsifiers, dispersants and other co-formulants that help deliver the desired attributes of the product.

Physico-chemical stability is the biggest concern while formulating OD. The above mentioned agrochemically acceptable excipients play a major role in developing stable OD formulations.

A disadvantage of the existing OD formulations is that such formulations frequently show phase separation after storage. Thus, storage even at ambient temperatures frequently leads to aggregation effects, lump formation or pronounced settling of the suspended phase. In the worst cases, the effects are irreversible, i.e. even shearing, for example by stirring, cannot re-homogenize the formulation. The stability of the oil dispersions is related to the obtainment of formulations without turbidity, crystallization, phase separation or decomposition of the active ingredient, and the stability of the aqueous dispersions is related to the time during which the same can be used for crop spraying without visually noticeable separation of the phases or decomposition or other chemical changes of the active ingredient.

To avoid phase separation and the problems associated with this as illustrated above, thickening agents or rheology modifiers may be used. The handling of most of these thickeners is very difficult and/or harmful because they are mainly very fine and light powders. Furthermore, it is difficult to dissolve and homogenize them while avoiding the formation of gels or lumps and continued and careful monitoring of the process is required. Additionally, thickening agents often require high sheer forces or high temperatures to be incorporated into the oil-dispersion. Solutions to solving the problem of phase separation can be found in, for example, WO2020126508A1 which describes an oil dispersion that was stabilized in the absence of a thickening agent by emulsifying water droplets into the oil phase.

However, in instances such as where the active ingredient is a bioactive protein, a need still exists to develop OD with a reduced content of a thickening agents or alternative forms to provide the necessary thickening for the OD and to allow the OD and the active ingredients such as a bioactive protein to be stable for longer periods of time.

### SUMMARY OF THE INVENTION

The inventors have developed a self-emulsifiable concentrate, also known as an “oil dispersion formulation”, “oil dispersion” or “OD” in short. The self-emulsifiable concentrate of the invention comprises an oil vehicle, and one or more dispersants, and one or more emulsifiers; and is characterized in that the self-emulsifiable concentrate further comprises a protein-containing composition, wherein the protein-containing composition is in an essentially solid state, wherein the protein-containing composition is dispersed in the oil vehicle, and wherein the self-emulsifiable concentrate comprises no more than 10% w/w, preferably no more than 5% w/w, even more preferably no more than 2.5% w/w, even more preferably no more than 2% w/w, most preferably no more than 1% w/w of a thickening agent other than the protein-containing composition.

It was surprisingly found that the protein-containing composition in the self-emulsifiable concentrate can act as a thickening agent. As such when preparing a self-emulsifiable concentrate containing a protein containing composition the amount of thickening agent to be added can be reduced or even no thickening agent needs to be added to the self-emulsifiable concentrate.

It was further found that the self-emulsifiable concentrate is particularly suitable for formulating protein based bioactives such as for example an immunoglobin single variable domain. Formulating bioactive proteins in an oil vehicle in the form of a self-emulsifiable concentrate greatly increases the stability of the bioactive protein.

It was further found that the self-emulsifiable concentrate is advantageous for incorporating dried protein-containing compositions derived from a microbial fermentation broth since the incorporation into an oil vehicle prevents the degradation or spoilage of the microbial fermentation broth hereby providing a convenient way of storing and shipping dried microbial fermentation broth compositions.

Further provided is a method for preparing the self-emulsifiable concentrate of the invention including the steps of, (i) optionally heating the oil vehicle to a temperature between 60° C. and 90° C. preferably the oil vehicle is heated to about 85° C.-90° C., (ii) incorporating up to 10% w/w of a thickening agent, other than the protein-containing composition, by mixing it with the heated oil vehicle, optionally by mixing at low shear force, (iii) if heated in step i, cooling the oil vehicle, (iv) adding the one or more dispersants to the oil vehicle, (v) adding the one or more emulsifiers to the oil vehicle, (vi) optionally further adding one or more, surface stabilizing agents, adjuvants, additives, filling materials, colorants, antioxidants, preservatives, antifoam substances, or combinations thereof, (vii) adding the protein-containing composition to the oil vehicle, wherein the protein-containing composition becomes dispersed in the oil vehicle.

Further provided is a method for preparing the self-emulsifiable concentrate of the invention including the steps of, (i) optionally heating the oil vehicle to a temperature in the range of 60° C. to 90° C., preferably the oil vehicle is heated to a temperature in the range of about 85° C. to 90° C., (ii) incorporating up to 10% w/w of a thickening agent, other than the protein-containing composition, by mixing it with the heated oil vehicle, optionally by mixing at low shear force, (iii) if heated in step i, cooling the oil vehicle, (iv) adding the one or more dispersants to the oil vehicle, (v) adding the one or more emulsifiers to the oil vehicle, (vi) optionally further adding one or more, surface stabilizing agents, adjuvants, additives, filling materials, colorants, antioxidants, preservatives, antifoam substances, or combinations thereof, (vii) adding the protein-containing composition to the oil vehicle, wherein the protein-containing composition becomes dispersed in the oil vehicle.

Further provided is an alternative method for producing a self-emulsifiable concentrate including the steps of (i) providing the oil vehicle, (ii) adding the one or more dispersants to the oil vehicle, (iii) adding the one or more emulsifiers to the oil vehicle, (iv) optionally further adding one or more emulsifiers, surface stabilizing agents, adjuvants, filling materials, colorants, antioxidants, preservatives, antifoam substances, or combinations thereof; (v) adding the protein-containing composition, wherein the protein-containing composition becomes dispersed in the oil vehicle and (vi) optionally incorporating no more than 10% w/w, preferably no more than 5% w/w, even more preferably no more than 2.5% w/w, even more preferably no more than 2% w/w, most preferably no more than 1% w/w of a thickening agent, other than the protein-containing composition, by mixing, optionally by mixing at low shear force.

Further provided is the use of the self-emulsifiable concentrate of the invention for the treatment or prevention of plant pathogenic infections.

Further provided is the use of the self-emulsifiable concentrate of the invention to improve the fitness of a crop, improve the stress resistance of a crop, improve the yield of a crop and/or improve the resistance of the crop to infections.

Further provided is a method comprising emulsifying the self-emulsifiable concentrate of the invention by mixing it with an aqueous solution, thereby producing an emulsified solution, and applying the emulsified solution to one or more plants.

Also provided is a kit of parts, comprising an oil vehicle, one or more dispersants, one or more emulsifiers, optionally one or more of surface stabilizing agents, adjuvants, additives, filling materials, colorants, antioxidants, preservatives, antifoam substances, or combinations thereof; the kit of parts further comprises a protein-based composition which is essentially in a solid state and f instructions for preparing a self-emulsifiable concentrate in which the protein-containing composition is dispersed in the oil vehicle and, if present, the thickening agent is present in an amount of no more than 10% w/w, preferably no more than 5% w/w, even more preferably no more than 2.5% w/w, even more preferably no more than 2% w/w, most preferably no more than 1% w/w.

Further provided is the use of the self-emulsifiable concentrate for the treatment or prevention of a plant pathogenic infection. Where the self-emulsifiable concentrate contains for example a bioactive protein such as an immunoglobulin single variable domain, the self-emulsifiable concentrate after being emulsified in an aqueous composition can be used to for the treatment or prevention of a plant pathogenic infection on a plant or a part of the plant. The self-emulsifiable concentrate may be emulsified by mixing it with an aqueous solution, thereby producing an emulsified solution that may be applied to one or more plants.

Further is provided an agrochemical composition comprising the self-emulsifiable concentrate according to claims emulsified in water, and optionally one or more tank mix additives.

Further is provide a method for protecting or treating a plant or a part of the plant from an infection or other biological interaction with a plant pathogen, at least comprising the step of applying directly or indirectly to the plant or to a part of the plant the agrochemical composition according to the invention, under conditions effective to protect or treat the plant or a part of the plant against the infection or biological interaction with the plant pathogen.

Further is provided a post-harvest treatment method for protecting or treating a harvested plant or a harvested part of the plant from an infection or other biological interaction with a plant pathogen, at least comprising the step of applying directly or indirectly to the harvested plant or to a harvested part of the plant the agrochemical composition according to the invention, under conditions effective to protect or treat the harvested plant or a harvested part of the plant against the infection or biological interaction with the plant pathogen.

### BRIEF DESCRIPTION OF THE DRAWINGS

FIG. 1: Example of a self-emulsifiable concentrate.

FIG. 2: Self-emulsifiable concentrate S1 after 2 weeks at 54° C. Black line indicates air-liquid interface.

FIG. 3: Analyzed samples and their corresponding lanes. From left to right, MW ladder, dried microbial fermentation product, traditional dried formulation, self-emulsifiable concentrate.

FIG. 4: A series of self-emulsifiable concentrate comprising an increasing amount of thickening agent. From left (bottom) to right (top) 0%, 0.5%, 1% and 1.5% of thickening agent is added.

FIG. 5: Self-emulsifiable Samples 1 to 6 (see Table 6) with increasing concentrations of protein-containing composition from left to right from 0% (w/w), 10% (w/w), 20% (w/w), 30% (w/w), 40% (w/w) and 44% (w/w). After 2 days of storage at room temperature

FIG. 6: FIG. 5 after 7 days at room temperature.

FIG. 7: self-emulsifiable concentrates according to combinations 3, 4 and 5 (see Table 6; Samples 13, 14 and 15 respectively).

FIG. 8: Self-emulsifiable concentrates OD 3.1, OD 4.1, OD 5.1 as described in Table 7.

FIG. 9: Self-emulsifiable concentrates 13-4 (left) and 13-5 (right) as described in Table 7.

FIG. 10: Self-emulsifiable concentrates 13-6 (2 samples) as described in Table 7.

FIG. 11: Self-emulsifiable concentrates 13-7 (right) and 13-8 (left) as described in Table 7.

FIG. 12: Self-emulsifiable concentrates 13-9 as described in Table 7.

FIG. 13: Self-emulsifiable concentrates from left to right 13-12 and 13-13, 13-10, 13-11 as described in Table 7.

FIG. 14: Self-emulsifiable concentrates 13-15 (left) and 13-14 (right) as described in Table 7.

FIG. 15: Analyzed samples (SDS PAGE). From left to right, MW ladder, well 1 control VHH, well 3 and 4 VHH bioactive protein as present in the self-emulsifiable concentrate OD 3.1, well 6 and 7 VHH bioactive protein as present in the self-emulsifiable concentrate OD 4.1, well 9 and 10 VHH bioactive protein as present in the self-emulsifiable concentrate OD 5.1 as described in Table 7.

FIG. 16: Analyzed samples (SDS PAGE). Sample IDs (according to Table 7) 13-4 and 13-5 (wells 5 and 6), 13-7 and 13-8 (wells 7 and 8), 13-10 and 13-11 (wells 9 and 10), 13-14 and 13-15 (wells 11 and 12). Well 1: standard 1 mg/ml VHH, well 2: standard 2 mg/ml VHH, well 3: standard 4 mg/ml VHH.

FIG. 17: Analyzed samples (SOS PAGE). Sample IDs 13-12 and 13-13 (wells 5 and 6). Well 1: standard 1 mg/mi VHH, well 2: standard 2 mg/mi VHH, well 3: standard 4 mg/mi VHH.

FIG. 18: Analyzed samples (SDS PAGE). From left to right, MW ladder, standard 1 mg/mi VHH, standard 2 mg/mi VHH, standard 4 mg/mi VHH, VHH bioactive protein as present in the self-emulsifiable concentrate 13-6 as described in Table 7 and after 2 years of storage at room temperature.

### DESCRIPTION OF THE SEQUENCE LISTING

Amino acid sequence

| Name | SEQ ID | VHH Amino acid sequence |
|---|---|---|
| VHH-1 | 1 | DVQLVESGGGLVQAGGSLRLSCAASRSIFSINAMDWYRQAPGKQREWVAGITRGGTTKYADSVK |
| | | GRFTISRDNAKKKVYLQMNSLKPEDTAVYYCNVLRGEQPWTRDYWGQGTQVTVSS |
| VHH-1Q | 2 | QVQLVESGGGLVQAGGSLRLSCAASRSIFSINAMDWYRQAPGKQREWVAGITRGGTTKYADSVK |
| | | GRFTISRDNAKKKVYLQMNSLKPEDTAVYYCNVLRGEQPWTRDYWGQGTQVTVSS |
| VHH-1 | 3 | RSIFSINAMD |
| CDR1 | | |
| VHH-1 | 4 | GITRGGTTK |
| CDR2 | | |
| VHH-1 | 5 | LRGEQPWTRDY |
| CDR3 | | |
| VHH-2 | 6 | QVQLQESGGGLVQAGGSLRLSCAASGTIFRPTAMGWYRQAPGKERELVATITTGGSTKYADSVK |
| | | GRFTISRGNAKNTVYLQMSSLKPEDTAVYYCNAQWGVRTRDYWGQGTQVTVSS |
| VHH-2 | 7 | GTIFRPTAMG |
| CDR1 | | |
| HH-2 | 8 | TITTGGSTK |
| CDR2 | | |
| VHH-2 | 9 | QWGVRTRDY |
| CDR3 | | |
| VHH-3 | 10 | QVQLQESGGGLVQAGDSLRLSCAASISDRAFSRHVMGWFRQPPGKEREFVAAIGWTGRRTYYA |
| | | DSVKGRFTISRDNAMNTVYLQMNSLKPEDTAVYYCAASHFYSVSFEINDYDYWGQGTQVTVSS |
| VHH-3 | 11 | ISDRAFSRHV |
| CDR1 | | |
| VHH-3 | 12 | AIGWTGRRTY |
| CDR2 | | |
| VHH-3 | 13 | SHFYSVSFEINDYDY |
| CDR3 | | |
| VHH-2D | 14 | DVQLQESGGGLVQAGGSLRLSCAASGTIFRPTAMGWYRQAPGKERELVATITTGGSTKYADSVK |
| | | GRFTISRGNAKNTVYLQMSSLKPEDTAVYYCNAQWGVRTRDYWGQGTQVTVSS |
| VHH-3D | 15 | DVQLQESGGGLVQAGDSLRLSCAASISDRAFSRHVMGWFRQPPGKEREFVAAIGWTGRRTYYA |
| | | DSVKGRFTISRDNAMNTVYLQMNSLKPEDTAVYYCAASHFYSVSFEINDYDYWGQGTQVTVSS |
| VHH-4 | 16 | QVQLQESGGGLVQAGGSLRLSCVASGTTFSSYTMGWYRQAPGKQRELLASIEGGGNTDYADSV |
| | | KGRFTISRDNARNTVYLQMNSLKTEDTAVYYCNAARTWSIFRNYWGQGTQVTVSS |
| VHH-5 | 17 | QVQLQESGGGLVQAGGSLRLSCAASGRTFSRYGMGWFRQLPGKQRELVTSITRGGTTTYADSV |
| | | KGRFTISRDNAKNTVYLQMNSLKPEDTAVYYCNARSIWRDYWGQGTQVTVSS |
| VHH-6 | 18 | QVQLQESGGGLVQAGGSLRLSCAASGGIFGINAMRWYRQAPGKQRELVASISSGGNTNYSESVK |
| | | GRFTISRDDANYTVYLQMNSLKPEDTAVYYCNFVRLWFPDYWGQGTQVTVSS |
| VHH-7 | 19 | QVQLQESGGGLVQPGGSLTLSCAATKTGFSINAMGWYRQAPGKQREMVATITSGGTTNYADSV |
| | | KGRFAISRDNAKNTVSLQMNTLKPEDTALYYCNTEARRYFTRASQVYWGQGTQVTVSS |
| VHH-8 | 20 | QVQLQESGGGLVQPGGSLRLSCAASGGIFSINAMGWYRQDPGKQREMVATITSGANTNYTDSVK |
| | | GRFTISRDNAKNTVYLQMNSLKPEDTAVYYCNAVGRRWYGGYVELWGQGTQVTVSS |
| VHH-9 | 21 | QVQLQESGGGLVQPGGSLRLSCAASGSIFSTYVMGWYRQAIGKQRELVATITSSGKTNYAASVK |
| | | GRFTVSRDITKNTMYLQMNSLKPEDTAVYYCGADRWVLTRWSNYWGQGTQVTVSS |
| VHH-10 | 22 | QVQLQESGGGLVQPGGSLRLSCAASGSISSLGWYRQAPGKQREFVASATSGGDTTYADSVKGR |
| | | FTISRDNSKNTVYLQMNSLKPEDTAVYYCKGQRGVAWTRKEYWGQGTQVTVSS |
| VHH-11 | 23 | QVQLQESGGGLVQPGGSLRLSCAASGSIFSTYAMGWYRQAIGKQRELVATITSSGKTNYAASVK |
| | | GRFTISRDITKNTMYLQMNSLKPEDTAVYYCGADRWVLTRWSNYWGQGTQVTVSS |
| VHH-12 | 24 | QVQLQESGGGLVQPGGSLRLSCTASGNIVNIRDMGWYRQVPGKQRELVATITSDQSTNYADSVK |
| | | GRFTTTRDNAKKTVYLQMDSLKPEDTAGYYCNARVRTVLRGWRDYWGQGTQVTVSS |
| VHH-13 | 25 | QVQLQESGGGLVQPGGSLRLSCAASGSIFSINAMGWYRQAPGKQRELVAAITSDGSTNYADSVK |
| | | GRFTISRDNAKNTAYLQMNSLKPEDTAVYYCNLRRRTFLKSSDYWGQGTQVTVSS |
| VHH-14 | 26 | QVQLQESGGGLVQAGDSLRLSCAASGRRFGSYAMGWFRQVPGKERELVAGISSGGSTKYADSV |
| | | RGRFTISRDNAKNTVSLQMKSLKPEDTAVYYCNAKYGRWTYTGRPEYDSWGQGTQVTVSS |
| VHH-15 | 27 | QVQLQESGGGLVQPGGSLRLSCAASGSIFSSDTMGWYRRAPGKQRELVAAITTGGNTNYADSVK |
| | | GRFTISRDNAKNTVYLQMNSLQPEDTAVYYCNCRRRWSRDFWGQGTQVTVSS |
| VHH-16 | 28 | QVQLQESGGGLVQPGGSLRLSCAASGTIFSIKTMGWYRQAPGKQRELVATISNGGSTNYADSVK |
| | | GRFTISRDNAKNTVYLQMNSLKPEDTAVYYCNARQQFIGAPYEYWGQGTQVTVSS |
| VHH-17 | 29 | QVQLQESGGGLVQAGGSLRLSCTASGAITFSLGTMGWYRQAPGKQRELVASISTGSTNYADSVK |
| | | GRFTISRDIIKNILYLQMNSLKPEDTAVYSCNARLLWSNYWGQGTQVTVSS |
| VHH-18 | 30 | QVQLQESGGGLVQAGESLRLSCAASGSTFSINVMGWYRQAPGEQRELVATISRGGSTNYADSVK |
| | | GRFTISRDNAKVTVYLQMDSLKPEDTAVYYCNAAGWVGVTNYWGQGTQVTVSS |
| VHH-19 | 31 | QVQLQESGGGLVQAGGSLRLSCAASGSTGSISAMGWYRQAPGKQRELVASITRRGSTNYADSV |
| | | KDRFTISRDNAWNTVYLQMNSLKPEDTAVYYCNARRYYTRNDYWGQGTQVTVSS |
| VHH-20 | 32 | QVQLQESGGGLGQAGGSLRLSCEVSGTTFSINTMGWHRQAPGKQRELVASISSGGWTNYADSV |
| | | KGRFTISRDNAKKTVYLQMNNLKPEDTAVYYCRWGAIGNWYGQGTQVTVSS |
| VHH-21 | 33 | QVQLQESGGGLVQPGGSLRLSCAASVRIFGLNAMGWYRQGPGKQRELVASITTGGSTNYAEPV |
| | | KGRFTISRDNANNTVYLQMNNLKPEDTAVYYCNAERRWGLPNYWGQGTQVTVSS |
| VHH-22 | 34 | QVQLQESGGGLVEAGGSLRLSCAASGRTFSRYGMGWFRQAPGKEREFVAANRWSGGSTYYAD |
| | | SVRGRFTISRDNAKNTVYLQMNSLKPEDTAVYYCAAYAHITAWGMRNDYEYDYWGQGTQVTVS |
| | | S |
| VHH-23 | 35 | QVQLQESGGGLVQAGGSLRLSCAATGRTFSRYTMGWFRQAPGKERDFVAGITWTGGSTDYADS |
| | | VKGRFTISRDNAKNTVYLQMNSLKPEDTAVYYCAAGNLLRLAGQLRRGYDSWGQGTQVTVSS |
| VHH-24 | 36 | QVQLQESGGGLVQAGGSLRLSCAASGRTGSRYAMGWFRQAPGKEREFVAAISWSGGSTYYAD |
| | | SVKDRFTISRDNAKNTVYLQMHSLKPEDTAVYYCATRNRAGPHYSRGYTAGQEYDYWGQGTQV |
| | | TVSS |
| VHH-25 | 37 | QVQLQESGGGLVQPGGSLRLSCAASGRIFSINAMGWYRQGPGKERELVVDMTSGGSINYADSV |
| | | SGRFTISRDNAKNTVYLQMNSLKPEDTAVYYCHANLRTAFWRNGNDYWGQGTQVTVSS |
| VHH-26 | 38 | QVQLQESGGGLVQPGGSLRLSCAASGSISSINAMGWYRQAPGKQRELVASITSGGSTNYADSVK |
| | | GRFTISRDNAKNTVNLQMNSLKPEDTAVYYCSAGPWYRRSWGRGTQVTVSS |
| VHH-27 | 39 | QVQLQESGGGLVQPGESLRLSCAASASIFWVNDMGWYRQAPGKQRELVAQITRRGSTNYADSV |
| | | KGRFTISRDNAKDEVYLQMNSLKPEDTAVYYCNADLAVRGRYWGQGTQVTVSS |
| VHH-28 | 40 | QVQLQESGGGLVQPGGSLRLSCAASGSFFPVNDMAWYRQALGNERELVANITRGGSTNYADSV |
| | | KGRFTISRDNAKNTVYLQMNTLKPEDTAVYYCNVRIGFGWTAKAYWGQGTQVTVSS |
| VHH-29 | 41 | QVQLQESGGGLVQPGGSLRLSCAASGGIFGINAMRWYRQAPGKQRELVASISSGGNTNYSESVK |
| | | GRFTISRDDANYTVYLQMNSLKPEDTAVYYCNFVRLWFPDYWGQGTQVTVSS |
| VHH-30 | 42 | QVQLQESGGGLVQPGGSLRLSCAASGSTIRINAMGWYRQAPGKQRELVATITRGGITNYADSVK |
| | | GRFTISRDNAKFTVYLQMNSLKPEDTAVYYCNARSWVGPEYWGQGTQVTVSS |
| VHH-31 | 43 | QVQLQESGGGLVQPGGSLRLSCAASGMTYSIHAMGWYRQAPGKERELVAITSTSGTTDYTDSVK |
| | | GRFTISRDGANNTVYLQMNSLKSEDTAVYYCHVKTRTWYNGKYDYWGQGTQVTVSS |
| VHH-32 | 44 | QVQLQESGGGLVQPGGSLRLSCTASGSIFSINPMGWYRQAPGKQRELVAAITSGGSTNYADYVK |
| | | GRFTISRDNAKNVVYLQMNSLKPEDTAVYYCNGRSTLWRRDYWGQGTQVTVSS |
| VHH-33 | 45 | QVQLQESGGGLVQPGGSLRLSCAASGSIFSINTMGWYRQAPGKQRELVAAITNRGSTNYADFVK |
| | | GRFTISRDNAKNTVYLQMNSLKPDDTAVYYCNAHRSWPRYDSWGQGTQVTVSS |
| VHH-34 | 46 | QVQLQESGGGLVQPGGSLRLSCAASGSIFSFNAMGWYRQAPGKQRELVAAITRGGSTNYADSV |
| | | KGRFTISRDNANNTVYLQMNSLKPEDTAVYYCNAESRIFRRYDYWGPGTQVTVSS |
| VHH-35 | 47 | QVQLQESGGGLVQPGGSLRLSCVTSGSIFGLNLMGWYRQAPGKQRELVATITRGGSTNYADSVK |
| | | GRFTISRDNAKKTVYLQMNSLKPEDTAVYYCNVDRGWSSYWGQGTQVTVSS |
| VHH-36 | 48 | QVQLQESGGGLVQPGGSLRLSCVTSGSIRSINTMGWYRQAPGNERELVATITSGGTTNYADSVK |
| | | NRFTISRDNAKNTVYLQMNSLKPEDTAVYYCNLHQRAWARSYVYWGQGTQVTVSS |
| VHH-37 | 49 | QVQLQESGGGSVQPGGSLRLSCAASGSIFAVNAMGWYRQAPGHQRELVAIISSNSTSNYADSVK |
| | | GRFTISRDNAKNTVYLQMNSLKPEDTAVYFCYAKRSWFSQEYWGQGTQVTVSS |
| VHH-38 | 50 | QVQLQESGGGLVQPGGSLRLSCAASGSIFSFNLMGWYRQAPGKQRELVAAITSSSNTNYADSVK |
| | | GRFTISRDNAKNTVYLQMNSLKPEDTAVYYCNAQYTITPWGIKKDYWGQGTQVTVSS |
| VHH-39 | 51 | QVQLQESGGGLMQPGGSLRLSCTASGNIVNIRDMGWYRQVPGKQRELVATITSDQSTNYADSVK |
| | | GRFTTTRDNAKKTVYLQMDSLKPEDTAGYYCNARVRTVLRGWRDYWGQGTQVTVSS |
| VHH-40 | 52 | QVQLQESGGGLVQPGESLRLSCVGSGSIFNINSMNWYRQASGKQRELVADMRSDGSTNYADSV |
| | | KGRFTISRDNARKTVYLQMNSLKPEDTAVYYCHANSIFRSRDYWGQGTQVTVSS |
| VHH-41 | 53 | QVQLQESGGGVVQAGDSLRLSCAASGRTFGGYTVAWFRQAPGKEREFVARISWSGIMAYYAES |
| | | VKGRFTISRDNAKNTVYLQMNSLKPEDTAVYYCASRSQIRSPWSSLDDYDRWGQGTQVTVSS |
| VHH-42 | 54 | QVQLQESGGGLVQPGGSLRLSCVVSGSISSMKAMGWHRQAPGKERELVAQITRGDSTNYADSV |
| | | KGRFTISRDNAKNTVYLQMNSLKPDDTGVYYCNADRFFGRDYWGKGTQVTVSS |
| VHH-43 | 55 | QVQLQESGGGLVQPGGSLRLSCAASRSILSISAMGWYRQGPGKQREPVATITSAGSSNYSDSVK |
| | | GRFTISRDNAKNTAYLQMNSLKPEDTAVYYCKTVYSRPLLGPLEVWGQGTQVTVSS |
| VHH-44 | 56 | QVQLQESGGGLVQTGGSLRLSCVASGSMFSSNAMAWYRQAPGKQRELVARILSGGSTNYADSV |
| | | KGRFTISRGNAKNTVYLQMNSLKPEDTAVYYCNAVRYLVNYWGQGTQVTVSS |
| VHH-45 | 57 | QVQLQESGGGSVQVGDSLTLSCVASGRSLDIYGMGWFRQAPGKEREFVARITSGGSTYYADSV |
| | | KGRFTLSRDNAKNTVYLQMNSLKPEDTAVYYCAAGVVVATSPKFYAYWGQGTQVTVSS |
| VHH-46 | 58 | QVQLQESGGGLVQAGGSLRLSCAASKRIFSTYTMGWFRQAPGKEREFVAAIIWSGGRTRYADSV |
| | | KGRFTISRDNARNTVHLQMNSLEPEDTAVYYCYTRRLGTGYWGQGTQVTVSS |
| VHH-47 | 59 | QVQLQESGGGLVQAGGSLRLSCAASGSTFSIQTIGWYRQAPGKQRDRVATISSGGSTNYADSVK |
| | | GRFTISRDNAKKTVYLQMNNLKPEDTAVYYCNLRYWFRDYWGQGTQVTVSS |
| VHH-48 | 60 | QVQLQESGGGLVQPGGSLRLSCAASGSTFSINVRGWYRQAPGKQRELVATITSDGSTNYADSVK |
| | | GRFTISRDNAKNTAYLQMNSLKPEDTAVYYCNAVRLFRQYWGQGTQVTVSS |
| VHH-49 | 61 | QVQLQESGGGLVQPGGSLRLSCAASGSIFRLNAMGWYRQAPGKQRELVAAITPGGGNTTYADS |
| | | VKGRFTISRDNALNTIYLQMNSLKPEDTAVYYCNAGGSSRWYSSRYYPGGYWGQGTQVTVSS |
| VHH-50 | 62 | QVQLQESGGGLVQAGGSLRLSCATSGGTFSRYAMGWFRQAPGKERELVATIRRSGSSTYYLDS |
| | | TKGRFTISRDNAKNTVYLQMNSLKLEDTAVYYCAADSSARALVGGPGNRWDYWGQGTQVTVSS |
| VHH-51 | 63 | QVQLQESGGGLVQPGGSLRLSCAASGSIGSINVMGWYRQYPGKQRELVAFITSGGITNYTDSVK |
| | | GRFAISRDNAQNTVYLQMNSLTPEDTAVYYCHLKNAKNVRPGYWGQGTQVTVSS |
| VHH-52 | 64 | QVQLQESGGGLVQPGGSLRLSCRASGGIFGINAMRWYRQAPGKQRELVASISSGGTTDYVESVK |
| | | GRFTISRDNATNTVDLQMSALKPEDTAVYYCNFVRFWFPDYWGQGTQVTVSS |
| VHH-53 | 65 | QVQLQESGGGLVQAGGSLRLSCAASGITFMSNTMGWYRQAPGKQRELVASISSGGSTNYADSV |
| | | KGRFTISRDNAKKTVYLQMNSLKPEDTAVYYCNARRNVFISSWGQGTQVTVSS |
| VHH-54 | 66 | QVQLQESGGGLVQPGGSLRLSCVASGSISVYGMGWYRQAPGKQRELVARITNIGTTNYADSVKG |
| | | RFTISRDNAKNTVYLQMNSLQPEDTAVYYCNLRRLGRDYWGQGTQVTVSS |
| VHH-55 | 67 | QVQLQESGGGLVQPGGSLRLSCAASRTALRLNSMGWYRQAPGSQRELVATITRGGTTNYADSV |
| | | KGRFTISREIGNNTVYLQMNSLEPEDTAVYYCNANFGILVGREYWGKGTQVTVSS |
| VHH-56 | 68 | QVQLQESGGGLVQAGGSLRLSCAVSGSIFSILSMAWYRQTPGKQRELVANITSVGSTNYADSVK |
| | | GRFTISRDIAKKTLYLQMNNLKPEDTAIYYCNTRMPFLGDSWGQGTQVTVSS |
| VHH-57 | 69 | QVQLQESGGGLVQAGGSLRLSCAVSAFSFSNRAVSWYRQAPGKSREWVASISGIRITTYTNSVK |
| | | GRFIISRDNAKKTVYLQMNDLRPEDTGVYRCYMNRYSGQGTQVTVSS |
| VHH-58 | 70 | QVQLQESGGGSVQPGGSLRLSCAASGTVFFSISAMGWYRQAPGKQRELVAGISRGGSTKYGDF |
| | | VKGRFTISRDNGKKTIWLQMNNLQPEDTAIYYCRLTSITGTYLWGQGTQVTVSS |
| VHH-59 | 71 | QVQLQESGGGLVQPGGSLRLSCAASGSIFSMKVMGWYRQGPGKLRELVAVITSGGRTNYAESV |
| | | KGRFTISRDNAKNTVSLQMNSLQPEDTAVYYCYYKTIRPYWGQGTQVTVSS |
| VHH-60 | 72 | QVQLQESGGGLVQAGGSLRLSCAASGITFRITTMGWYRQAPGKQRELVASSSSGGTTNYASSVK |
| | | GRFTISRDNAKNTVYLQMNSLRPEDTAVYYCNARKFITTPWSTDYWGQGTQVTVSS |
| VHH-61 | 73 | QVQLQESGGGLVQPGDSLRLSCTPSGSIFNHKATGWYRQAPGSQRELVAKITTGGTTNYADSVK |
| | | GRFTISRDNAKNTVYLQMSSLKPEDTAVYYCNAERYFATTLWGQGTQVTVSS |
| VHH-62 | 74 | QVQLQESGGGLVQAGGSLRLSCAASGITFSNNAGGWYRQAPGQQRELVARISSGGNTNYTDSV |
| | | KGRFTISRDITKNTLSLQMNNLKPEDSAVYYCNAQRRVILGPRNYWGQGTQVTVSS |
| VHH-63 | 75 | QVQLQESGGGLVQAGGSLRLSCAASGNIFRINDMGWYRQAPGNQRELVATITSANITNYADSVK |
| | | GRFTISRDNAKNTVYLQMNSLNPEDTAVYYCTAQAKKWRIGPWSDYWGQGTQVTVSS |
| VHH-64 | 76 | QVQLQESGGGLVQPGGSLRLSCAASGRIFSINDMAWYRQAPGKQRELVAIITNDDSTTYADSVKG |
| | | RFTISRDNAKNTVYLQMNSLKPEDTAVYYCNADINTAIWRRKYWGQGTQVTVSS |
| VHH-65 | 77 | QVQLQESGGGLVQSGGSLRLSCVHSKTTFTRNAMGWYRQALGKERELVATITSGGTTNYADSVK |
| | | GRFTISMDSAKNTVYLQMNSLKPEDTAVYYCNVNTRRIFGGTVREYWGQGTQVTVSS |
| VHH-66 | 78 | QVQLQESGGGLVQPGGSLRLSCAVSGSRIFIHDMGWHRQAPGEPRELVATITPFGRRNYSEYVK |
| | | GRFTVSRDIARNTMSLQMSNLKAEDTGMYYCNVRVNGVDYWGQGTQVTVSS |
| VHH-67 | 79 | QVQLQESGGGLVQAGGSLRLSCAISGITFRRPFGISRMGWYRQAPGKERELVATLSRAGTSRYV |
| | | DSVKGRFTISRDDAKNTLYLQMVSLNPEDTAVYYCYIAQLGTDYWGQGTQVTVSS |
| VHH-68 | 80 | QVQLQESGGGLVQAGGSLRLSCVASGITLRMYQVGWYRQAPGKQRELVAEISSRGTTMYADSV |
| | | KGRFTISRDGAKNIVYLQMNSLEPEDTAVYYCNARAFAFGRNSWGQGTQVTVSS |
| VHH-69 | 81 | QVQLQESGGGSVQAGGSLRLSCAVSGGTFSNKAMGWYRQSSGKQRALVARISTVGTAHYADSV |
| | | KGRFTVSKDNAGNTLYLQMNSLKPEDTAVYYCNAQAGRLYLRNYWGQGTQVTVSS |
| VHH-70 | 82 | QVQLQESGGGLVQPGESLRLSCVAAASTSITTFNTMAWYRQAPGKQRELVAQINNRDNTEYADS |
| | | VKGRFIISRGNAKNTSNLQMNDLKSEDTGIYYCNAKRWSWSTGFWGQGTQVTVSS |
| VHH-71 | 83 | QVQLQESGGGLVQAGGSLRLSCTASGLTFALGTMGWYRQAPGKQRELVASISTGSTNYADSVK |
| | | GRFTISRDIIKNILYLQMNSLKPEDTAVYSCNARLWWSNYWGQGTQVTVSS |
| VHH-72 | 84 | QVQLQESGGGLVQAGGSLRLSCTASGRTSSVNPMGWYRQAPGKQRELVAVISSDGSTNYADSV |
| | | KGRFTVSRDNAKNTLYLQMNSLKPEDTAVYYCNANRRWSWGSEYWGQGTQVTVSS |
| VHH-73 | 85 | QVQLQESGGGLVQAGGSLRLSCAASGITFTNNAGGWYRQAPGQQRELVARISSGGNTNYTDSV |
| | | KGRFTISRDITKNTLSLQMNNLKPEDSAVYYCNAQRRVILGPRNYWGQGTQVTVSS |
| VHH-74 | 86 | QVQLQESGGGLVQAGGSLRLSCEAPVSTFNINAMAWYRQAPGKSRELVARISSGGSTNYADSVK |
| | | GRFTISRDNAKNTVYLQMNSLKPEDTAVYICYVNRHWGWDYWGQGTQVTVSS |
| VHH-75 | 87 | QVQLQESGGGLVQPGGTLRLSCVASGSFRSINAMGWYRQAPGKQRELVATVDSGGYTNYADSV |
| | | KGRFTISRDNAKNTVYLQMSSLTPEDTAVYYCYAGIYKWPWSVDARDYWGQGTQVTVSS |
| VHH-76 | 88 | QVQLQESGGGLVQAGGSLRLSCAASGSSISMNSMGWYRQAPGKERERVALIRSSGGTYYADSV |
| | | KGRFTISRDNAKNTVYLQMNNLKPEDTAVYYCQARRTWLSSESWGQGTQVTVSS |
| VHH-77 | 89 | QVQLQESGGGLVQAGGSLRLSCAVSGSTFGINTMGWYRQAPEKQRELVASISRGGMTNYADSV |
| | | KGRFIISRDNAKNTVYLQMNSLKPEDTAVYVCNAGIRSRWYGGPITTYWGQGTQVTVSS |
| VHH-78 | 90 | QVQLQESGGGLVQAGGSLRLSCAASGSTGSINAMGWYRQGPGKQRDLVASISSGGATNYADSV |
| | | KGRFTISRDNSKNTVYLQMSSLKPEDTAVYYCNAKKSRWSWSIVHDYWGQGTQVTVSS |
| VHH-79 | 91 | QVQLQESGGGSVQTGGSLTLSCTTSGSIFGRSDMGWYRQAPGKQRELVATITRRSRTNYAEFVK |
| | | GRFTISRDSAKNLVTLQMNSLKPEDTNVYYCNARWGAGGIFSTWGQGTQVTVSS |
| VHH-80 | 92 | QVQLQESGGGLVQPGESLRLSCAASGSMSIDAMGWYRQAPGDQRELVASITTGGSTNYADSVK |
| | | GRFTISRDNAKNTVWLQMNSLKPEDTAVYYCNAKVRLRWFRPPSDYWGQGTQVTVSS |
| VHH-81 | 93 | QVQLQESGGGLVQPGGSLRLSCAASGRLLSISTMGWYRRTPEDQREMVASITKDGTTNYADSVK |
| | | GRLTISRDNAKNTVYLQMNSLKPDDTAVYVCNARATTWVPYRRDAEFWGQGTQVTVSS |
| VHH-82 | 94 | QVQLQESGGGLVQAGGSLRLSCAASGSIFGINDMGWYRQAPGKQRDLVADITRSGSTHYVDSVK |
| | | GRFTISRDNAKNTVYLQMNSLKPEDTAVYYCNADSGSHWWNRRDYWGQGTQVTVSS |
| VHH-83 | 95 | QVQLQESGGGLVQPGGSLKLSCAASGFTFSINTMGWYRQAPGKQRELVARISRLRVTNYADSVK |
| | | GRFTISRDNAKNTVYLQMNSLKPEDTAVYYCNAANWGLAGNEYWGQGTQVTVSS |
| VHH-84 | 96 | QVQLQESGGGLVQAGGSLRPSCTASGSTLLINSMGWYRQAPGKQRELVATISNSGTTNYVDAVK |
| | | GRFAISRDNANHTVYLQMNSLEPEDTAVYYCNAQTFWRRNYWGQGTQVTVSS |
| VHH-85 | 97 | QVQLQESGGGLVQAGGSLRLSCAVSGSTSRINAMGWYRQAPGKKRESVATIRRGGNTKYADSV |
| | | KGRFTISRDNANNTVYLQLNSLKPEDTAVYYCNAHSWLDYDYWGRGTQVTVSS |
| VHH-86 | 98 | QVQLQESGGGLVQAGGSLRLSCASRRRINGITMGWYRQAPGKQRELVATIDIHNSTKYADSVKG |
| | | RFIISRDNGKSMLYLQMNSLKPEDTAVYYCNRIPTFGRYWGQGTQVTVSS |
| VHH-87 | 99 | QVQLQESGGGLVQAGGSLRLSCVASGSTFYTFSTKNVGWYRQAPGKQRELVAQQRYDGSTNY |
| | | ADSLQGRFTISRDNAKRTVYLQMNSLKPEDTAVYICNVNRGFISYWGQGTQVTVSS |

### DETAILED DESCRIPTION OF THE INVENTION

Reference to any prior art in this specification is not, and should not be taken as, an acknowledgment or any form of suggestion that this prior art forms part of the common general knowledge in any country.

All documents cited in the present specification are hereby incorporated by reference in their entirety. Unless otherwise defined, all terms used in disclosing the invention, including technical and scientific terms, have the meaning as commonly understood by one of ordinary skill in the art to which this invention belongs.

The present invention will be described with respect to particular embodiments but the invention is not limited thereto but only by the claims. Any reference signs in the claims shall not be construed as limiting the scope.

Where the term “comprising” is used in the present description and claims, it does not exclude other elements or steps.

Where an indefinite or definite article is used when referring to a singular noun e.g. “a” or “an”, “the”, this includes a plural of that noun unless something else is specifically stated.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier ‘about’ refers is itself also specifically, and preferably, disclosed.

The following terms or definitions are provided solely to aid in the understanding of the invention. Unless specifically defined herein, all terms used herein have the same meaning as they would to one skilled in the art of the present invention.

The definitions provided herein should not be construed to have a scope less than understood by a person of ordinary skill in the art. Unless indicated otherwise, all methods, steps, techniques and manipulations that are not specifically described in detail can be performed and have been performed in a manner known per se, as will be clear to the skilled person. Reference is for example again made to the standard handbooks, to the general background art referred to above and to the further references cited therein.

The present invention provides a self-emulsifiable concentrate comprising an oil vehicle wherein a protein-containing composition is dispersed in the oil vehicle. The protein-containing composition may be in a solid or essentially solid state and should not be soluble in the oil vehicle. In a preferred embodiment, the protein-containing composition is derived from a microbial fermentation broth derived from a microbial fermentation reaction, where the broth contains dry matter in which the bioactive protein is contained and optionally co-formulants such as, but not limited thereto, surfactants, filler agents, antifoams, preservatives, buffering agents, anti-caking agents and stickers are added. The protein-containing composition needs to be solid or essentially solid. In the embodiment where the protein-containing composition is derived from a fermentation broth, the broth needs to be dried prior to it being dispersed in the oil vehicle. Drying of the fermentation broth can be achieved by, for example, spray drying or freeze drying. In a preferred embodiment the fermentation broth is spray dried. The resulting dried and solid material will comprise the dry components present in the fermentation broth, this includes proteins such as a bioactive protein but also additional additives such as for example fillers that may be added to the fermentation broth. The totality of dry matter derived from a fermentation reaction and additional compounds that may be added to the fermentation broth constitute the solid material that will remain after the water from the fermentation broth is removed. In one embodiment the solid material may be further milled or ground. Hence the production of the self-emulsifiable concentrate of the invention may require an additional milling step. In a preferred embodiment an additional milling step may be performed after the protein containing composition is dispersed into the oil vehicle i.e., in a preferred embodiment the milling step is performed on the oil vehicle comprising the protein-containing composition. In another embodiment the milling step is performed on the fully formulated self-emulsifiable concentrate to further increase the stability of the self-emulsifiable concentrate. As such, the milling step may be performed on the protein-containing composition prior to adding it to the oil vehicle, and/or after the addition of the protein-containing composition to the oil vehicle. The milling step may be performed at any stage of preparing a self-emulsifiable concentrate after the addition of the protein containing compositions. The milling step may be performed on the protein containing composition in its spray-dried, essentially solid state. Such a milling step may be performed by adding a quantity of glass beads to the spray dried powder, the oil vehicle comprising the protein-containing composition or the fully formulated self-emulsifiable concentrate and mixed using for example a propeller mixer at 1500 rpm for 30 minutes or by using a bead mill. The milling step serves to increase the contact surface area of the protein-containing composition, which is in an essentially solid state, hereby further improving the stability of the self-emulsifiable concentrate. Without wanting to be bound by theory, the protein-containing composition comprising dry matter containing a bioactive protein derived from a microbial fermentation may help to stabilize a self-emulsifiable concentrate and as such can function as a thickening agent. Further decreasing the size of the particles of the protein-containing composition by using a milling step may further improve this stabilizing effect.

The self-emulsifiable concentrates further comprise one or more dispersants, and one or more emulsifiers. Dispersants have as a function to disperse the protein-containing composition in the oil continuous phase and provide long term stability. In the concentrate, solid particles are susceptible to flocculation, which can lead to an increase in particle size and formulation instability. To prevent flocculation on storage, dispersants adsorb onto the solid particle surface creating a barrier to flocculation and agglomeration. Emulsifiers have as a function to facilitate the formation of an emulsion when the self-emulsifiable concentrate is added to a recipient containing an aqueous mix as is commonly done in agriculture to prepare a tank mix for spraying crop protection products on crops.

A self-emulsifiable concentrated or oil-dispersion is defined by solid particles that are dispersed in an oil vehicle. Importantly, for the self-emulsifiable concentrate to remain stable, thickening agents, also known as rheology modifiers, may be added to stabilize the dispersion of the solid to prevent phase separation. When phase separation occurs, the product can become instable or can prevent proper formation of the emulsion when added to a tank mix and this impairs the ability of the self-emulsifiable emulsion to be properly mixed in for example a tank mix for spraying crop protection products on crops. The inventors have found that when using a protein containing composition as described herein, the amount of thickening agent to be added was drastically reduced. In some embodiments the self-emulsifiable concentrate contains between 0% and 10% w/w of a thickening agent. In some embodiments the self-emulsifiable concentrate contains from 0% to 10% w/w of a thickening agent. In more preferred embodiments the self-emulsifiable concentrate contains between 0% and 5% w/w of a thickening agent. In more preferred embodiments the self-emulsifiable concentrate contains from 0% to 5% w/w of a thickening agent. In more preferred embodiments the self-emulsifiable concentrate contains between 0% and 4% w/w of a thickening agent. In more preferred embodiments the self-emulsifiable concentrate contains from 0% to 4% w/w of a thickening agent. In more preferred embodiments the self-emulsifiable concentrate contains between 0% and 3% w/w of a thickening agent. In more preferred embodiments the self-emulsifiable concentrate contains from 0% to 3% w/w of a thickening agent. In more preferred embodiments the self-emulsifiable concentrate contains between 0% and 2% w/w of a thickening agent. In more preferred embodiments the self-emulsifiable concentrate contains from 0% to 2% w/w of a thickening agent. In more preferred embodiments the self-emulsifiable concentrate contains between 0% and 1% w/w of a thickening agent. In more preferred embodiments the self-emulsifiable concentrate contains from 0% to 1% w/w of a thickening agent. In some preferred embodiments the self-emulsifiable concentrate contains 0% w/w or essentially no thickening agent is added, other than the protein-containing composition.

The amount of thickening agent can also be determined by the ratio of weight of thickening agent versus the weight of oil (i.e., ratio of “thickening agent:oil”) in the self-emulsifiable concentrate. In some embodiments the ratio of thickening agent:oil is less than 1:5, in a more preferable embodiments the ratio of thickening agent:oil is less than 1:10, in an even more preferable embodiments the ratio of thickening agent:oil is less than 1:20, in a more preferable embodiment the ratio of thickening agent:oil is less than 1:30. In some preferred embodiments, the ratio of thickening agent:oil is essentially 0.

In embodiments where between 0% and 2% w/w (or from 0% to 2% w/w) thickening agents is added, the self-emulsifiable concentrate is stabilized further by the protein-containing composition. It is understood that the protein-containing composition as described herein aids in the stabilizing of the self-emulsifiable concentrate and can serve as a replacement for thickening agents. In practice it may however remain necessary to include small amounts of a thickening agent to further stabilize the self-emulsifiable concentrate. In preferred embodiments, the amount of thickening agent that is needed to stabilize the self-emulsifiable concentrate is reduced by at least 10%. In even more preferred embodiments, the amount of thickening agent that is needed to stabilize the self-emulsifiable concentrate is reduced by at least 20%. In even more preferred embodiments, the amount of thickening agent that is needed to stabilize the self-emulsifiable concentrate is reduced by at least 30%. In even more preferred embodiments, the amount of thickening agent that is needed to stabilize the self-emulsifiable concentrate is reduced by at least 40%. In even more preferred embodiments, the amount of thickening agent that is needed to stabilize the self-emulsifiable concentrate is reduced by at least 50%. In even more preferred embodiments, the amount of thickening agent that is needed to stabilize the self-emulsifiable concentrate is reduced by at least 60%. In even more preferred embodiments, the amount of thickening agent that is needed to stabilize the self-emulsifiable concentrate is reduced by at least 70%. In even more preferred embodiments, the amount of thickening agent that is needed to stabilize the self-emulsifiable concentrate is reduced by at least 80%. In even more preferred embodiments, the amount of thickening agent that is needed to stabilize the self-emulsifiable concentrate is reduced by at least 90%. In even more preferred embodiments, the amount of thickening agent that is needed to stabilize the self-emulsifiable concentrate is reduced by at least 95%. In even more preferred embodiments, the amount of thickening agent that is needed to stabilize the self-emulsifiable concentrate is reduced by at least 99%. In a more preferred embodiment, the self-emulsifiable concentrate has essentially no added thickening agent.

Further provided are means and methods for producing the self-emulsifiable concentrate comprising the steps of (i) optionally heating the oil vehicle to a temperature between 60° C. and 90° C., preferably to about 85° C. to 90° C., followed by (ii) optionally incorporating no more than 10% w/w of the thickening agent, other than the protein-containing composition, by mixing it with the heated oil vehicle, optionally by mixing at low shear force, followed by (iii) if heated in step (i), cooling the oil vehicle, adding (iv) the one or more dispersants, and (v) the one or more emulsifiers to the oil vehicle, and (vi) optionally further adding one or more surface stabilizing agents, adjuvants, additives, filling materials, colorants, antioxidants, preservatives, antifoam substances, or combinations thereof, to the oil vehicle, and (vii) adding the protein-containing composition to the oil vehicle, wherein the protein-containing composition becomes dispersed in the oil vehicle. Further provided are means and methods for producing the self-emulsifiable concentrate comprising the steps of (i) optionally heating the oil vehicle to a temperature in the range of 60° C. to 90° C., preferably to about 85° C. to 90° C., followed by (ii) optionally incorporating no more than 10% w/w, preferably no more than 5% w/w, even more preferably no more than 2.5% w/w, even more preferably no more than 2% w/w, most preferably no more than 1% w/w of the thickening agent, other than the protein-containing composition, by mixing it with the heated oil vehicle, optionally by mixing at low shear force, followed by (iii) if heated in step (i), cooling the oil vehicle, adding (iv) the one or more dispersants, and (v) the one or more emulsifiers to the oil vehicle, and (vi) optionally further adding one or more surface stabilizing agents, adjuvants, additives, filling materials, colorants, antioxidants, preservatives, antifoam substances, or combinations thereof, to the oil vehicle, and (vii) adding the protein-containing composition to the oil vehicle, wherein the protein-containing composition becomes dispersed in the oil vehicle. The skilled person will be aware that in cases where a thickening agent needs to be added and depending on the specific type of thickening agent, the temperature of the oil vehicle needs to be increased to allow the successful incorporation of the thickening agent into the oil vehicle. Alternatively or additionally, high shear force may need to be applied to further facilitate or allow the thickening agent to be incorporated into the oil vehicle. In some embodiments the oil vehicle is heated to a temperature of 40° C. or higher before optionally adding the thickening agent to no more than 10% w/w, preferably no more than 5% w/w, even more preferably no more than 2.5% w/w, even more preferably no more than 2% w/w, most preferably no more than 1% w/w. In another embodiment the oil vehicle is heated to a temperature of 50° C. or higher before optionally adding the thickening agent to no more than 10% w/w, preferably no more than 5% w/w, even more preferably no more than 2.5% w/w, even more preferably no more than 2% w/w, most preferably no more than 1% w/w. In another embodiment the oil vehicle is heated to a temperature of 60° C. or higher before optionally adding the thickening agent to no more than 10% w/w, preferably no more than 5% w/w, even more preferably no more than 2.5% w/w, even more preferably no more than 2% w/w, most preferably no more than 1% w/w. In yet another embodiment the oil vehicle is heated to a temperature of 70° C. or higher before optionally adding the thickening agent to no more than 10% w/w, preferably no more than 5% w/w, even more preferably no more than 2.5% w/w, even more preferably no more than 2% w/w, most preferably no more than 1% w/w. In yet another embodiment the oil vehicle is heated to a temperature of 75° C. or higher before optionally adding the thickening agent to no more than 10% w/w, preferably no more than 5% w/w, even more preferably no more than 2.5% w/w, even more preferably no more than 2% w/w, most preferably no more than 1% w/w. In yet another embodiment the oil vehicle is heated to a temperature of 80° C. or higher before optionally adding the thickening agent to no more than 10% w/w, preferably no more than 5% w/w, even more preferably no more than 2.5% w/w, even more preferably no more than 2% w/w, most preferably no more than 1% w/w. In yet another embodiment the oil vehicle is heated to a temperature of 85° C. or higher before optionally adding the thickening agent to no more than 10% w/w, preferably no more than 5% w/w, even more preferably no more than 2.5% w/w, even more preferably no more than 2% w/w, most preferably no more than 1% w/w. In yet another embodiment the oil vehicle is heated to a temperature of 90° C. or higher before optionally adding the thickening agent to no more than 10% w/w, preferably no more than 5% w/w, even more preferably no more than 2.5% w/w, even more preferably no more than 2% w/w, most preferably no more than 1% w/w. In some embodiments the temperature of the oil vehicle needs to be increased even higher. The skilled person will know the maximum temperature one can heat the oil before the integrity of the thickening agent or the oil vehicle becomes compromised due to heating. In more preferred embodiments the oil vehicle does not require heating to a temperature higher than the ambient temperature to incorporate the oil vehicle. In other preferred embodiments the thickening agent is incorporated to no more than 10% w/w, preferably no more than 5% w/w, even more preferably no more than 2.5% w/w, even more preferably no more than 2% w/w, most preferably no more than 1% w/w in the oil vehicle by stirring or applying shear force. In some embodiments the thickening agent is incorporated to no more than 10% w/w, preferably no more than 5% w/w, even more preferably no more than 2.5% w/w, even more preferably no more than 2% w/w, most preferably no more than 1% w/w in the oil vehicle by applying heavy shear force such as by for example mixing. In other embodiments the oil vehicle is heated as described above while being stirred or while shear force is applied to incorporate the thickening agent to no more than 10% w/w, preferably no more than 5% w/w, even more preferably no more than 2.5% w/w, even more preferably no more than 2% w/w, most preferably no more than 1% w/w. In other less preferred embodiments the oil vehicle is heated as described above while being mixed or while heavy shear force is applied to incorporate the thickening agent to no more than 10% w/w, preferably no more than 5% w/w, even more preferably no more than 2.5% w/w, even more preferably no more than 2% w/w, most preferably no more than 1% w/w. In the most preferred embodiments no or only low amounts of thickening agent need to be added to the oil vehicle other than the protein-containing composition to stabilize the self-emulsifiable concentrate.

In a more preferred embodiment the self-emulsifiable concentrate is produced by providing the oil vehicle, adding the one or more dispersants to the oil vehicle, adding the one or more emulsifiers to the oil vehicle, optionally further adding one or more, surface stabilizing agents, adjuvants, filling materials, colorants, antioxidants, preservatives, antifoam substances, or combinations thereof, to the oil vehicle, adding the protein-containing composition to the oil vehicle, wherein the protein-containing composition becomes dispersed in the oil vehicle, and optionally incorporating no more than 10% w/w, preferably no more than 5% w/w, even more preferably no more than 2.5% w/w, even more preferably no more than 2% w/w, most preferably no more than 1% w/w of the thickening agent, other than the protein-containing composition, by mixing, optionally by mixing at low shear force. In embodiments where no heating is needed to incorporate the thickening agent, the thickening agent is added to no more than 10% w/w, preferably no more than 5% w/w, even more preferably no more than 2.5% w/w, even more preferably no more than 2% w/w, most preferably no more than 1% w/w in the last step in the process of obtaining a self-emulsifiable to further stabilize the dispersion. In some embodiments a further milling step is performed prior to the addition of the thickening agent.

Further provided is the use of the self-emulsifiable concentrate for the treatment or prevention of a plant pathogenic infection. Where the self-emulsifiable concentrate contains for example a bioactive protein such as an immunoglobulin single variable domain, the self-emulsifiable concentrate after being emulsified in an aqueous composition can be used to for the treatment or prevention of a plant pathogenic infection on a plant or a part of the plant. The self-emulsifiable concentrate may be emulsified by mixing it with an aqueous solution, thereby producing an emulsified solution that may be applied to one or more plants or parts of a plant.

The self-emulsifiable concentrate of the invention contains a protein-containing composition. In a preferred embodiment the protein-containing composition contains a bioactive compound such as a bioactive protein or in a more preferred embodiment an immunoglobulin single variable domain. The protein-containing composition may be derived from a fermentation broth that has undergone optional further purification steps as further described herein. In a most preferred embodiment the fermentation broth is derived from a microbial fermentation reaction and wherein the fermentation reaction produces a bioactive protein, such as an immunoglobulin single variable domain. In some embodiments of the invention the protein-containing composition has bioactive properties and can be used to treat or protect a plant or part of the plant from a plant pathogenic pest, such as a fungal pest, bacterial pest, insect pest but not limited thereto. In preferred embodiments the bioactive properties that can be used to treat or protect a plant or part of the plant from a plant pathogenic pest, such as a fungal pest, may lie in the bioactive compound such as a bioactive protein that is produced during a microbial fermentation reaction. More specifically the bioactive protein may be an immunoglobulin single variable domain. In some embodiments the bioactive properties lie in the bioactive compounds and/or bioactive proteins or a combination thereof produced by the microbial cells used in the microbial fermentation reaction. In some embodiments, the bioactive properties of the bioactive compounds and/or bioactive proteins or a combination thereof present may have beneficial effects on a plant or part of the plant, such as improving the fitness of a plant or part of the plant, improving the stress resistance of a plant or part of the plant, and/or improving the yield of a plant or part of the plant.

An objective of the invention is to provide improved formulations for protein-containing compositions. Specifically, the self-emulsifiable concentrate has the advantage of stabilizing the protein-containing composition and greatly increases the shelf life of the composition. More specifically, where the protein-containing composition contains a protein of interest (for example an immunoglobulin single variable domain), the protein of interest is stabilized when dispersed in the self-emulsifiable concentrate.

By providing the ability to incorporate a protein-containing composition, for example derived from a microbial fermentation broth, into a self-emulsifiable concentrate the current invention provides a quick, safe and convenient way to process and stabilize the protein-containing composition. For instance, the microbial fermentation broth can now be processed, dried (for example spray-dried) and mixed into an oil vehicle at which point the self-emulsifiable concentrate stabilizes the protein-containing composition. This prevents the need to store a liquid fermentation broth at cold temperature to prevent microbial spoilage and/or degradation of the protein-containing composition or bioactive protein. Furthermore, by incorporating a dried powder into an oil vehicle no further handling of powder is required, reducing, or preventing the risk of dust formation.

### [Protein-Containing Composition]

In a preferred embodiment, the protein-containing composition is derived from a microbial fermentation broth produced during a microbial fermentation reaction. Microbial fermentation broths will contain dry matter which comprises non-relevant process-related components originating from the host cells (for example Pichia pastoris) such as host cell proteins, carbohydrates and lipids, from the culture medium and used process aids. A typical fermentation reaction in Pichia pastoris producing for example a bioactive protein such as an immunoglobulin single variable domain and where the immunoglobulin single variable domain was purified and concentrated using several filtration techniques, the resulting fermentation broth can contain over 5% w/w of dry matter. In some examples dry matter content of the fermentation broth can be up to 10% w/w or more or even 15% w/w or more. In a preferred embodiment the dry matter content of the fermentation broth can be up to 25% w/w or more. In an even more preferred embodiment, the dry matter content of the fermentation broth can be up to 40% w/w or more. In a most preferred embodiment, the dry matter content of the fermentation broth may be around 50% w/w. The dry matter of the fermentation broth may contain a bioactive protein. The totality of dry matter derived from a fermentation reaction and additional compounds that may be added to the microbial fermentation broth constitute the solid material that will remain after the water from the microbial fermentation broth is removed during for instance spray-drying. The dry matter derived from the microbial fermentation may provide a significant portion of the solid material in the protein-containing composition.

It is understood that where a microbial fermentation reaction produces a bioactive protein such as for example an immunoglobulin single variable domain, said bioactive protein will be contained in the dry matter derived from the microbial fermentation reaction. As such the relative amount of bioactive protein in the protein-containing composition that is in a solid or essentially solid state will depend on said microbial fermentation reaction. The relative amount of bioactive protein will further depend on further additions of additional additives, co-formulants or excipients containing solid or essentially solid compounds and thus will increase the total amount of solids that will remain in the protein-containing composition that is derived from a dried (for example spray-dried) microbial fermentation broth. The relative amount of bioactive protein will further depend on the degree of downstream processing of the fermentation broth and to which degree the bioactive protein is further concentrated and/or purified relative the dry matter content. Typical examples of protein-containing compositions as described herein, in particular as derived from spray-dried microbial fermentation broths comprise, on a weight/weight basis, e.g. 5%, 10%, 15%, 20%, 25%, 30% or, 40% up to 50% or more of bioactive protein. Typical examples of protein-containing compositions have a relative amount of bioactive protein of between 5% and 25% (from 5% to 25%). In preferred embodiments the protein-containing compositions of this invention have a relative amount of bioactive protein of around 15%, in more preferred embodiments the protein-containing compositions have a relative amount of bioactive protein of up to 20% or more, in even more preferred embodiments the protein-containing compositions have a relative amount of bioactive protein of 25% or more. The skilled person will know that the final minimum or maximum amount of the bioactive protein in the protein-containing compositions of this invention will depend on the weight/weight ratio of said bioactive protein and the dry matter in which it is contained and the amount of additional solid compounds that are added to the microbial fermentation broth such as additives, co-formulants or excipients.

In some embodiments the microbial fermentation broth is further supplemented with additives, co-formulants or excipients prior to being spray-dried, thereafter becoming the protein-containing composition. In some embodiments the protein-containing composition further comprises a humectant (i.e., the microbial fermentation broth may be supplemented with a humectant). A specific example of a humectant is attapulgite clay powder also known as Palygorskite and more specifically magnesium aluminium phyllosilicate. A commercially available example of attapulgite clay powder is Attagel 50 available from BASF SE. In a preferred embodiment the protein-containing composition comprises an attapulgite clay powder such as Attagel 50 (i.e., the microbial fermentation broth may be supplemented with attapulgite clay powder such as Attagel 50).

In some embodiments the protein-containing composition further comprises a “surfactant” also referred to as a “wetting agent”, and used herein interchangeably. Thus, the microbial fermentation broth may be supplemented with a surfactant, e.g., prior to spray drying. Surfactants are compounds that lower the surface tension between two liquids, or between a liquid and a solid. A surfactant is usually an organic amphiphilic compound, meaning that it contains both water soluble (hydrophilic) and water insoluble (hydrophobic) components. An example of a surfactant is Tween. Tween surfactants contain hydrophilic ethylene glycol head groups and a hydrophobic alkyl tail. Different Tween molecules have the same hydrophilic head group, but a variable alkyl tail length for instance Tween 20 has a dodecyl tail and Tween 40 a longer octadecyl tail. In a preferred embodiment, the protein-containing composition comprises the surfactant Tween 20 or polyoxyethylene sorbitan monolaurate (i.e., the microbial fermentation broth may be supplemented with Tween 20 or polyoxyethylene sorbitan monolaurate). Tween 20 variants Tween 22, Tween 23 and Tween 24 are for instance available from commercial provider Croda International Plc. In a preferred embodiment the protein-containing composition further comprises the surfactant Tween 23 (i.e., the microbial fermentation broth may be supplemented with Tween 23). Another example of a surfactant are organomodified siloxanes or more specifically polyether siloxanes. An example of such polyether siloxanes is the Break-Thru series of products available from Evonik Operations GmbH. In a preferred embodiment the protein-containing composition comprises the surfactant biodegradable polyether siloxane known by its commercial name Break-Thru S301 (i.e., microbial fermentation broth may be supplemented with the surfactant biodegradable polyether siloxane known by its commercial name Break-Thru S301). Another suitable surfactant from Evonik Operations GmbH is the polyether siloxane known as Break-Thru S240. Other examples of surfactants that can be added in varying concentrations are C8-10 alkyl polyglucoside available from BASF SE with its commercial name Agnique PG8107, polyalkyleneoxide Modified heptamethyltrisiloxane available from De Sangosse or Momentive with its commercial name Silwet L-77, polyoxyethylene (20) oleyl ether available from Croda Internation Plc with its commercial name Brij 020, polyethoxylated Alcohol available from Croda International Plc with its commercial name Brij C20, alkyl polyethylene glycol ether available from BASF SE with its commercial name Lutensol ON 60, fatty alcohol polyglycolether available from Clariant AG with its commercial name Genapol O 230, Alcohol ethoxylate more specifically Ethylene Oxide/Propylene Oxide Block Copolymers such as those available from Dow Inc with commercial name Tergitol XD, or specific mixtures such as Geropon L Wet Max available from Solvay SA.

In some embodiments the protein-containing composition further comprises a filler agent or also referred to as an “inert ingredient”, and used herein interchangeably. Thus, the microbial fermentation broth may be supplemented with a filler agent, e.g., prior to spray drying. Filler agents are compounds that in general are considered not to have a biological activity, i.e. they do not improve or decrease efficacy of a product in which they are used. Filler agents are also considered safe for use in for instance foodstuff or for agricultural use. As an example, the InertFinder database of the U.S. Environmental Protection Agency—EPA, provides an overview of all compounds that are considered inert, and can be used as a filler agent. Filler agents may for instance be used to increase the volume of a product. Since active ingredients in crop protection products may be present in a low concentration, adding filler agents may improve for instance handling of the product. In other instances filler agents may be added to assure a constant concentration of active ingredient, for instance when an active ingredient is derived from a microbiological fermentation which are inherently variable in output concentration of the active ingredient (be it a bioactive protein or a microbial strain), filler agents are added so to achieve a standard concentration in the final product. The skilled person will know that the amount of filler agent may be calculated based on for instance the concentration of the active ingredient in the protein-containing composition (or microbial fermentation broth) in order to achieve a set concentration in the final product, where the final product may for instance be spray-dried and thereafter incorporated into an oily vehicle. Some non-limiting examples of filler agents are Trisodium citrate dihydrate commonly available, and for example available from Citribel NV, Silicon dioxides such as Aerosil 200 and Sipernat 50s available from Evonik Operations GmbH. In a preferred embodiment the protein-containing composition further comprises the filler agent Sipernat 50S (i.e., the microbial fermentation broth may be supplemented with the filler agent Sipernat 50S).

In some embodiments the protein-containing composition further comprises an antifoam. Thus, the microbial fermentation broth may be supplemented with an antifoam, e.g., prior to spray drying. Antifoam used in for example a crop protection product may help to prevent the formation of foam in the spray tank when filling a spray tank by mixing a concentrated composition in a larger volume of water. Common examples of antifoam products are silicone fluids such as polydimethylsiloxane also known as dimethicone also known with its tradename Xiameter AFE 1530 a commercial product sold by DOW Inc., tertiary amine oxides such as decyldimethyl-aminoxide also known as decalmine oxide also known with its tradename Tegotens DO a commercial product sold by Evonik and silicone emulsions such as those disclosed in WO2007058985A1 and for example the silicone emulsion SAG 471 a commercial product sold by Momentive. In a preferred embodiment the protein-containing composition further comprises the antifoam agent Xiameter AFE 1530 (i.e., the microbial fermentation broth may be supplemented with Xiameter AFE 1530).

In some embodiments the protein-containing composition further comprises an anti-caking agent. Thus, the microbial fermentation broth may be supplemented with an anti-caking agent, e.g., prior to spray drying. Anti-caking agents are anhydrous compounds that are added in small amounts to dry foods to prevent particles from caking together or to the walls of the vessel of a spray-drying apparatus. An example of compounds that can serve as anti-caking agents are silicon dioxides, for example available from Evonik Operations GmbH with commercial name Sipernat 50s.

In some embodiments the protein-containing composition further comprises a sticker. Thus, the microbial fermentation broth may be supplemented with a sticker, e.g., prior to spray drying. Stickers prevent bioactive compounds to wash off leaves or other plant materials when sprayed, hereby increasing retention time on leaf surface resulting in better overall spray efficacy. Non limiting examples of stickers are hydroxyethyl cellulose polymers such as available from Dow Inc. under its commercial name Cellosize Hydroxyethyl Cellulose QP300 and guar gum or products based thereon available from Solvay under its commercial name AgRHEA SticGuard.

The skilled person will know that certain compounds can have different functions in a formulation. For example, Sipernat 50s may be used as a filler, additionally Sipernat 50s is also known for its role as an anti-caking agent. Another example is the attapulgite clay Attagel 50 that may be used as a humectant but may serve as a thickening agent as well in a self-emulsifiabel concentrate. Brij 020 and Brij C20 can both be utilized as a wetting agent and serve as a dispersant. Aerosil 200 and Sipernat 50s can also be used as rheology modifiers or thickening agents.

### [Mixing of Microbial Fermentation Broths or Self-Emulsifiable Concentrates]

The different ingredients or additives or co-formulants as described above may be mixed into the microbial fermentation broth, protein-containing composition or into the self-emulsifiable concentrate (see below) in various orders. The skilled person will know that some ingredients should be added first or last, depending on the specific properties of that ingredient. This is often derived by trial and error, for instance addition of an ingredient could lead to its precipitation if another ingredient is already present. Inverting the order of mixing could already alleviate such a problem. That being said, for most ingredients no specific order will be required. Thus, most ingredients can be added at the same time or in any given order. Other ingredients might need heating in order to be incorporated into the protein-containing composition. Mixing of the ingredients can be achieved by any suitable mixing means, such as a 4-bladed propeller, a mixing rod, a bead mill blender or any other means that can mix liquids. Mixing at small laboratory scale can be achieved by common appliances such as a blender, whereas mixing at pilot scale or at industrial scale would require more robust industrial grade mixer such as a heavy duty 4-bladed propeller mixer.

In the context of obtaining a protein-containing compositions in a solid or essentially solid state, in some set-ups the final microbial fermentation broth can be continuously mixed (e.g., supplemented with one or more additives, co-formulants or excipients) in a recipient and directly fed into the spray-drying apparatus vessel. This is especially useful in a large-scale continuous spray-drying system. This set-up assures the microbial fermentation broth stays homogenous throughout the entire process and new baches of microbial fermentation broths can be continuously added thereto assuring that a continuous process can run for extended periods of times (such as multiple days, weeks or even months) yielding consistent protein-containing compositions in a solid or essentially solid state. In other set-ups the mixing of the microbial fermentation broth may be achieved in a separate recipient and then transferred into the spray-drying apparatus by, for example a pump.

In the context of obtaining a self-emulsifiable concentrate from a protein-containing composition, the above considerations as to mixing in a continuous or non-continuous set-up may be applied as well.

### [Bioactive Protein]

In a preferred embodiment the protein-containing composition comprises a bioactive protein. As used herein, the term “bioactive protein” refers to a recombinant protein expressed by the microbe which is biologically active (i.e., has a biological function, such as e.g., binding to an antigen). The bioactive protein may be a protein which is overexpressed. In a more preferred embodiment the bioactive protein is an immunoglobulin single variable domain or VHH. Bioactive proteins may have the effect of actively killing microbial organisms such as bacteria or fungi. Additionally bioactive proteins may have the effect of actively killing insects. In some instances, the effect of the bioactive protein is that it inhibits or stops the growth of the microbial organism or insect. In some instances the bioactive protein can inhibit essential communication systems of microbial organisms or insects and in so doing disrupt their successful propagation. Examples of the latter would be inhibition of quorum sensing in bacteria or pheromone signaling in insects. In other examples the bioactive protein can prevent the microbial organism or insect to exert its pathogenicity traits without necessarily killing or impairing the microbial organism or insect. As such a bioactive protein may be fungistatic or fungicidal, bacteriostatic or bactericidal, insecticidal or insectistatic, or have pathogenicity inhibiting properties.

In some embodiments the bioactive protein may be a small peptide with anti-microbial properties such as an antimicrobial peptide or AMP. AMPs usually have a length of in the range of 10 to 50 amino acids. AMPs are commonly anionic or cationic and can be subdivided in 4 classes: (i) anionic peptides which are rich in glutamic and aspartic acids, (ii) linear cationic α-helical peptides, (iii) cationic peptides enriched for specific amino acidrich in proline, arginine, phenylalanine, glycine, tryptophan and (iv) anionic/cationic peptides forming disulfide bonds. More specific examples are plant derived AMPs with antimicrobial or antiviral activities such as peptides composed of at least two helical domains connected by a linker/turn such as plant-derived amphipathic helix or two helices engineered into a helix-tum-helix (HTH) format in which homologous or heterogeneous helices are connected by a peptide linker. For example, as described in WO2021202476, WO2020072535, WO2020176224 or WO2003000863.

Non-limiting examples of bioactive proteins that can be produced in a microbial fermentation reaction and are suitable for being formulated in the agglomerates of this invention may be the well-known Bt toxins, e.g., a Cry protein, a Cyt protein, or a Vip protein, or an δ-endotoxin (e.g., Crystal (Cry) toxins and/or cytolytic (Cyt) toxins); vegetative insecticidal proteins (Vips); secreted insecticidal protein (Sips); or Bin-like toxins. “Vip” or “VIP” or “Vegetative Insecticidal Proteins” refer to proteins discovered from screening the supernatant of vegetatively grown strains of Bt for possible insecticidal activity. Vips have little or no similarity to Cry proteins. Of particular use and preference for use with this document are what have been called VIP3 or Vip3 proteins, which have Lepidopteran activity. Vips are thought to have a similar mode of action as Bt cry peptides. Further examples may be polypeptides derived from spider venom such as venom from funnel-web spiders such as agatoxins or diguetoxins more specifically a Mu-diguetoxin-dc1a variant polypeptides or a U1-agatoxin-Ta1b variant polypeptide. Other examples are polypeptides derived from sea anemone, such as Av3 toxins. Such as described in WO2022067214 or WO2021216621 or WO2022212777.

In preferred embodiments, the bioactive protein that can be produced in a microbial fermentation reaction, and are suitable for being formulated in the self-emulsifiabel concentrate of the invention, is an antibody or a functional fragment thereof, a carbohydrate-binding domain, a heavy chain antibody or a functional fragment thereof, a single domain antibody, a heavy chain variable domain of an antibody or a functional fragment thereof, a heavy chain variable domain of a heavy chain antibody or a functional fragment thereof, a variable domain of camelid heavy chain antibody (VHH) or a functional fragment thereof, a variable domain of a new antigen receptor, a variable domain of shark new antigen receptor (vNAR) or a functional fragment thereof, a minibody, a nanobody, a nanoantibody, an affibody, an alphabody, a designed ankyrin-repeat domain, an anticalins, a knottins or an engineered CH2 domain. In some embodiments, the compound of interest is an antibody, for example a VHH.

In a more preferred embodiment the bioactive protein may comprise at least one camelized heavy chain variable domain of a conventional four-chain antibody (camelized VH), or a functional fragment thereof at least one heavy chain variable domain of a heavy chain antibody (VHH), which is naturally devoid of light chains or a functional fragment thereof, such as but not limited to a heavy chain variable domain of a camelid heavy chain antibody (camelid VHH) or a functional fragment thereof. And where the at least one heavy chain variable domain of an antibody or a functional fragment thereof, which does not have an amino acid sequence that is exactly the same as (i.e. as in a degree of sequence identity of 100% with) the amino acid sequence of a naturally occurring VH domain, such as the amino acid sequence of a naturally occurring VH domain from a mammal, and in particular from a human being.

The bioactive protein may be a VHH. In more specific embodiments, the VHH may be a VHH that can bind a specific lipid fraction of the cell membrane of a fungal spore. Such VHHs may exhibit fungicidal activity through retardation of growth and/or lysis and explosion of spores, thus preventing mycelium formation. The VHH may therefore have fungicidal or fungistatic activity.

In some embodiments, the VHH may be a VHH that is capable of binding to a lipid-containing fraction of the plasma membrane of a fungus (for example Botrytis cinerea or other fungus). Said lipid-containing fraction may be obtainable by chromatography. For example, said lipid-containing fraction may be obtainable by a method comprising:
fractionating hyphae of a fungus (for example Botrytis cinerea or other fungus) by total lipid extract thin-layer chromatography and selecting the fraction with a Retention Factor (RD higher than the ceramide fraction and lower than the non-polar phospholipids fraction.

The VHH may be capable of binding to a fungus. Such VHHs can thereby cause retardation of growth of a spore of the said fungus and/or lysis of a spore of the said fungus. That is to say, binding of the VHH to a fungus results in retardation of growth of a spore of the said fungus and/or lysis of a spore of the said fungus.

The VHHs may (specifically) bind to a membrane of a fungus or a component of a membrane of a fugus. In some embodiments, the VHHs do not (specifically) bind to a cell wall or a component of a cell wall of a fungus. For example, in some embodiments, the VHHs do not (specifically) bind to a glucosylceramide of a fungus.

The VHHs may be capable of (specifically) binding to a lipid-containing fraction of the plasma membrane of a fungus, such as for example a lipid-containing fraction of Botrytis cinerea or other fungus. Said lipid-containing fraction (of Botrytis cinerea or otherwise) may be obtainable by chromatography. The chromatography may be performed on a crude lipid extract (also referred to herein as a total lipid extract, or TLE) obtained from fungal hyphae and/or conidia. The chromatography may be, for example, thin-layer chromatography or normal-phase flash chromatography. The chromatography (for example thin-layer chromatography) may be performed on a substrate, for example a glass plate coated with silica gel. The chromatography may be performed using a chloroform/methanol mixture (for example 85/15% v/v) as the eluent.

For example, said lipid-containing fraction may be obtainable by a method comprising:
fractionating hyphae and/or conidia of a fungus (for example Botrytis cinerea or other fungus) by total lipid extract thin-layer chromatography and selecting the fraction with a Retention Factor (RD higher than the ceramide fraction and lower than the non-polar phospholipids fraction.

In a more specific embodiment, the lipid-containing fraction may be obtainable by a method comprising:
fractionating hyphae and/or conidia of a fungus (for example Botrytis cinerea or other fungus) by total lipid extract thin-layer chromatography on a silica-coated glass slide using a chloroform/methanol mixture (for example 85/15% v/v) as the eluent and selecting the fraction with a Retention Factor (RD higher than the ceramide fraction and lower than the non-polar phospholipids fraction.

Alternatively, the fraction may be obtained using normal-phase flash chromatography. In such a method, the method may comprise:
fractionating hyphae and/or conidia of a fungus (for example Botrytis cinerea or other fungus) by total lipid extract normal-phase flash chromatography, and selecting the fraction with a Retention Factor (RD higher than the ceramide fraction and lower than the non-polar phospholipids fraction.

In a more specific embodiment, the lipid-containing fraction may be obtainable by a method comprising:
fractionating hyphae and/or conidia of a fungus (for example Botrytis cinerea or other fungus) by total lipid extract normal-phase flash chromatography comprising dissolving the TLE in dichloromethane (CH2Cl2) and MeOH and using CH2Cl2/MeOH (for example 85/15%, v/v) as the eluent, followed by filtration of the fractions through a filter.

In a more specific embodiment, the lipid-containing fraction may be obtainable by a method comprising:
fractionating hyphae and/or conidia of a fungus (for example Botrytis cinerea or other fungus) by total lipid extract normal-phase flash chromatography comprising dissolving the TLE in dichloromethane (CH2Cl2) and MeOH loading the TLE on to a phase flash cartridge (for example a flash cartridge with 15 μm particles), running the column with CH2Cl2/MeOH (85/15%, v/v) as the eluent, and filtering the fractions through a filter (for example a 0.45 μm syringe filter with a nylon membrane) and drying the fractions.

The fractions from the chromatography may be processed prior to testing of binding of the VHH to the fraction or of interaction with the fraction. For example, liposomes comprising the fractions may be prepared. Such a method may comprise the use of thin-film hydration. For example, in such a method, liposomes may be prepared using thin-film hydration with the addition of 1,6-diphenyl-1,3,5-hexatriene (DPH). Binding and/or disruption of the membranes by binding of the VHH may be measured by a change in fluorescence before and after polypeptide binding (or by reference to a suitable control).

Accordingly, in some embodiments, the VHHs may (specifically) bind to a lipid-containing chromatographic fraction of the plasma membrane of a fungus, optionally wherein the lipid-containing chromatographic fraction is prepared into liposomes prior to testing the binding of the polypeptide thereto.

Binding of the VHH to a lipid-containing fraction of a fungus may be confirmed by any suitable method, for example bio-layer interferometry. Specific interactions with the lipid-containing fractions may be tested. For example, it may be determined if the polypeptide is able to disrupt the lipid fraction when the fraction is prepared into liposomes, for example using thin-film hydration.

In methods involving chromatography, an extraction step may be performed prior to the step of chromatography. For example, fungal hyphae and/or conidia may be subjected to an extraction step to provide a crude lipid extract or total lipid extract on which the chromatography is performed. For example, in some embodiments, fungal hyphae and/or conidia (for example fungal hyphae and/or conidia of Fusarium oxysporum or Botrytis cinerea) may be extracted at room temperature, for example using chloroform:methanol at 2:1 and 1:2 (v/v) ratios. Extracts so prepared may be combined and dried to provide a crude lipid extract or TLE.

Accordingly, in some embodiments, the VHH may be capable of (specifically) binding to a lipid-containing fraction of the plasma membrane of a fungus (such as Fusarium oxysporum or Botrytis cinerea), wherein the lipid-containing fraction of the plasma membrane of the fungus is obtained or obtainable by chromatography. The chromatography may be normal-phase flash chromatography or thin-layer chromatography. Binding of the VHH to the lipid to the lipid-containing fraction may be determined according to bio-layer interferometry. In some embodiments, the chromatography step may be performed on a crude lipid fraction obtained or obtainable by a method comprising extracting lipids from fungal hyphae and/or conidia from a fungal sample. The extraction step may use chloroform:methanol at 2:1 and 1:2 (v/v) ratios to provide two extracts, and then combining the extracts.

In methods relating to thin-layer chromatography, the chromatography may comprise the steps of: fractionating hyphae of the fungus by total lipid extract thin-layer chromatography and selecting the fraction with a Retention Factor (RD higher than the ceramide fraction and lower than the non-polar phospholipids fraction.

In some methods relating to thin-layer chromatography, the chromatography may comprise the steps of:
fractionating hyphae and/or conidia of a fungus (for example Botrytis cinerea or other fungus) by total lipid extract thin-layer chromatography on a silica-coated glass slide using a chloroform/methanol mixture (for example 85/15% v/v) as the eluent and selecting the fraction with a Retention Factor (RD higher than the ceramide fraction and lower than the non-polar phospholipids fraction.

In methods relating to normal-phase flash chromatography, the chromatography may comprise the steps of:
fractionating hyphae and/or conidia of a fungus (for example Botrytis cinerea or other fungus) by total lipid extract normal-phase flash chromatography, and selecting the fraction with a Retention Factor (RD higher than the ceramide fraction and lower than the non-polar phospholipids fraction.

In some methods relating to normal-phase flash chromatography, the chromatography may comprise the steps of:
fractionating hyphae and/or conidia of a fungus (for example Botrytis cinerea or other fungus) by total lipid extract normal-phase flash chromatography comprising dissolving the TLE in dichloromethane (CH2Cl2) and MeOH and using CH2Cl2/MeOH (for example 85/15%, v/v) as the eluent, followed by filtration of the fractions through a filter.

In some methods relating to normal-phase flash chromatography, the chromatography may comprise the steps of:
fractionating hyphae and/or conidia of a fungus (for example Botrytis cinerea or other fungus) by total lipid extract normal-phase flash chromatography comprising dissolving the TLE in dichloromethane (CH2Cl2) and MeOH loading the TLE on to a phase flash cartridge (for example a flash cartridge with 15 μm particles), running the column with CH2Cl2/MeOH (85/15%, v/v) as the eluent, and filtering the fractions through a filter (for example a 0.45 μm syringe filter with a nylon membrane) and drying the fractions.

In some embodiments, the bioactive protein is VHH-1, VHH-2 or VHH-3. For example, in some embodiments, the bioactive protein is a VHH comprising or consisting of a sequence selected from the group consisting of SEQ ID Nos: 1, 2, 6, 10, 14 and 15.

In some embodiments, the bioactive protein is a VHH comprising:
a CDR1 comprising or consisting of a sequence selected from the group consisting of SEQ ID Nos 3, 7 and 11;
a CDR2 comprising or consisting of a sequence selected from the group consisting of SEQ ID Nos: 4, 8 and 12; and
a CDR3 comprising or consisting of a sequence selected from the group consisting of SEQ ID Nos: 5, 9 and 13.

In some embodiments, the bioactive protein is a VHH comprising:
a CDR1 comprising or consisting of the sequence of SEQ ID NO: 3, a CDR2 comprising or consisting of the sequence of SEQ ID NO: 4 and a CDR3 comprising or consisting of the sequence of SEQ ID NO: 5;
a CDR1 comprising or consisting of the sequence of SEQ ID NO: 7, a CDR2 comprising or consisting of the sequence of SEQ ID NO: 8 and a CDR3 comprising or consisting of the sequence of SEQ ID NO: 9 or
a CDR1 comprising or consisting of the sequence of SEQ ID NO: 11, a CDR2 comprising or consisting of the sequence of SEQ ID NO: 12 and a CDR3 comprising or consisting of the sequence of SEQ ID NO: 13.

In some embodiments, the bioactive protein is a VHH comprising a CDR1 comprising or consisting of the sequence of SEQ ID NO: 3, a CDR2 comprising or consisting of the sequence of SEQ ID NO: 4 and a CDR3 comprising or consisting of the sequence of SEQ ID NO: 5.

In some embodiments, the bioactive protein is a VHH comprising SEQ ID NO: 1.

In some embodiments, the bioactive protein is a VHH comprising SEQ ID NO: 2.

In some embodiments, the bioactive protein is a VHH disclosed in WO2014/177595 or WO2014/191146, the entire contents of which are incorporated herein by reference. More specifically the bioactive protein may be a VHH comprising an amino acid sequence chosen from the group consisting of SEQ ID NO's: 1 to 84 from WO2014/177595 or WO2014/191146, which correspond to SEQ ID NOs: 16 to 99 of the present application.

In some embodiments, the bioactive protein is a VHH comprising (a) the amino acid sequence provided in any one of SEQ ID NOs: 1, 2, 6, 10 or 14 to 99, or (b) an amino acid sequence that is at least 80%, preferably at least 90%, identical to any one of SEQ ID NOs: 1, 2, 6, 10 or 14 to 99.

In some embodiments, the VHHs are fused to a carrier peptide.

“Heavy chain variable domain of an antibody or a functional fragment thereof” or “immunoglobulin single variable domain” (also indicated hereafter as VHH), as used herein, means (i) the variable domain of the heavy chain of a heavy chain antibody, which is naturally devoid of light chains, including but not limited to the variable domain of the heavy chain of heavy chain antibodies of camelids or sharks or (ii) the variable domain of the heavy chain of a conventional four-chain antibody (also indicated hereafter as VH), including but not limited to a camelized (as further defined herein) variable domain of the heavy chain of a conventional four-chain antibody (also indicated hereafter as camelized VH).

As used herein, the terms “complementarity determining region” or “CDR” within the context of antibodies refer to variable regions of either the H (heavy) or the L (light) chains (also abbreviated as VH and VL, respectively) and contain the amino acid sequences capable of specifically binding to antigenic targets. These CDR regions account for the basic specificity of the antibody for a particular antigenic determinant structure. Such regions are also referred to as “hypervariable regions.” The CDRs represent non-contiguous stretches of amino acids within the variable regions but, regardless of species, the positional locations of these critical amino acid sequences within the variable heavy and light chain regions have been found to have similar locations within the amino acid sequences of the variable chains. The variable heavy and light chains of all canonical antibodies each have 3 CDR regions, each non-contiguous with the others (termed L1, L2, L3, H1, H2, H3) for the respective light (L) and heavy (H) chains.

As further described hereinbelow, the amino acid sequence and structure of a heavy chain variable domain of an antibody can be considered, without however being limited thereto, to be comprised of four framework regions or “FR's”, which are referred to in the art and hereinbelow as “framework region 1” or “FR1”; as “framework region 2” or “FR2”; as “framework region 3” or “FR3”; and as “framework region 4” or “FR4”, respectively, which framework regions are interrupted by three complementary determining regions or “CDR's”, which are referred to in the art as “complementarity determining region 1” or “CDR1”; as “complementarity determining region 2” or “CDR2”; and as “complementarity determining region 3” or “CDR3”, respectively.

As also further described hereinbelow, the total number of amino acid residues in a heavy chain variable domain of an antibody (including a VHH or a VH) can be in the region of 110-130, is preferably 112-115, and is most preferably 113. It should however be noted that parts, fragments or analogs of a heavy chain variable domain of an antibody are not particularly limited as to their length and/or size, as long as such parts, fragments or analogs retain (at least part of) the functional activity, such as the pesticidal, biocidal, biostatic activity, fungicidal or fungistatic activity (as defined herein) and/or retain (at least part of) the binding specificity of the original a heavy chain variable domain of an antibody from which these parts, fragments or analogs are derived from. Parts, fragments or analogs retaining (at least part of) the functional activity, such as the pesticidal, biocidal, biostatic activity, fungicidal or fungistatic activity (as defined herein) and/or retaining (at least part of) the binding specificity of the original heavy chain variable domain of an antibody from which these parts, fragments or analogs are derived from are also further referred to herein as “functional fragments” of a heavy chain variable domain.

“Biostatic (effect)” or “biostatic use”, as used herein, includes any effect or use of an active substance (optionally comprised in a biostatic, biocidal, fungicidal or fungistatic composition as defined herein) for controlling, modulating or interfering with the harmful activity of a pest, such as a plant pest or a plant pathogen, including but not limited to inhibiting the growth or activity of the pest, altering the behaviour of the pest, and repelling the pest in or on plants, plant parts or in other agro-related settings, such as for example for household uses or in soil.

“Biocidal (effect)” or “biocidal use”, as used herein, includes any effect or use of an active substance (optionally comprised in a biocidal or fungicidal composition as defined herein) for killing the pest in or on plants, plant parts or in other agro-related settings, such as for example for household uses or in soil.

“Anti-fungal” activity or effect refers to fungistatic and/or fungicidal activity or effect.

“Fungistatic (effect)” or “Fungistatic use” or “fungistatic activity”, as used herein, includes any effect or use of an active substance (optionally comprised in a fungicidal or fungistatic composition as defined herein) for controlling, modulating or interfering with the harmful activity of a fungus, including but not limited to inhibiting the growth or activity of the fungus, altering the behaviour of the fungus, and repelling the fungus in or on plants, plant parts or in other agro-related settings, such as for example for household uses or in soil.

“Fungicidal (effect)” or “Fungicidal use” or “fungicidal activity”, as used herein, includes any effect or use of an active substance (optionally comprised in a fungicidal composition as defined herein) for killing the fungus in or on plants, plant parts or in other agro-related settings, such as for example for household uses or in soil.

“Pesticidal activity” or “biocidal activity”, as used interchangeably herein, means to interfere with the harmful activity of a pest, including but not limited to killing the pest.

“Biostatic activity”, as used herein, means to interfere with the harmful activity of a pest, including but not limited to inhibiting the growth or activity of the pest, altering the behaviour of the pest, or repelling the pest.

Pesticidal, biocidal, or biostatic activity of an active ingredient, substance or principle or a composition or agent comprising a pesticidal, biocidal, or biostatic active ingredient, substance or principle, can be expressed as the minimum inhibitory activity (MIC) of an agent (expressed in units of concentration such as e.g. mg/mL), without however being restricted thereto.

“Fungicidal activity”, as used herein, means to interfere with the harmful activity of a fungus, including but not limited to killing the fungus.

“Fungistatic activity”, as used herein, means to interfere with the harmful activity of a fungus, including but not limited to inhibiting the growth or activity of the fungus, altering the behaviour of the fungus, and repelling the fungus.

Fungicidal or fungistatic activity of an active ingredient, substance or principle or a composition or agent comprising a pesticidal, biocidal, or biostatic active ingredient, substance or principle, can be expressed as the minimum inhibitory activity (MIC) of an agent (expressed in units of concentration such as e.g. mg/mL), without however being restricted thereto.

A method for numbering the amino acid residues of heavy chain variable domains is the method described by Chothia et al. (Nature 342, 877-883 (1989)), the so-called “AbM definition” and the so-called “contact definition”. Herein, this is the numbering system adopted.

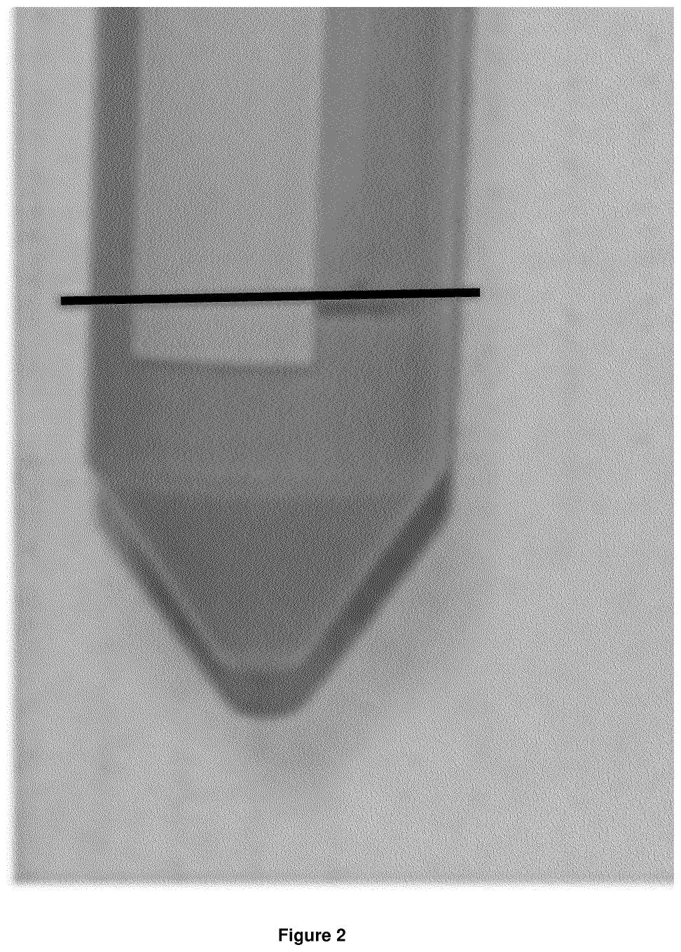

Alternatively, the amino acid residues of a variable domain of a heavy chain variable domain of an antibody (including a VHH or a VH) may be numbered according to the general numbering for heavy chain variable domains given by Kabat et al. (“Sequence of proteins of immunological interest”, US Public Health Services, NIH Bethesda, Md., Publication No. 91), as applied to VHH domains from Camelids in the article of Riechmann and Muyldermans, referred to above (see for example FIG. 2 of said reference).

For a general description of heavy chain antibodies and the variable domains thereof, reference is inter alia made to the following references, which are mentioned as general background art: WO 94/04678, WO 95/04079 and WO 96/34103 of the Vrije Universiteit Brussel; WO 94/25591, WO 99/37681, WO 00/40968, WO 00/43507, WO 00/65057, WO 01/40310, WO 01/44301, EP 1134231 and WO 02/48193 of Unilever; WO 97/49805, WO 01/21817, WO 03/035694, WO 03/054016 and WO 03/055527 of the Vlaams Instituut voor Biotechnologie (VIB); WO 03/050531 of Algonomics N.V. and Ablynx NV; WO 01/90190 by the National Research Council of Canada; WO 03/025020 (=EP 1 433 793) by the Institute of Antibodies; as well as WO 04/041867, WO 04/041862, WO 04/041865, WO 04/041863, WO 04/062551 by Ablynx; Hamers-Casterman et al., Nature 1993 Jun. 3; 363 (6428): 446-8.

Generally, it should be noted that the term “heavy chain single variable domain” or “immunoglobulin single variable domain” as used herein in its broadest sense is not limited to a specific biological source or to a specific method of preparation. For example, heavy chain single variable domains can be obtained (1) by isolating the VHH domain of a naturally occurring heavy chain antibody; (2) by isolating the VH domain of a naturally occurring four-chain antibody; (3) by expression of a nucleotide sequence encoding a naturally occurring VHH domain; (4) by expression of a nucleotide sequence encoding a naturally occurring VH domain; (5) by “camelization” (as described below) of a naturally occurring VH domain from any animal species, in particular a species of mammal, such as from a human being, or by expression of a nucleic acid encoding such a camelized VH domain; (6) by “camelisation” of a “domain antibody” or “Dab” as described by Ward et al (supra), or by expression of a nucleic acid encoding such a camelized VH domain; (7) using synthetic or semi-synthetic techniques for preparing proteins, polypeptides or other amino acid sequences; (8) by preparing a nucleic acid encoding a VHH or a VH using techniques for nucleic acid synthesis, followed by expression of the nucleic acid thus obtained; and/or (9) by any combination of the foregoing. Suitable methods and techniques for performing the foregoing will be clear to the skilled person based on the disclosure herein.

However, according to a specific embodiment, the heavy chain variable domains as disclosed herein do not have an amino acid sequence that is exactly the same as (i.e. as a degree of sequence identity of 100% with) the amino acid sequence of a naturally occurring VH domain, such as the amino acid sequence of a naturally occurring VH domain from a mammal, and in particular from a human being.

### [Spray-Drying]

In order to provide a protein-containing composition derived from a fermentation broth in a solid or essentially solid state, a spray-drying process may be used in order to evaporate the water content present in the microbial fermentation broth. For this, an aqueous microbial fermentation broth (which may be supplemented with one or more additives, co-formulants or excipients) is sprayed by a spray drying apparatus. Spray drying apparatuses used for spray drying of a microbial fermentation broth are widely known and may spray from the bottom, the top, or any other suitable orientation. The term spray drying apparatus used herein refers to set-ups that are capable of spray drying a microbial fermentation broth. When referring herein to a vessel or the vessel, it is understood to indicate the vessel that is comprised in a spray drying apparatus. The parameters used in a spray-drying apparatus need to be carefully controlled. The amount of liquid and the rate of addition will influence the spray-drying process, as is commonly known.

A spray drying process may comprise at least the steps of spraying the liquid protein-containing composition and applying heat to evaporate the liquid. However, the process may optionally also comprise further steps, e.g. a pre-heating phase to bring the liquid protein-containing composition feed to an appropriate temperature or pre-concentrating the microbial fermentation broth to increase the concentration of solids in the microbial fermentation broth. Thus, by increasing the amount of solids in the microbial fermentation broth, the amount of liquid in the form of water is reduced.

The spray-drying process can be continuous or discontinuous. In a preferred embodiment a continuous process is used where solid or essentially solid protein-containing composition is continuously extracted from the spray-drying apparatus during the spray drying process. The skilled person will know how to adjust the agitation parameters in order to capture the solid or essentially solid protein-containing composition.

During a continuous or discontinuous spray-drying process the residence time of a single theoretical unit, such as the content of a single droplet sprayed into the vessel or a single bioactive protein, can have a residence time of over 8 hours. With the residence time is meant the time-span between the time beginning where the microbial fermentation broth containing a single theoretical unit enters the vessel by being sprayed into the vessel and where under the influence of heat and agitation liquid is evaporated and solid or essentially solid protein-containing compositions are formed into a powder containing said theoretical unit has reached the required size and can be removed from the vessel. In some embodiments the residence time is 10 hours or less. In other preferred embodiments the residence time is 8 hours or less. In more preferred embodiments the residence time is 6 hours or less. In even more preferred embodiments, the residence time is 4 hours or less. In more preferred embodiments the residence time is 2 hours or less. In some set-ups the residence time can even decrease to less than 1 hour or even less than 30 minutes. The skilled person will know that a reduced residence time has the advantage of speeding up the process and potentially further improving the integrity of the bioactive protein in the solid or essentially solid protein-containing composition. The residence time will also depend on the characteristics of the microbial fermentation broth, for instance a high water content will require increased drying time for sufficient water to evaporate. Furthermore, residence time can also decrease by including multiple spray nozzles to spray the microbial fermentation broths into the vessel. Examples of these are industrial size spray drying apparatus containing 2, 3, 4 or more spray nozzles in different orientation, increasing the throughput of microbial fermentation broth, and at the same time allowing for faster formation of a solid or essentially solid protein-containing composition and thus a reduced residence time.

In a discontinuous process, a separate phase of drying may ensue, following the formation and extraction of the solid or essentially solid protein-containing composition. In this case no additional liquid is added to the reaction vessel where application of heat continues until a desired residual content of liquid is achieved. The drying phase may not be necessary, e.g. in case the liquid content is continuously kept below the desired level by adjusting the process parameters appropriately. In a discontinuous process, where the water content of the solid or essentially solid protein-containing composition is too high, an extra heating step can be applied at the end of the spray drying process to ensure appropriate water content in the final solid or essentially solid protein-containing composition.

In the preferred continuous process, for example the solid or essentially solid protein-containing composition extracted from the vessel could be subjected to an extra drying process in a further downstream dryer or oven if needed. In a preferred embodiment, the solid or essentially solid protein-containing composition extracted from the vessel contains the preferred water content and do not require an additional drying step. In preferred embodiments, the water content of the solid or essentially solid protein-containing composition is lower than 15% w/w. In more preferred embodiments, the water content of the solid or essentially solid protein-containing composition is lower than 12% w/w. In more preferred solid or essentially solid protein-containing composition, the water content of the solid or essentially solid protein-containing composition is lower than 10% w/w. In more preferred embodiments, the water content of the solid or essentially solid protein-containing composition is lower than 9% w/w. In more preferred embodiments, the water content of the solid or essentially solid protein-containing composition is lower than 8% w/w. In a more preferred embodiment, the water content of the solid or essentially solid protein-containing composition is lower than 7% w/w. In a more preferred embodiment, the water content of the solid or essentially solid protein-containing composition is lower than 6% w/w. In a more preferred embodiment, the water content of the solid or essentially solid protein-containing composition is lower than 5% w/w. In a more preferred embodiment, the water content of the solid or essentially solid protein-containing composition is lower than 4% w/w. In an even more preferred embodiment, the water content of the solid or essentially solid protein-containing composition is lower than 3% w/w. In another preferred embodiment, the water content of the solid or essentially solid protein-containing composition is lower than 2% w/w. In yet another preferred embodiment, the water content of the solid or essentially solid protein-containing composition is lower than 1% w/w.

Spray drying process parameters that can be readily adjusted by the skilled person include the rate of adding the liquid, the form and intensity of applying heat, e.g. the volume and temperature of a heated gas streamed through the reaction vessel, the intensity and form of physical agitation, e.g. mixing or fluidizing by use of a gas stream, and the overall duration of the process. The skilled person can derive guidance on suitable process parameters from his common knowledge in spray-drying processes. Heat can be applied by any means available to the skilled person, e.g. by heating the reaction vessel, by applying radiation such as microwaves, or by applying a heated gas stream. In a preferred embodiment the fluidized bed and the microbial fermentation broth are contacted with a heated gas stream, e.g. heated air, to evaporate the liquid. The skilled person knows many alternative gases that are compatible with the materials and active agents used in the process, including inert gases such as nitrogen or noble gases, and air. In one preferred embodiment the gas is air.

For drying the microbial fermentation broth, heat may be applied to the microbial fermentation broth. The prolonged exposure to heat in a liquid state under shear stress conditions has previously been considered unsuitable for producing solid bioactive proteins formulations such as the spray dried solid or essentially solid protein-containing containing bioactive protein such as an immunoglobulin single variable domain. It was expected to lead to loss of biological activity due to chemical and physical instability. It had been previously shown that up to a certain temperature of the fluid bed (up to 56° C.) and during relatively short processing times an immunoglobulin single variable domain or VHH can remain stable (see WO2012130872) in a coating/aggregation process where a microbial fermentation broth containing an immunoglobulin single variable domain or VHH is coated onto a solid carrier composed of mannitol.

During the spray drying process the spray dried powder enters in a state also referred to as a fluidized bed during its residence in the vessel of the spray-drying apparatus. A fluidized bed is a physical phenomenon that occurs when a solid particulate substance in the vessel is agitated under the right conditions so that it behaves like a fluid. The temperature of the fluidized bed is monitored and controlled by changing the temperature of for example the air inlet. The fluidized bed is where the protein-containing composition is in a solid or essentially solid state and it is here that temperature may be controlled so to not overheat and potentially degrade the bioactive properties of the protein-containing compositions, for example degrade the bioactive protein that may be present in the protein-containing composition.

In one embodiment, the temperature of the fluidized bed is kept at a temperature between 40° C. and 100° C. (a temperature in the range of 40° C. to 100° C.). In a preferred embodiment, the temperature of the fluidized bed is kept at a temperature between 40° C. and 80° C. (a temperature in the range of 40° C. to 80° C.). In a preferred embodiment, the temperature of the fluidized bed is kept at a temperature between 45° C. and 75° C. (a temperature in the range of 45° C. to 75° C.). In a preferred embodiment, the temperature of the fluidized bed is kept at a temperature between 50° C. and 70° C. (a temperature in the range of 50° C. to 70° C.). In a preferred embodiment, the temperature of the fluidized bed is kept at a temperature between 55° C. and 65° C. (a temperature in the range of 55° C. to 65° C.). In a preferred embodiment, the temperature of the fluidized bed is kept at a temperature between 58° C. and 63° C. (a temperature in the range of 58° C. to 63° C.).

In one embodiment, the temperature of the heated gas stream is kept at a temperature between 70° C. and 120° C. (a temperature in the range of 70° C. to 120° C.) immediately prior to entering the vessel of the spray-drying apparatus (e.g., fluidized bed reactor). In a preferred embodiment the temperature of the heated gas stream is kept at a temperature between 75° C. and 110° C. (a temperature in the range of 75° C. to 110° C.). In a preferred embodiment the temperature of the heated gas stream is kept at a temperature between 80° C. and 105° C. (a temperature in the range of 80° C. to 105° C.) immediately prior to entering the vessel of the spray-drying apparatus (e.g., fluidized bed reactor). In a preferred embodiment the temperature of the heated gas stream is kept at a temperature between 90° C. and 100° C. (a temperature in the range of 90° C. to 100° C.) immediately prior to entering the vessel of the spray-drying apparatus (e.g., fluidized bed reactor). Alternatively, in some embodiments the heated gas stream is kept at a temperature of between 100° C. and 110° C. (a temperature in the range of 100° C. to 110° C.) immediately prior to entering the vessel of the spray-drying apparatus (e.g., fluidized bed reactor). The skilled person will understand that in order to keep the temperature of the fluid bed at a certain desired temperature, the temperature of the heated gas stream is adjusted. For example, when the spray rate is increased, the fluid bed temperature would cool down which is anticipated by increasing the temperature of the heated gas stream. The temperature of the heated gas stream is thus adapted in function of the temperature of the fluidized bed.

The flow rate of the heated gas can vary strongly depending on the size of the vessel wherein the spray drying takes place. For example, a small pilot set-up may have a flowrate of heated gas of between 45 and 60 m³/h. Whereas a larger vessel will need flow rates of up to 1200 m³/h. A fully industrial sized vessel for spray-drying will have flow rates of heated gas of even 5000 to 6000 m³/h or even higher. The skilled person will know that the larger the vessel, the larger the volume of microbial fermentation broth that is applied and thus the higher the flow rate of heated air needs to be to maintain the fluidized bed and maintain a constant temperature in the fluidized bed as well as to provide sufficient heated air to evaporate water from the sprayed microbial fermentation broth.

The spray rate is understood to be the rate at which the microbial fermentation broth is passed through a spraying nozzle and enters the vessel. The spray rate is often provided as a measure of liters of microbial fermentation broth per hour. Alternatively the measurement is given in kg per hour or kg per minute. In one embodiment the spray rate is 1 l/h or more. In a preferred embodiment the spray rate is 2 l/h or more. In a preferred embodiment the spray rate is 3 l/h or more. In a preferred embodiment the spray rate is 4 l/h or more. In a preferred embodiment the spray rate is 5 l/h or more. In a preferred embodiment the spray rate is 6 l/h or more. In a preferred embodiment the spray rate is 7 l/h or more. In a preferred embodiment the spray rate is 8 l/h or more. In a preferred embodiment the spray rate is 9 l/h or more. In a preferred embodiment the spray rate is 10 l/h or more. In a preferred embodiment the spray rate is 11 l/h or more. In a preferred embodiment the spray rate is 12 l/h or more. In a preferred embodiment the spray rate is 13 l/h or more. In a preferred embodiment the spray rate is 14 l/h or more. In a more preferred embodiment, the spray rate is 15 l/h or more. In a preferred embodiment, the spray rate is between 15 l/h and 24 l/h (in the range of 15 l/h to 24 l/h). In a more preferred embodiment, the spray rate is between 20 l/h and 24 l/h (in the range of 20 l/h to 24 l/h). In an even more preferred embodiment, the spray rate is between 22 l/h and 24 l/h (in the range of 22 l/h to 24 l/h). On an industrial scale the spray rate can be increased even further. In some embodiments the spray rate is 50 l/h or more. In a more preferred embodiment the spray rate is 100 l/h or more. In a most preferred embodiment, the spray rate is 150 l/h or more. These spray-rates can be achieved using one single nozzle but might as well be achieved using a plurality of nozzles. For example, 2, 3, 4 or more spray nozzles can be used in different orientation in the vessel.

The terms “spraying” or “sprayed”, as used herein, mean the process of passing a liquid composition (e.g., the microbial fermentation broth) under pressure through a fine opening or nozzle. Many different nozzles and spray patterns exist, and the skilled person will be well aware of the combination of nozzles and pressures that are suitable for obtaining high spray rates while maintaining appropriately sized droplets. When a liquid composition (e.g., microbial fermentation broth) is sprayed, the liquid jet is broken into very fine droplets. Sometimes referred to as atomization or liquid atomization. The size of the droplets will influence the speed at which the water evaporates from the liquid composition (e.g., microbial fermentation broth) and will thus influence the spray-drying process as well. In a preferred embodiment the liquid composition (e.g., microbial fermentation broth) is sprayed through a pressurized or pneumatic nozzle where along with the liquid composition (e.g., microbial fermentation broth) air is injected in the nozzle together with the liquid composition (e.g., microbial fermentation broth). This is often referred to as atomization air and the pressure at which the atomization air is introduced into the nozzle system is the atomization pressure. In one embodiment the atomization pressure is between 1 and 5 bar (in the range of 1 to 5 bar). The skilled person will know what the suitable air pressure is for a specific type of nozzle at a specific spray rate, as well as the manufacturer's instructions for the specific nozzle will guide the skilled person. In a preferred embodiment a pneumatic nozzle is used to spray the liquid composition (e.g., microbial fermentation broth) such as for example a binary nozzle. Pneumatic nozzles lead to the formation of very small droplets. This process is known as pneumatic atomization. For example, droplets of approximately 20 μm can be formed using pneumatic atomization.

The spray dried powder particles can be characterized by their size distributions, which can be determined by dynamic light scattering methods. The D50 value for the particles in the instant case is typically up to 200 μm, preferably up to 150 μm, more preferably up to 100 μm, most preferably up to 50 μm, and especially preferably up to 25 μm. In some preferred embodiments the spray dried product may contain particles with a D50 value below 25 μm. In some embodiments the spray-dried powder is further ground or milled into a finer powder. In another more preferred embodiment the spray-dried powder is further ground or milled into a an even finer powder or essentially a dust with a D50 value of 50 μm or lower. In a more preferred embodiment, the spray dried powder is reduced further in size whilst already formulated into an oil vehicle i.e. the formulations according to the invention may be mixed using for example a bead mill or a by adding glass beads during the mixing process. Often the rheology modifier or thickener may be added at the end of the optional mixing step to further stabilize the self-emulsifiable concentrate where needed. The result of this grinding is that the dust particles will decrease in size whilst already suspended in the oil vehicle, resulting in less sedimentation. Without wanting to be bound by theory, this additional step might further increase the stability of the self-emulsifiable concentrate of the invention by increasing the total surface area of the particles that make up the protein-containing composition.

### [Self-Emulsifiable Concentrate]

A self-emulsifiable concentrate, here also referred to as an oil dispersion or OD, comprises an oil vehicle in which a solid or essentially solid protein-containing composition is dispersed.

The self-emulsifiable concentrate may comprise the protein-containing composition in a concentration of at least 15% w/w, preferably at least 20% w/w more preferably at least 25% w/w, more preferably at least 30% w/w, or more preferably at least 40% w/w, based on the total weight of the self-emulsifiable concentrate. In some embodiments the self-emulsifiable concentrate may comprise the protein-containing composition in a concentration of at least 50% w/w based on the total weight of the self-emulsifiable concentrate. Where the protein-containing composition comprises a bioactive protein, the protein-containing composition may comprise the bioactive protein in a concentration of at least 5%, more preferably at least 10% w/w, even more preferably 20% w/w or more, even more preferably 30% w/w or more, even more preferably 40% w/w or more, even more preferably up to 50% w/w or more, based on the total weight of the protein-containing composition.

The protein-containing composition has a very low solubility in the oil vehicle. Since the oil vehicle is very lipophilic, the solubility of the protein-containing composition is best measured in a lipophilic hydrocarbon such as 1-octanol. Such a measurement is sometimes referred to as the partition coefficient, octanol-water coefficient or K_{OW} value. The partition coefficient of a substances is calculated by mixing the substance in equal volumes water and for example 1-octanol and determining the concentration of the substance in both the water phase and the 1-octanol phase. The log value of the concentration in octanol over the concentration in water determines the partitioning coefficient value. Therefore, in a preferred embodiment the protein-containing composition has a partition coefficient of up to 0. In a more preferred embodiment, the partition coefficient is between −10 and 0.

The protein-containing composition is present in the form of particles that are dispersed in the oil vehicle. The particles can be characterized by their size distributions, which can be determined by dynamic light scattering methods. The D50-value is a statistical figure that indicates a maximum particle diameter that characterizes 50% by volume of all particles. In other words, 50% (v/v) of all particles have a diameter that is equal or smaller than the D50 value. The D50 value for the particles in the instant case is typically up to 200 μm, preferably up to 150 μm, more preferably up to 100 μm, most preferably up to 50 μm, and especially preferably up to 25 μm. In some preferred embodiments the protein-containing composition may contain particles with a D50 value below 25 μm.

One objective of this invention is to improve the shelf life of the protein-containing composition. Contrary to self-emulsifiable concentrates where the active ingredient is dispersed in a solid form in an oil vehicle, an aqueous formulation is prone to degradation of e.g., bioactive proteins due to for example oxidation reactions, proteolytical activity and so forth. Furthermore, aqueous compositions can be contaminated with microorganisms, leading to the spoilage of the product and the degradation of the bioactive protein. The shelf life can be determined by storing vessels containing the product at a fixed temperature for extended periods of times whilst taking regular samples and assessing the physicochemical and bioactive status of the product. Shelf-life experiments can be accelerated by storage at higher temperatures. For example, CIPAC method MT 46.3—Accelerated storage procedure. In one embodiment, the self-emulsifiable compositions are stable for at least 6 months of storage at 2-8° C. In a preferred embodiment, the self-emulsifiable compositions are stable for at least 1 year of storage at 2-8° C. In a most preferred embodiment, the self-emulsifiable compositions are stable for at least two years of storage at 2-8° C. In one embodiment, the self-emulsifiable compositions are stable for at least 6 months of storage at 18-22° C. temperature. In a preferred embodiment, the self-emulsifiable compositions are stable for at least 1 year of storage at 18-22° C. temperature. In a most preferred embodiment, the self-emulsifiable compositions are stable for at least two years at 18-22° C. temperature. In one embodiment, the self-emulsifiable compositions are stable for at least 3 months of storage at stressed temperature conditions of 45° C. In a preferred embodiment, the self-emulsifiable compositions are stable for at least 6 months of storage at stressed temperature conditions of 45° C. In a most preferred embodiment, the self-emulsifiable compositions are stable for at least 1 year at stressed temperature conditions of 45° C. The skilled person will understand that storage stability is also dependent on the packages protecting self-emulsifiable compositions from for instance air, moisture and heat. For example, for good storage stability a 3-layer packaging may be used, composed out of one layer of Polyethylene terephthalate, one layer of Aluminum and one layer of low-density polyethylene for example commercially available as Lamizip stazakken zilver, DaklaPack. Alternatively, HDPE canisters, may be used as well as metal, glass or fluorinated PP or PE canisters.

### [Components of the Self-Emulsifiable Composition]

The self-emulsifiable concentrate of the invention comprises a protein-containing composition that is dispersed in an oil vehicle. In one embodiment, the oil vehicle in which the protein-containing composition is dispersed is selected from vegetable oils, synthetic oils, fatty acids or combinations thereof. In a more preferred embodiment, the oil vehicle in which the protein-containing composition is dispersed comprises one or more vegetable oils. In a preferred embodiment the vegetable oil is an environmentally approved oil, such as an OMRI-listed oil or an oil approved by the Environmental Protection Agency (EPA). In an even more preferred embodiment the vegetable oils are selected almond oil, Apricot kernel oil, linseed oil, oxidised linseed oil, polymerized linseed oil, Macadamia nut oil, safflower oil, sesame seed oil, soyabean oil, sunflower oil, rapeseed (canola) oil, olive oil, wheat germ oil, castor oil, oxidized castor oil, colza oil, coconut oil, soybean oil, maize germ oil, cottonseed oil, canola oil, peanut oil and corn oil. In some embodiments, the oil vehicle is a mixture of different oils. In a preferred embodiment, the oil vehicle is a soybean oil.

In one embodiment, the oil vehicle is present in an amount in the range of 18% to 77% w/w. Preferably, the oil vehicle is present in an amount in the range of 40% to 70% w/w, more preferably in an amount of about 49% w/w.

The self-emulsifiable concentrate optionally may comprise one or more thickening agents, i.e., other than the protein-containing composition. Thickening agents are used to control sedimentation. Thickening agents are also known as rheology modifiers, rheology agents, anti-caking agents, viscosity modifiers or structuring agents, and generally provide increased viscosity to the OD formulation. In addition to increasing the viscosity of the OD formulation, thickening agents have a shear thinning capability that allows the gel network they form to easily breakdown upon application of a small external force. This shear thinning allows the OD formulation to maintain its viscosity and physical stability while at rest but allows this viscosity to quickly dissipate when external force is applied so that the product can be easily poured or pumped from its container, mixed in a carrier such as water and applied to an area where it is needed. Thickening agents that may be used in the self-emulsifiable concentrate may include but are not limited to natural polymers, synthetic polymers, inorganic material or any combination thereof. Natural polymers that may be used in the subject formulation may include but are not limited to polysaccharides including cellulose, agarose, dextran, alginates, carrageenans, starch, and chitosan; and proteins including gelatin and albumin; or any combination thereof. Thickening agents can be mineral or derived from minerals (e.g. organoclays, fumed silica, precipitated silica), swellable polymers (e.g., polyamides or hydrogenated caster oils), associative thickeners which form structures by themselves (e.g., EO/PO block co-polymers), or they can be steric dispersants (e.g., comb polymers such as polyvinylpyrrolidinones or polyacrylates). These rheological or structuring agents provide long term stability when the product is at rest or in storage. Synthetic polymers that may be used in the subject formulation may include but are not limited to polystyrene, polyacrylamide, polymethylacrylates, polyamides, polyesters, polyanhydrides, polyurethanes, amino resins, polycyanoacrylates, or any combination thereof. In some embodiments, the thickening agent is a polyamide polymer. In another embodiment, the thickening agent is a copolyimide. In another embodiment the thickening agent is a polyester block co-polymer more specifically a Polyamide-polyether block copolymer such as described in EP1606334B1, EP232668A1 or EP1504050B1. In yet another embodiment, the thickening agent is a thermoplastic polyamide. Polyamides that may be used in the subject formulation may include but are not limited to polyamides sold by Croda under the trademarks Atlox Rheostrux™ 200 PA, Atlox Rheostrux™ 100 PA and Atlox Rheostrux™ 300 PA. Other examples are copolyamides sold by Arkema under the registered mark Platamid®, and thermoplastic polyamides sold by Dupont under the registered mark Elvamide® 8066. In another embodiment the thickening agent is a silicon dioxide such as the hydrophilic fumed silica sold by Evonik under the trademark Aerosil, more specifically Aerosil 200. In yet another embodiment, the thickening agent is a precipitated silica sold by Evonik under the trademark Sipernat 22 or Sipernat 50s. In yet another embodiment, the thickening agent is an attapulgite clay powder such as Attagel 50 available from BASF. Preferably, the thickening agent is a silicon dioxide.

One value which may be considered when composing a self-emulsifiable concentrate is the Hydrophile-Lipophile Balance (HLB). This value may help guide the skilled person in finding the correct components for creating a stable well performing self-emulsifiable concentrate. HLB is a numerical system used to describe the relationship between the water-soluble and oil-soluble parts of a nonionic surfactant. HLB numbers range from 1 to 30 (perhaps higher). For instance, if a surfactant has an HLB=1, it is considered very oil soluble, while a surfactant with an HLB=15 is considered to be water soluble. The calculation of “hydrophilic-lipophilic balance” values (“HLB value”) are described for example by Michael E. Aulton, Pharmaceutics—The Science of Dosage Form Design, Second Edition, Churchill Livingston, 2001, p. 95-99. It is understood that dispersant properties can be defined by their HLB value but the actual behaviour of a compound is dependent on the full context of the formulation. As such a certain product might show characteristics of both an emulsifier as a dispersant. In general, the following subdivision can apply: <10: Lipid-soluble (water-insoluble); >10: Water-soluble (lipid-insoluble); 1 to 3: anti-foaming agent; 3 to 6: W/O (water in oil) emulsifier; 7 to 9: wetting and spreading agent, dispersant; 13 to 16: detergent; 8 to 16: O/W (oil in water) emulsifier; 16 to 18: solubiliser or hydrotrope.

In order to provide a well-functioning self-emulsifiable concentrate it may be needed to add both a dispersant with a low HLB (below 9) with an emulsifier with a high HLB (above 9).

The self-emulsifiable concentrate also typically comprises dispersants or dispersing aids, which terms include non-ionic surfactants or dispersants with an HLB below 10 and aqueous dispersants with an HLB above 10, and are used to disperse the active ingredient in the oil continuous phase and provide long term stability. In the concentrate, solid particles are susceptible to flocculation, which can lead to an increase in particle size and formulation instability. To prevent flocculation on storage, dispersants adsorb onto the solid particle surface creating a barrier to flocculation and agglomeration. Dispersion performance is primarily dictated by the nature of the surfactants selected, and their collective effect on how they arrange themselves at the particle/oil interface. Suitable dispersants are compounds that have a high affinity to the protein-containing composition without dissolving it in the continuous oil phase. The dispersant is typically non-ionic and readily dissolvable in the oil vehicle. Examples of suitable dispersants are N-hydroxyalkyl amides of saturated and unsaturated fatty acids, preferably N,N-bisdihydroxyethyl amides of saturated and unsaturated fatty acids (e.g. Surfom OD 8104); ethoxylated sorbitans partial esters and peresters, preferably ethoxylated sorbitan oleates (e.g. Atlas G 1096, Atlas G 1086, or Arlatone TV); ethoxylated glycerol esters of hydroxy fatty acids and their derivatives, such as ethoxylated castor oil, ethoxylated and hydrogenated castor oil, or ethoxylated castor oil oleate (e.g. Alkamuls VO 2003); and alkoxylated fatty alcohols and alkyl-aryl-sulfonates or mixtures thereof (e.g. Atlox 3467), fatty alcohol alkoxylates, preferably ethoxylated C₈-C₁₈ alcohols, such as ethoxylated isodecyl and isododecyl alcohol (e.g. Foryl 5999, Lutensol ON 50, Tensiofix NTM, or Tensiofix 96DB10), and alkoxylated polyolefins, such as polyisobutylene succinic anhydride-polyethylene glycol (e.g. Atlox 4914). Other suitable examples are, polyethylene oxide-polypropylene oxide block copolymers, polyethylene glycol ethers of linear alcohols, reaction products of fatty acids with ethylene oxide and/or propylene oxide, polyvinyl alcohol, polyvinylpyrrolidone, copolymers of polyvinyl alcohol and polyvinyl-pyrrolidone, and copolymers of (meth)acrylic acid and (meth)-acrylic acid esters, alkyl ethoxylates and alkylaryl ethoxylates, which can be optionally phosphated and optionally neutralized with bases (where sorbitol ethoxylates may be mentioned by way of example), and polyoxyalkylenamine derivatives may be mentioned. Alkali metal and alkaline earth metal salts of alkylsulphonic acids or alkylarylsulphonic acids are preferred. A further group of anionic surfactants or dispersing aids are salts of polystyrenesulphonic acids, salts of polyvinylsulphonic acids, salts of naphthalenesulphonic acid-formaldehyde condensation products, salts of condensation products of naphthalenesulphonic acid, phenol-sulphonic acid and formaldehyde, and salts of lignosulphonic acid, which are not very soluble in vegetable oil.

In one embodiment, the dispersant are selected from the group of high molecular weight polymers, ethoxylated anchoring groups, carboxylic acid based anchoring groups. For example, the dispersant is selected from Atlox™ 4916, Atlox™ 4914, Atlox™ LP-1 or Zephrym™ PD-2206. In one embodiment the dispersant is a polymeric dispersants. In a preferred embodiment the dispersant is the polymeric dispersant Atlox™ 4916. In another embodiment, the dispersant is a polyether such as the polyether from Evonik under its commercial name Break-Thru DA 646. In a preferred embodiment, the dispersant is a polyisobutylene succinic anhydride-polyethylene glycol.

Most high molecular weight polymers rely on steric hindrance to prevent flocculation and the efficiency with which flocculation is prevented is dependent on the type of oil vehicle used. If the lipophilic chains on the dispersant are not sufficiently oil soluble or long enough then they will shrink and collapse onto the particle surface therefore reducing the steric barrier and increasing the chance of flocculation and agglomeration. The person skilled in the art knows that in order to find the most suitable combination of oil vehicle and a dispersant some trial and error is required. An important parameter for the dispersing power of a dispersant is the molecular weight. Higher molecular weight dispersants will be slower to diffuse to the particle surface; however once they are at the interface, they are typically more strongly adsorbed onto the surfaces due to the greater number of anchoring groups. They are therefore much less likely to be displaced from the surface and can provide greater long term stability. Guidance towards finding the most suitable dispersant can be found in The Formulator's Toolbox found on Croda Crop Care website.

In some embodiments the dispersant is a non-aqueous dispersant.

The self-emulsifiable concentrate typically contains the dispersant in a concentration of from at most 10% w/w, preferably at most 7% w/w, more preferably between 3 and 7% w/w (in the range of 3% to 7% w/w), based on the total weight of the self-emulsifiable concentrate. Preferably, the dispersant is present at a concentration in the range of 3% to 4% w/w. A preferred concentration is about 3%.

Water in oil emulsifiers may be characterized by their HLB value typically from 1 to 12, more preferably from 1 to 11, most preferably from 1 to 10. The HLB value of the W/O-emulsifier may be up to 9, preferably up to 7. Typically, the W/O-emulsifier is a non-ionic amphoteric emulsifier, preferably containing a polyethylene oxide moiety. Suitable W/O emulsifiers may be selected from fatty alcohol alkoxylates, preferably ethoxylated C₁₂-C₁₈ alcohols, such as isotridecyl alcohol that is ethoxylated with two ethylene oxide moieties (e.g. the Lutensol TO series of BASF); polyalkoxylates, preferably copolymers of ethyleneoxide and propylene oxide (e.g. Step Flow LF or Genapol PF10); copolymers and block copolymers of glycerol with hydroxylated saturated and unsaturated fatty acids, such as polyglyceryl-2 dipolyhydroxystearate (e.g. Dehymuls PGPH), ethoxylated glycerol esters of hydroxy fatty acids and their derivatives, such as ethoxylated castor oil, ethoxylated and hydrogenated castor oil, or ethoxylated castor oil oleate (e.g. Toxium 8248, Toximul 8243, Alkamuls VO2003 or 15 Emulsogen EL0200); polyether siloxanes (e.g. Break Thru OE 440), nonionic modified polyesters (e.g. Tersperse 2520), or polyglycerol fatty acid partial esters (e.g. Tego XP11041). Water in oil emulsifiers can also be added as additives to the self-emulsifiable concentrate. For example, polyether siloxanes (e.g. Break Thru OE 440) can be added to improve spreading of the agrochemical composition when applied to crops.

Since most applicants dilute the self-emulsifiable concentrate in an aqueous tank-mix composition, it is advantageous to add an oil-in-water emulsifier (O/W-emulsifier) to the self-emulsifiable concentrate. Such emulsifiers are also generally known to the skilled person. The HLB value of the O/W-emulsifier is typically from 7 to 17, more preferably from 8 to 16, most preferably from 10 to 16. The HLB value of the W/O-emulsifier may be up to 19, preferably up to 18. The HLB value of the O/W-emulsifier may be at least 9, preferably at least 10, more preferably at least 11. Examples of suitable O/W-emulsifiers are ethoxylated sorbitans partial esters and peresters, preferably ethoxylated sorbitans oleates (e.g. Tween 85 or Arlatone TV), alkoxylated fatty alcohols and alkyl-aryl-sulfonates or mixtures thereof (e.g. Atlox 3467), ethoxylated glycerol esters of hydroxy fatty acids and their derivatives, such as ethoxylated castor oil, ethoxylated and hydrogenated castor oil, or ethoxylated castor oil oleate (e.g. Alkamuls VO 2003), N-hydroxyalkyl amides of saturated and unsaturated fatty acids, preferably N,N-bisdihydroxyethyl amides of saturated and unsaturated fatty acids (e.g. Surfom OD 8104), Fermentation products of glucose and rapeseed-oil fatty acids with yeast Starmerella bombicola (e.g. HoneySurf). In a preferred embodiment, the emulsifier is an ethoxylated sorbitan oleate.

The self-emulsifiable concentrate may comprise the O/W-emulsifier typically in a concentration of at least 1% w/w, preferably at least 2% w/w, more preferably at least 3% w/w based on the total weight of the self-emulsifiable concentrate. The self-emulsifiable concentrate may comprise the O/W emulsifier in a concentration of up to 20% w/w, preferably up to 15% w/w, more preferably between 5% and 15% w/w (in the range of 5% to 15% w/w), even more preferably between 5% and 8% w/w (in the range of 5% to 15% w/w) based on the total weight of the self-emulsifiable concentrate. A preferred concentration of emulsifier is about 7% w/w.

Suitable antifoam substances are all substances that can customarily be employed in agrochemical agents for this purpose. Silicone oils and magnesium stearate are preferred. Suitable examples are food-grade silicone antifoam compounds for example Xiameter AFE-1530 (frim DOW) and SAG 471 antifoam concentrate (from Momentive Performance Materials).

Possible preservatives are all substances that can customarily be employed in agrochemical agents for this purpose. Suitable examples are alkaline formulation based on o-phenylphenol such as Preventol® (Bayer AG) and a dipropylene glycol solution of 1,2-benzisothiazolin-3-one such as Proxel®.

Suitable antioxidants are all substances that can customarily be employed in agrochemical agents for this purpose. For example, butylhydroxytoluene.

Possible colorants are all substances that can customarily be employed in agrochemical agents for this purpose. Titanium dioxide, carbon black, zinc oxide, blue pigments, and Permanent Red FGR may be mentioned by way of example.

Suitable inert filling materials are all substances that can customarily be employed in agrochemical agents for this purpose and that do not function as thickening agents. Inorganic particles, such as carbonates, silicates, and oxides and organic substances, such as urea-formaldehyde condensates, are preferred. Kaolin, rutile, silica (“highly disperse silicic acid”), silica gels, and natural and synthetic silicates, as well as talc, may be mentioned by way of example.

In some embodiments the self-emulsifiable concentrate comprises between 15% and 50% w/w (in the range of 15% to 50% w/w) protein-containing composition, between 0% and 10% w/w (in the range of 0% to 10% w/w) thickening agent, between 18% and 77% w/w (in the range of 18% to 77% w/w) oil vehicle, between 5% and 15% w/w (in the range of 5% to 15% w/w) emulsifier and between 3% and 7% w/w (in the range of 3% to 7% w/w) dispersant.

In another embodiment the self-emulsifiable concentrate comprises between 15% and 50% w/w (in the range of 15% to 50% w/w) protein-containing composition, between 0% and 5% w/w (in the range of 0% to 5% w/w) thickening agent, between 23% and 77% w/w (in the range of 23% to 77% w/w) oil vehicle, between 5% and 15% w/w (in the range of 5% to 15% w/w) emulsifier and between 3% and 7% w/w (in the range of 3% to 7% w/w) dispersant.

In some specific embodiments the self-emulsifiable concentrate comprises 40% w/w protein-containing composition, 2.5% thickening agent, 47.5% w/w oil vehicle, 7% w/w emulsifier, 3% w/w dispersant. In another specific embodiment the self-emulsifiable concentrate comprises 40% w/w protein-containing composition, 1.5% w/w thickening agent, 47% w/w oil vehicle, 8% w/w emulsifier, 3.5% w/w dispersant. In another specific embodiment the self-emulsifiable concentrate comprises 40% w/w protein-containing composition, 1.5% w/w thickening agent, 48.5% w/w oil vehicle, 7% w/w emulsifier, 3% w/w dispersant. In another specific embodiment the self-emulsifiable concentrate comprises 40% w/w protein-containing composition, 1% w/w thickening agent, 49% w/w oil vehicle, 7% w/w emulsifier, 3% w/w dispersant. In another specific embodiment the self-emulsifiable concentrate comprises 40% w/w protein-containing composition, 0.5% w/w thickening agent, 49.5% w/w oil vehicle, 7% w/w emulsifier, 3% w/w dispersant.

An exemplary self-emulsifiable concentrate of the invention comprises
(a) a protein containing composition comprises dry matter derived from a microbial fermentation and comprising a bioactive protein, most preferably a VHH;
(b) an oil vehicle selected from rapeseed oil, soybean oil or sunflower oil, preferably soybean oil;
(c) a thickening agent selected from a polyamide, attapulgite clay powder or a silicon dioxide, preferably a silicon dioxide, preferably wherein the thickening agent is present in an amount of no more than 5% w/w;
(d) an ethoxylated sorbitan oleate as an emulsifier; and
(e) a polyisobutylene succinic anhydride-polyethylene glycol as a dispersant.

In a preferred embodiment, the self-emulsifiable concentrate comprises (i) from 20% (w/w) to 50% w/w protein-containing composition and where preferably said protein containing composition comprises dry matter comprising a bioactive protein, preferably a VHH, (ii) from 1% (w/w) to 5% (w/w) thickening agent and where this thickening agent may be selected from a polyamide (such as Rheostrux 200), attapulgite clay powder (such as Attagel 50) or a silicon dioxide such as (Aerosil 200), preferably a silicon dioxides, (iii) from 40% (w/w) to 70% (w/w) oil vehicle and where the oil vehicle is selected from rapeseed oil, soybean oil or sunflower oil, preferably soybean oil, (iv) about 7% (w/w) ethoxylated sorbitans oleates (such as Atlas G-1086), and (v) from 3% (w/w) to 4% (w/w) of polyisobutylene succinic anhydride-polyethylene glycol (such as Atlox 4914) as a dispersant. In a most preferred embodiment, the self-emulsifiable concentrate comprises about 40% (w/w) protein-containing composition comprising dry matter comprising a VHH, (ii) about 2.5% (w/w) of a silicon dioxide (such as Aerosil 200), (iii) about 47.5% (w/w) soybean oil, (iv) about 7% ethoxylated sorbitans oleates (such as Atlas G-1086), and (v) about 3% (w/w) of the dispersant polyisobutylene succinic anhydride-polyethylene glycol (such as Atlox 4914).

After setting a certain concentration of the protein-containing composition, the person skilled in the art can find the suitable concentration of thickening agent that needs to be added to the self-emulsifiable concentrate to maintain its stability. Progressively lower amounts of thickening agents can be incorporated into a series of self-emulsifiable concentrates and observed to visually detect the minimal amount of thickening agent that is required to prevent phase separation to set in. Phase separation is easily detectable by visual observation since the oil fraction will go to the top of the test vial and the solid protein-containing composition will sediment out and potentially harden or crystalize at the bottom of the test vial.

### [Method for Testing Physico-Chemical Stability of the Self-Emulsifiable Concentrate]

In order to test the physico-chemical stability of the self-emulsifiable concentrate, more specifically the physical separation (e.g., separation of the liquid and solid phases) of the self-emulsifiable concentrate over time, the self-emulsifiable concentrate may be placed in a suitable recipient allowing the self-emulsifiable concentrate to be visible as to enable observation of phase separation and other visible changes that might occur in the liquid. The recipients may then be incubated for multiple days, weeks and even months to assess the stability of the tested oil-dispersion. Visible changes that may occur over time or immediately after preparation of the self-emulsifiable concentrate are for example phase separation, precipitation or crystallization. The process can be accelerated by incubating the self-emulsifiable concentrates at higher temperatures such as 40° C. or higher. For example, the self-emulsifiable concentrates may be tested after incubation for 2 weeks at 54° C.

The stability of the self-emulsifiable concentrate may further be tested using a viscosity meter, such as for example a viscosity meter which are for example available from Amatek Inc. A stably formed self-emulsifiable concentrate may be characterized by high viscosity at low shear and low viscosity at high shear. These results of a viscosity test can also be referred to as the flowability of the self-emulsifiable concentration i.e. how well it can be poured from one recipient into another.

The skilled person will know that many other physico-chemical tests are standardized and available. Such as CIPAC MT 3.2 for determining the density of the oil dispersion, CIPAC MT 75.2 for assessing the pH and conductivity of the oil dispersion, CIPAC MT 36.6 for assessing the emulsion characteristics and re-emulsification properties of the oil dispersion, CIPAC MT 180 for assessing the dispersion stability of the oil dispersion.

### [Physical and Chemical Stability of a Bioactive Protein]

The self-emulsifiable concentrate of the present invention may be tested for the integrity and stability of a bioactive protein in chemical and physical terms. Thus, the stability of the self-emulsifiable concentrate can be assessed by testing the chemical and physical stability of a bioactive protein in the self-emulsifiable concentrate. Physical integrity can be ascertained e.g. by standard SDS-PAGE analysis or commonly used LabChip protein characterization system from PerkinElmer to check the integrity of the full sized bioactive proteins and if degradation occurs over time by monitoring decreased concentration of bioactive protein or the formation of degradation products by for example proteolytical degradation. Additionally, size-exclusion chromatography or SEC can be used to assess the formation of a dimer or higher order complex or the loss of structure e.g. by unfolding which would affect the flow through properties of bioactive protein in this chromatographic method and would lead to clear alterations in the chromatogram as compared to the reference sample. Chemical stability of the bioactive protein can be assessed e.g. by reversed phase chromatography (abbreviated “RPC”). Chemical modifications of the polypeptide will affect the retention times and thus influence the chromatogram. The various peaks can be analyzed and compared to a reference value. The skilled person knows suitable chromatographic equipment and analysis software. Non-limiting examples include e.g. Agilent 1200 HPLC system equipped with ChemStation software (Agilent Technologies, Palo Alto, USA., Rev B); Dionex Ultimate 3000 HPLC system equipped with Chromeleon software (Dionex Corporation, Sunnyva CA, USA, V6.8); or ACQUITY UPLC® H-Class Bio System (Waters, Saint-Quentin, France). Such systems allow for the generation and analysis of chromatograms. Typically, a main peak comprising the bioactive protein may be flanked by so-called pre- or post-peaks, which represent chemical variants, e.g. oxidation products or for example chemical reactions occurring in or between amino acids structures of the bioactive protein (for example pyroglutamate formation or the formation of breakage of disulfide bridges). The peaks on the chromatogram can be compared, e.g. In terms of their area under the curve. This can be achieved by standard commercial software as exemplified above. Typically, the total area under the curve of all characteristic peaks in one chromatogram is set at 100% and is also referred to as “peak area”, and the distribution between different peaks of one chromatogram can be compared. For example, the main peak corresponding to the bioactive protein can be 95%, and a pre-peak, comprising e.g. a oxidation product can be 5% of the total peak area on the chromatogram. These patterns can be compared between a liquid reference and a self-emulsifiable concentrate of the invention. Ideally, the proportion of the main peak versus the side peaks will not change significantly by the methods of the invention. Self-emulsifiable concentrates of the present invention will only show very minor changes between the main peak and pre- or post-peaks caused by the formulation. For example, the relative increases in pre- or post-peaks may be less than 15% for each individual peak, e.g. less than 14, 12, 10, 8, 6, 4, 2, or 1%. This means, for example, if in the reference sample a single pre-peak 1 amounts to 5% of the total area of peaks, this peak will amount to no more than 10% after preparing a self-emulsifiable concentrate of the present invention, and more particularly will remain at e.g. 10%. In other words, the bioactive proteins may retain their chemical integrity without significant changes. This is also reflected in that the main peak corresponding to the bioactive protein will be more than 80%, preferably more than 85%, more preferably more than 90% of the total area under the curve even after the method of formulation of the present invention. It is noted that the total area under the curve of the main peak of an RPC chromatogram can also be used to monitor any physical changes in the protein as this would result in a sharp decrease of the total peak area without the formation of significant pre- or post-peaks. As such RPC can serve as a complementary method to standard SDS-PAGE or LabChip analysis. The above defined changes in peak pattern can also be considered as “minor changes” in the context of the present invention or considered as changes that will not have a significant effect on the bioactivity of the bioactive protein in for example an on planta treatment. Moreover, the peak pattern will be stable at storage, and will not differ significantly (as defined above) even after e.g. 6 months storage at an average temperature of 20° C. or more.

Alternatively, the integrity of the bioactive protein can be assessed by assessing the melting temperature (Tm; where 50% of the protein is folded and the 50% unfolded) of the bioactive protein. By increasing the temperature of a solution of the bioactive protein and monitoring its intrinsic tryptophan fluorescence at an emission wavelength of 330 and 350 nm during unfolding of protein exact melting temperatures can be measured and compared to a standard solution. Deviations in the Tm will indicate structural or chemical changes having occurred in the bioactive protein during incubation. This method can for instance be performed using The Prometheus NT.48 available from NanoTemper Technologies monitors the shift of intrinsic tryptophan fluorescence.

### [Obtaining a Protein-Containing Composition]

In some embodiments the self-emulsifiable concentrate of the current invention is characterized by containing a solid or essentially solid protein-containing composition that is dispersed in an oil vehicle and where the protein-containing composition may be derived from a microbial fermentation broth. A “microbial fermentation broth” or “fermentation broth” may be defined as a liquid suspension obtained after the propagation of microbial cell in a suitable growth media or culture broth. In some embodiments the microbial cell is essentially a wild-type organism not substantially modified using genetic modifications. In preferred embodiments the microbial cells may be genetically modified to express a bioactive protein. The bioactive protein may have a protective or curative effect against a plant pathogen when applied to said plant. Typically, a microbial cell is propagated in a nutrient rich culture broth providing the necessary nutrients, salts, minerals, oxygen etc. . . . for the microbial cell to grow and multiply to reach a certain density of cells in the fermentation broth. Generally, the culture broth will comprise any and all nutrients required for the microbial organism to grow. The skilled person will be aware of the required components of the culture broth, which may differ depending on the species of microbial cell being cultured. In some embodiments, the culture broth may comprise a nitrogen source, such as ammonium or peptone. Where the microbial cell is modified to express a bioactive protein, the bioactive protein may be encoded by a nucleotide sequence that may be operably linked to an inducible promoter, the microbial fermentation may comprise a step of inducing the expression of the compound of interest by adding an inducing agent such as methanol or lactose. A common inducible promoter that may be used is the inducible cbh1 or cbh2 promoter, in which administration of lactose will initiate expression in, for example filamentous fungi. Other possibilities are methanol inducible promoters such as the AOX1 or FMD promoters in, for example yeast. Other inducible promoters could of course be used. If the sequence encoding the compound of interest is under the control of a constitutive promoter, no specific step of induction of expression may be required. Fermentation or culture of the microbial cells may occur in a solid fermentation or culture setting or a liquid fermentation or culture setting. Solid-state fermentation or culture may comprise seeding the microbial cell on a solid culture substrate, and methods of solid-state fermentation or culture are known the skilled person. Liquid fermentation or culture may comprise culturing the microbial cell in a liquid cell culture medium. Typically, a fermentation reaction is completed when the microbial organism reaches a saturating density inside the culture broth and when the polypeptide of interest (e.g., the bioactive protein) is expressed in sufficiently high amounts. Of course, the skilled person will appreciate that many scenarios and methods exist to come to a microbial fermentation broth that can be used in the current invention of a self-emulsifiable concentrate.

At the end of a fermentation reaction, the fermentation broths are optionally clarified by removing the cellular material and as such obtaining a clarified broth, this can be achieved in many ways such as commonly known filtration, centrifugation, or precipitation techniques. In some embodiments further downstream processing steps are applied to, for instance further concentrate the protein content in the clarified broth. Where the fermentation broth contains a bioactive protein, the further downstream processing steps can be optimized to increase the concentration of said bioactive protein. Common downstream process steps for concentrating the protein content include filtration, chromatography steps or a combination thereof. In a preferred embodiment, the fermentation broth is clarified by removing the cellular material. In a more preferred embodiment, the fermentation broth is clarified by removing the cellular material and the concentration of the bioactive protein is increased, optionally by one or more filtration steps.

In some embodiments the fermentation broth is not clarified and the cellular material, such as live and/or inactivated and/or lysed microbial cells or spores of said cells are maintained in the fermentation broth. Optionally the microbial cells (or lysed cells) or spores of said cells may be concentrated in the fermentation broth by for example a centrifugation step or filtration step.

The microbial fermentation broth is dried to obtain a protein-containing composition. In one embodiment the fermentation broth is directly dried without first being processed by for example centrifugation or filtration steps. In another embodiment the fermentation broth is first clarified prior to being dried. In yet another embodiment the clarified broth undergoes further concentration steps by for example filtration steps. In yet another embodiment the clarified broth undergoes one or more downstream process steps to increase the protein concentration and/or increase the protein purity of the protein of interest that may be contained in the fermentation broth. In a preferred embodiment the fermentation broth is first clarified and subsequently concentrated by one or more filtration steps prior to drying to obtain an protein-containing composition. In one embodiment, a) the microbial fermentation broth is clarified to remove microbial cells, thereby producing a clarified solution; and b) the clarified solution is subsequently dried, thereby producing a dried composition, wherein the protein-containing composition comprises the dried composition produced in step b). Optionally, the protein-containing composition can be further processed by a milling step.

For example, a microbial fermentation can be obtained from a Pichia pastoris culture grown under standard fermentation conditions and expressing for example a bioactive protein and where the nucleotide encoding the bioactive protein is under the control of a methanol inducible AOX or FMD promoter. Standard methods can be used such as taught by Methods in Molecular Biology, vol. 389: Pichia Protocols, Second Edition Edited by: J. M. Cregg. At the end of the fermentation the Pichia pastoris cells are removed by for example a centrifugation after which the filtrate is passed over a high molecular weight filter to remove larger proteins and other molecules left behind after the centrifugation step. Thereafter the filtrate can be passed over a small molecular weight filter to increase the concentration of the protein of interest in the retentate. The retentate can then be processed further by for example including an agrochemically acceptable filler and processed further by for example spray drying to obtain a protein-containing composition that can be directly incorporated into the oil vehicle of a self-emulsifiable concentrate of the invention.

Any methods comprising or requiring the culturing or fermentation of the modified microbial host cell comprise the culture or fermentation of the host cell in a suitable medium.

“Culturing”, “cell culture”, “fermentation”, “fermenting” or “microbial fermentation” as used herein includes suspending the microbial cell in a culture broth or growth medium, providing sufficient nutrients including but not limited to one or more suitable carbon source (including glucose, sucrose, fructose, lactose, avicel®, xylose, galactose, ethanol, methanol, or more complex carbon sources such as molasses or wort), nitrogen source (such as yeast extract, peptone or beef extract), trace element (such as iron, copper, magnesium, manganese or calcium), amino acid or salt (such as sodium chloride, magnesium chloride or natrium sulfate) or a suitable buffer (such as phosphate buffer, succinate buffer, HEPES buffer, MOPS buffer or Tris buffer). Optionally it includes one or more inducing agents driving expression of the compound of interest or a compound involved in the production of the compound of interest (such as lactose, avicel, IPTG, ethanol, methanol, sophorose or sophorolipids). It can also further involve the agitation of the culture media via for example stirring of purging to allow for adequate mixing and aeration. It can further involve different operational strategies such as batch cultivation, semi-continuous cultivation or continuous cultivation and different starvation or induction regimes according to the requirements of the microbial cell and to allow for an efficient production of bioactive protein or a compound involved in the production of a bioactive protein. Alternatively, the microbial cell is grown on a solid substrate in an operational strategy commonly known as solid state fermentation.

A microbial cell is defined here as a single cellular organism used during a fermentation process or during cell culture. Preferably, a microbial cell is selected from the kingdom Fungi. In a most preferred embodiment, the microbial cell is a Pichia pastoris cell and where said Pichia pastoris cell is modified to express a bioactive protein, such as a VHH.

In particular, the fungus may be a filamentous fungus, preferably from the division Ascomycota, subdivision Pezizomycotina. In some embodiments, the fungi may preferably from the Class Sordariomycetes, optionally the Subclass Hypocreomycetidae. In some embodiments, the fungi may be from an Order selected from the group consisting of Hypocreales, Microascales, Eurotiales, Onygenales and Sordariales. In some embodiments, the fungi may be from a Family selected from the group consisting of Hypocreaceae, Nectriaceae, Clavicipitaceae and Microascaceae. In some more specific embodiments, the fungus may be from a Genus selected from the group consisting of Trichoderma (anamorph of Hypocrea), Myceliophthora, Fusarium, Gibberella, Nectria, Stachybotrys, Claviceps, Metarhizium, Villosiclava, Ophiocordyceps, Cephalosporium, Rasamsonia, Neurospora, and Scedosporium. In some further and preferred embodiments, the fungi may be selected from the group consisting of Trichoderma reesei (Hypocrea jecorina), T. citrinoviridae, T. Iongibrachiatum, T. virens, T. harzianum, T. asperellum, T. atroviridae, T. parareesei, Fusarium oxysporum, F. gramineanum, F. pseudograminearum, F. venenatum, Gibberella fujikuroi, G. moniliformis, G. zeaea, Nectria (Haematonectria) haematococca, Stachybotrys chartarum, S. chlorohalonata, Claviceps purpurea, Metarhizium acridum, M. anisopliae, Villosiclava virens, Ophiocordyceps sinensis, Neurospora crassa, Rasamsonia emersonii, Acremonium (Cephalosporium) chrysogenum, Scedosporium apiospermum, Aspergillus niger, A. awamori, A. oryzae, Chrysosporium lucknowense, Myceliophthora thermophila, Myceliophthora heterothallica, Humicola insolens, and Humicola grisea, most preferably Trichoderma reesei. If the host cell is a Trichoderma reesei cell, it may be selected from the following group of Trichoderma reesei strains obtainable from public collections: QM6a, ATCC13631; RutC-30, ATCC56765; QM9414, ATCC26921, RL-P37 and derivatives thereof. If the host cell is a Myceliophthora heterothallica, it may be selected from the following group of Myceliophthora heterothallica or Thermothelomyces thermophilus strains: CBS 131.65, CBS 203.75, CBS 202.75, CBS 375.69, CBS 663.74 and derivatives thereof. If the host cell is a Myceliophthora thermophila it may be selected from the following group of Myceliophthora thermophila strains ATCC42464, ATCC26915, ATCC48104, ATCC34628, Thermothelomyces heterothallica C1, Thermothelomyces thermophilus M77 and derivatives thereof. If the host cell is an Aspergillus nidulans it may be selected from the following group of Aspergillus nidulans strains: FGSC A4 (Glasgow wild-type), GR5 (FGSC A773), TN02A3 (FGSC A1149), TNO2A25, (FGSC A1147), ATCC 38163, ATCC 10074 and derivatives thereof.

In particular, the fungus may be a yeast cell. The yeast may be selected from the group consisting of Pichia (also known as Komagataella), Candida, Torulopsis, Arxula, Hansenula, Yarrowia, Kluyveromyces and Saccharomyces. The microbial cell may preferably be from the division Ascomycota. The microbial cell may be selected from the group consisting of Pichia (also known as Komagataella), Candida, Torulopsis, Arxula, Hansenula, Yarrowia, Kluyveromyces and Saccharomyces. More preferably, the microbial host cell may be from the Pichia genus (also known as Komagataella), such as P. pastoris, P. farinose, P. anomala, P. heedii, P. guilliermondii, P. kluyveri, P. membranifaciens, P. norvegensis, P. ohmeri, P. methanolica and P. subpelliculosa. Most preferably, the microbial cell may be Pichia Pastoris (also known as Komagataella phaffii).

In yet another embodiment, the microbial cell is a bacterial cell. In particular, the bacterial cell may be selected from the group consisting of Escherichia coli (E. coli) such as BL21, DH5α, and others, Bacillus species, Pseudomonas species, Corynebacterium species, Streptomyces species, Lactococcus species, Shigella species, Streptococcus species, Neisseria species, Geobacillus species, Bifidobacterium species, Azotobacter species, Bordetella species, Lactobacillus species, Staphylococcus species. The microbial cell may preferably be a bacillus species such as Bacillus alkalophilus, Bacillus circulans, Bacillus clausii, Bacillus coagulans, Bacillus firmus, Bacillus lautus, Bacillus lentus, Bacillus pumilus, Bacillus amyloliquefaciens, Bacillus thuringiensis, Bacillus megaterium, Bacillus halodurans or Bacillus stearothermophilus, Bacillus brevis, Bacillus subtilis or Bacillus licheniformis. In a more preferred aspect the bacterial species is a Bacillus subtilis or Bacillus licheniformis, for example but not limited to Bacillus subtilis 168, Bacillus subtilis 168 marburg (DSM 347), Bacillus subtilis WB800, Bacillus subtilis PY79, Bacillus subtilis CU1065, Bacillus subtilis ATCC 6633, Bacillus subtilis 168 W23, Bacillus subtilis 6051-HGW, Bacillus subtilis 3610, Bacillus licheniformis DSM 13 Bacillus licheniformis ATCC 14580, Bacillus licheniformis NRRL B-14393, Bacillus licheniformis DSM 8785, Bacillus licheniformis ATCC 9945A, Bacillus licheniformis ATCC 14875, Bacillus licheniformis SL-208 or Bacillus licheniformis T5.

It is understood that a microbial fermentation used to obtain a protein-containing composition as set out above may be performed with any microbial cell. Preferably the microbial fermentation is performed with a microbial cell that may be genetically adapted to express a bioactive protein. In preferred embodiments the microbial fermentation is performed using one or more of the species selected from Pichia pastoris, Trichoderma reesei, Aspergillus niger, Aspergillus nidulans, Myceliophthora thermophila, Myceliophthora heterothallica, Bacillus subtilis and Bacillus licheniformis. In a preferred embodiment the microbial host cell used to perform the microbial fermentation for obtaining a protein-containing composition is Pichia pastoris (aka Komagataella phaffii). In another embodiment the microbial host cell used to perform the microbial fermentation for obtaining a protein-containing composition is a Trichoderma reesei. In another preferred embodiment the microbial host cell used to perform the microbial fermentation for obtaining a protein-containing composition is Bacillus licheniformis. In another preferred embodiment the microbial host cell used to perform the microbial fermentation for obtaining a protein-containing composition is Bacillus subtilis. To specify the microbial cell performing the microbial fermentation it is said that the microbial fermentation may be, for example, a Pichia pastoris fermentation, to indicate that the microbial fermentation is performed by Pichia pastoris microbial cells. Or, for example a Bacillus licheniformis fermentation, to indicate the microbial fermentation is performed by Bacillus licheniformis microbial cells. In more preferred embodiments, said microbial cells are modified to express a bioactive protein, such as a VHH.

### [Agrochemical Composition]

In a further aspect, the present invention provides the use of the self-emulsifiable concentrate as disclosed herein as a plant protection agent or anti-pest agent. More specifically the bioactive protein present in the self-emulsifiable concentrate of this invention may serve as an active ingredient of a plant protection product. Therefore, the self-emulsifiable concentrate of this invention may be used as a plant protection product. In particular embodiments, the anti-pest agent is a biostatic agent, a fungistatic agent, a pesticidal agent and/or a fungicidal agent. In yet a further aspect, the present invention provides methods of inhibiting the growth of a plant pathogen or methods of killing a plant pathogen, the methods comprising at least the step of applying directly or indirectly to a plant or to a part of the plant, the self-emulsifiable concentrate as disclosed herein by emulsifying the self-emulsifiable concentrate in a suitable volume of water. Emulsifying the self-emulsifiable concentrate of this invention in a suitable volume of water leads to a composition suitable for use on plants or crops, such a composition is herein referred as an agrochemical composition. The self-emulsifiable concentrate of the invention may be emulsified in water prior to being applied to a crop as an agrochemical composition. The self-emulsifiable concentrate of the invention can be mixed with water at a rate such that a desired final concentration of the bioactive protein is achieved. The skilled person will know that this is dependent on the relative amount of bioactive protein in the self-emulsifiable concentrate. An agrochemical composition may not be composed solely of the self-emulsifiable concentrate of this invention dissolved in a suitable quantity of water. That is to say, tank additives may be added to the agrochemical composition which may improve the performance. In some embodiments of the invention the self-emulsifiable concentrate are added to a suitable quantity of water in for example a recipient such as spray tank. In another embodiment tank additives are added to a suitable quantity of water together with the self-emulsifiable concentrate. In some embodiments the tank additives may be selected, but are not limited hereto, from one or more of adjuvants, fertilizers, biostimulants, and/or plant growth regulators. In some embodiments the self-emulsifiable concentrate are added to a suitable quantity of water in a recipient and were the dissolution is facilitated by mixing. In some embodiments the tank additives may be selected, but are not limited hereto, from one or more of adjuvants, fertilizers, biostimulants, and/or plant growth regulators may already be incorporate into the self-emulsifiable concentrate.

In particular embodiments, the agrochemical compositions as disclosed herein are directly or indirectly applied to the plant or to a part of the plant by spraying, atomizing, foaming, fogging, culturing in hydroculture, culturing in hydroponics, coating, submerging, and/or encrusting, optionally post-harvest.

In particular embodiments, the methods for protecting or treating a plant or a part of a plant from an infection or other biological interaction with a plant pathogen as disclosed herein, comprise applying the agrochemical composition directly or indirectly to the plant or to a part of the plant either in a pre-harvest or in a post-harvest stage. According to specific embodiments, the harvested produce is a fruit, flower, nut or vegetable, a fruit or vegetable with inedible peel, preferably selected from avocados, bananas, plantains, lemons, grapefruits, melons, oranges, pineapples, kiwi fruits, guavas, mandarins, mangoes and pumpkin, is preferred, more preferably bananas, oranges, lemons and peaches, in particular bananas. According to further specific embodiments, the harvested produce is a cut flower from ornamental plants, preferably selected from Alstroemeria, Carnation, Chrysanthemum, Freesia, Gerbera, Gladiolus, baby's breath (Gypsophila spec), Helianthus, Hydrangea, Lilium, Lisianthus, roses and summer flowers. The plant species to which the agrochemical compositions as disclosed herein can be applied can for example be but are not limited to maize, soya bean, alfalfa, cotton, sunflower, Brassica oil seeds such as Brassica napus (e.g. canola, rape-seed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory including root chicory, endive or common chicory), Umbelliferae sp. (e.g. carrots, parsley, celery and celeriac), curbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and Chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

In a preferred embodiment of the treatment methods with the agrochemical composition, the crop is selected from the group consisting of field crops, grasses, fruits and vegetables, lawns, trees and ornamental plants. In certain aspects, the present invention thus also provides post-harvest treatment methods for protecting or treating a harvested plant or a harvested part of the plant from an infection or other biological interaction with a plant pathogen, at least comprising the step of applying directly or indirectly to the harvested plant or to a harvested part of the plant, an agrochemical composition as disclosed herein, under conditions effective to protect or treat the harvested plant or a harvested part of the plant against the infection or biological interaction with the plant pathogen. According to specific embodiments, the harvested produce is a fruit, flower, nut or vegetable, a fruit or vegetable with inedible peel, preferably selected from avocados, bananas, plantains, lemons, grapefruits, melons, oranges, pineapples, kiwi fruits, guavas, mandarins, mangoes and pumpkin, is preferred, more preferably bananas, oranges, lemons and peaches, in particular bananas. According to further specific embodiments, the harvested produce is a cut flower from ornamental plants, preferably selected from Alstroemeria, Carnation, Chrysanthemum, Freesia, Gerbera, Gladiolus, baby's breath (Gypsophila spec), Helianthus, Hydrangea, Lilium, Lisianthus, roses and summer flowers. According to further specific embodiments, the harvested produce is cut grass or wood. Post-harvest disorders are e.g. lenticel spots, scorch, senescent breakdown, bitter pit, scald, water core, browning, vascular breakdown, C02 injury, C02 or 02 deficiency, and softening. Fungal diseases may be caused for example by the following fungi: Mycosphaerella spp., Mycosphaerella musae, Mycosphaerella frag a ae, Mycosphaerella citri; Mucor spp., e.g. Mucor piriformis; Monilinia spp., e.g. Monilinia fructigena, Monilinia laxa; Phomopsis spp., Phomopsis natalensis; Colletotrichum spp., e.g. Colletotrichum musae, Colletotrichum gloeosporioides, Colletotrichum coccodes; Verticillium spp., e.g. VerticiHium theobromae; Nigrospora spp.; Botrytis spp., e.g. Botrytis cinerea; Diplodia spp., e.g. Diplodia citri; Pezicula spp.; Alternaria spp., e.g. Alternaria citri, Alternaria alternata; Septoria spp., e.g. Septoria depressa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Fusarium spp., e.g. Fusarium semitectum, Fusarium moniliforme, Fusarium solani, Fusarium oxysporum; Cladosporium spp., e.g. Cladosporium fulvum, Cladosporium cladosporioides, Cladosporium cucumerinum, Cladosporium musae; Penicillium spp., e.g. Penicillium funiculosum, Penicillium expansum, Penicillium digitatum, Penicillium italicum; Phytophthora spp., e.g. Phytophthora citrophthora, Phytophthora fragariae, Phytophthora cactorum, Phytophthora parasitica; Phacydiopycnis spp., e.g. Phacydiopycnis malirum; Gloeosporium spp., e.g. Gloeosporium album, Gloeosporium perennans, Gloeosporium fructigenum, Gloeosporium singulata; Geotrichum spp., e.g. Geotrichum candidum; Phlyctaena spp., e.g. Phlyctaena vagabunda; Cylindrocarpon spp., e.g. Cylindrocarpon mail; Stemphyllium spp., e.g. Stemphyllium vesica um; Thielaviopsis spp., e.g. Thielaviopsis paradoxy; Aspergillus spp., e.g. Aspergillus niger, Aspergillus carbonari us; Nectria spp., e.g. Nectria galligena; Cercospora spp., e.g. Cercospora angreci, Cercospora apii, Cercospora atrofiliformis, Cercospora musae, Cercospora zeae-maydis. In further aspects, the present invention provides uses of the agrochemical compositions as disclosed herein as an anti-pest agent, such as for instance a biostatic agent or a pesticidal agent, including but not limited to a fungistatic or a fungicidal agent.

“Crop” as used herein means a plant species or variety that is grown to be harvested as food, livestock fodder, fuel raw material, or for any other economic purpose. As a non-limiting example, said crops can be maize, cereals, such as wheat, rye, barley and oats, sorghum, rice, sugar beet and fodder beet, fruit, such as pome fruit (e.g. apples and pears), citrus fruit (e.g. oranges, lemons, limes, grapefruit, or mandarins), stone fruit (e. g. peaches, nectarines or plums), nuts (e.g. almonds or walnuts), soft fruit (e.g. cherries, strawberries, blackberries or raspberries), the plantain family or grapevines, leguminous crops, such as beans, lentils, peas and soya, oil crops, such as sunflower, safflower, rapeseed, canola, castor or olives, cucurbits, such as cucumbers, melons or pumpkins, fibre plants, such as cotton, flax or hemp, fuel crops, such as sugarcane, miscanthus or switchgrass, vegetables, such as potatoes, tomatoes, peppers, lettuce, spinach, onions, carrots, egg-plants, asparagus or cabage, ornamentals, such as flowers (e.g. petunias, pelargoniums, roses, tulips, lilies, or chrysanthemums), shrubs, broad leaved trees (e.g. poplars or willows) and evergreens (e.g. conifers), grasses, such as lawn, turf or forage grass or other useful plants, such as coffee, tea, tobacco, hops, pepper, rubber or latex plants.

A “pest”, as used here, is an organism that is harmful to plants, animals, humans or human concerns, and includes, but is not limited to crop pests (as later defined), household pests, such as cockroaches, ants, etc., and disease vectors, such as malaria mosquitoes.

A “plant pest”, “plant pathogen” or “crop pest”, as used in the application interchangeably, refers to organisms that specifically cause damage to plants, plant parts or plant products, particularly plants, plant parts or plant products, used in agriculture. Note that the term “plant pest” or “crop pest” is used in the meaning that the pest targets and harms plants. Pests particularly belong to invertebrate animals (e.g. insects (including agricultural pest insects, insect pests of ornamental plants, insect pests of forests). Relevant crop pest examples include, but are not limited to, aphids, caterpillars, flies, wasps, and the like, nematodes (living freely in soil or particularly species that parasitize plant roots, such as root-knot nematode and cyst nematodes such as soybean cyst nematode and potato cyst nematode), mites (such as spider mites, thread-footed mites and gall mites) and gastropods (including slugs such as Deroceras spp., Milax spp., Tandonia sp., Limax spp., Arion spp. and Veronicella spp. and snails such as Helix spp., Cernuella spp., Theba spp., Cochlicella spp., Achatina spp., Succinea spp., Ovachlamys spp., Amphibulima spp., Zachrysia spp., Bradybaena spp., and Pomacea spp.), pathogenic fungi (including Ascomycetes (such as Fusarium spp., Thielaviopsis spp., Verticillium spp., Magnaporthe spp.), Basidiomycetes (such as Rhizoctonia spp., Phakospora spp., Puccinia spp.), and fungal-like Oomycetes (such as Pythium spp. and Phytophthora spp.), bacteria (such as Burkholderia spp. and Proteobacteria such as Xanthomonas spp. and Pseudomonas spp.), Phytoplasma, Spiroplasma, viruses (such as tobacco mosaic virus and cauliflower mosaic virus), and protozoa.

“Microbe”, as used herein, means bacterium, virus, fungus, yeast and the like and “microbial” means derived from a microbe.

“Fungus”, as used herein, means a eukaryotic organism, belonging to the group of Eumycota. The term fungus in the present invention also includes fungal-like organisms such as the Oomycota. Oomycota (or oomycetes) form a distinct phylogenetic lineage of fungus-like eukaryotic microorganisms. This group was originally classified among the fungi but modern insights support a relatively close relationship with the photosynthetic organisms such as brown algae and diatoms, within the group of heterokonts.

“Pest infection” or “pest disease” as used herein refers to any inflammatory condition, disease or disorder in a living organism, such as a plant, animal or human, which is caused by a pest.

“Fungal infection” or “fungal disease” as used herein refers to any inflammatory condition, disease or disorder in a living organism, such as a plant, animal or human, which is caused by a fungus.

The present invention will now be illustrated by way of the following non-limiting Examples.

### EXAMPLES

### Example 1: Preparation of a Protein-Containing Composition

The protein-containing composition was prepared using standard microbial fermentation techniques using yeast such as Pichia pastoris for expression of a bioactive protein (here a VHH). Guidance to performing standard microbial fermentations can be found in Methods in Molecular Biology, vol. 389: Pichia Protocols, Second Edition Edited by: J. M. Cregg. The resulting broth was then subjected to filtration or centrifugation steps to remove the cellular material. Hereafter the clarified broth was further concentrated by filtration with a filter having a cut-off size smaller than the bioactive protein. The resulting retentate was spray dried to form a fine and essentially dry powder. In this example, the spray dried product appeared as a light powder at room temperature and the bioactive protein content was estimated to be about 20%.

### Example 2: Selection of a Thickening Agent

The choice of the oil used in the stable self-emulsifiable composition of the invention is mainly driven by the absence of solubility of the active ingredient in the oil. Vegetable oil was chosen as the most suitable type of oil in this Example. More specifically a soybean oil was used. The vegetable oil can be chosen from similar oils such as linseed oil.

In order to keep the self-emulsifiable composition stable and prevent the sedimentation of the active ingredient a thickening agent was added. The amount and choice of the thickening agent was driven by the increased viscosity balanced against flowability to ensure a stable but practically useable formulation (i.e. it can be easily poured into for instance a spray tank). For the choice of the thickening agent, three options were explored: modified clays, fumed silica and polymeric structurants. Modified clays are minerals like bentonite which are then chemically modified. The modified clays were not selected for two reasons: (a) they can contain surface charges which could lead to the degradation of a protein based bioactive and (b) modified clays require intensive milling and high shear in order to be activated: their structure has to be broken in order for the oil to be combined with the clay. This process step could lead to high temperatures which might affect the protein based bioactive. Fumed silicas increase viscosity by interaction of the silanol groups. Fumed silicas are much easier to incorporate, as they can just be mixed into the OD-mixture with low shear (˜500 rpm). They create a clear gel that fluidizes easily. The main downsides are that the fumed silica can only be incorporated at the end of the process, and thus an amount of thickening agent has to be decided before the formulation process.

Fumed silica Aerosil 200 was explored as a rheology modifier for linseed oil. At first, 10% w/w on oil of Aerosil 200 was added to linseed oil at 500 rpm with a 4-bladed mixer. This created a very thick gel which did not fluidize. Then, linseed oil was added at 500 rpm until the gel became fluid again. The result is a very nice, clear gel which fluidizes after a few shakes by hand. The final concentration of Aerosil 200 was between 6 and 7% w/w.

As an alternative to fumed silica, Sipernat 22 was selected as rheology modifier. Incorporation in the oil happened at ˜500 rpm with a 4-bladed mixer. The compound was incorporated into the oil but did not increase viscosity. After some time, Sipernat 22 started to precipitate which shows a clear incompatibility with linseed oil. After some time at the bottom, a gel like substance started to form. Following this, Sipernat 22 was mixed into the linseed oil at 1200 rpm. Again, incorporation was successful, but in the end, viscosity was not increased and after some time the Sipernat 22 started to precipitate again.

Polymeric structurants are lipophilic compounds with a high molecular weight. Structurants used in this example are Rheostrux 100 and Rheostrux 200 for increasing the viscosity of vegetable oils. The polymeric structurants are incorporated into the oil facilitated by increasing the temperature of the oil to between 60° C. and 90° C. The oil was heated by using an au-bain-marie or directly on a hot plate. Low velocity stirring (300 rpm) by use of a magnetic stirrer in the oil was also performed as it aids in the dissolution of the polymeric structurant. A temperature of around maximum 85° C. is applied for Rheostrux 100 to dissolve in the oil. For Rheostrux 200, the temperature of 85° C. is a starting point as it is likely the temperature has to be increased to improve dissolution. The point of dissolution was very clear: both products make the oil more turbid while dissolving, but the moment the product is dissolved, the oil became clear again. After cooling the oil down to room temperature, the oil should be a thick and turbid gel. This was performed with the ODs R1 up to OD R5, with different concentrations of Rheostrux 200 as indicated in Table 1. For both OD R1 with 2.99% w/w thickening agent and OD R2 with 2.23% w/w thickening agent the viscosity was insufficient for making a stable dispersion. OD R5 with 4.76% w/w thickening agent is on the upper boundary of allowable viscosity as handling started to become difficult. Note that unlike OD 1-4, OD R5 does include a protein-containing composition derived from the fermentation of example 1. OD R3 with 3.73% w/w thickening agent and OD R4 with 4.76% w/w thickening agent were easy to handle and were not too viscous after addition of the other components. OD R3 and OD R4 have a oil:rheology modifier ratio of respectively 25 and 20.

Aerosil 200 was also selected as a good rheology modifier for soyabean oil (S1) at 6.29% w/w of Aerosil 200 in Linseed oil. Aerosil 200 was incorporated into soyabean oil at a 1:19 ratio (2,47% w/w). It is important to note that for S1, the rheology modifier was added as the last ingredient. This strategy should always be preferred, but in the case of the Rheostrux-series, this is of course not possible due to the heating step. Rheostrux 100 was incorporated into soyabean oil under heat (>85° C.) and magnetic stir (400 rpm). The result was a very viscous gel, but this can be improved after addition of emulsifiers and dispersants. An advantage of Aerosil 200 over Rheostrux 100 is that Aerosil 200 creates a clear gel and it creates a more “scalable” viscosity. Rheostrux 100 makes the oil more turbid and the gel thickens more heavily.

Since both Rheostrux products require a heating step in order to be incorporated into the vegetable oil, it is possibly an expensive processing step. Following the increase in temperature, the oil has to be cooled down afterwards as well, before other components are added. This of course takes time and could again lead to increased production costs. For this reason, it's interesting to explore other thickening agents which do not require a heating step to be incorporated. As described above, an advantageous thickening agent is Aerosil 200 since this does not require heating and still forms a good gel.

TABLE 1
Summarizing table containing the formulation IDs, total OD mass, type of oil and mass
percentage of this oil in the OD, type of rheology modifier and mass percentage of
the thickening agent in the OD and the ratio between the oil and thickening agent.

| | Total mass | | Thickening agent | Ratio oil:thickening |
|---|---|---|---|---|
| Formulation ID | (g) | Oil (mass %) | (mass %) | agent |
| R1 OD | 21.10 | Rapeseed oil (97.01) | Rheostrux 200 (2.99) | 32.5 |
| R2 OD | 20.63 | Rapeseed oil (97.77) | Rheostrux 200 (2.23) | 44 |
| R3 OD | 21.99 | Rapeseed oil (96.27) | Rheostrux 200 (3.73) | 25 |
| R4 OD | 21.66 | Rapeseed oil (95.24) | Rheostrux 200 (4.76) | 20 |
| R5 OD* | 32.36 | Rapeseed oil (65.30) | Rheostrux 200 (3.92) | 16 |
| L1 OD | 49.86 | Linseed oil (93.17) | Aerosil 200 (6.29) | 15 |
| S1 OD* | 100.40 | Soyabean oil (47.39) | Aerosil 200 (2.47) | 19 |
| S2 OD | 106.12 | Soyabean oil (95.00) | Rheostrux 100 (5.00) | 19 |

*R5 OD and S1 OD were developed into a final formulation.

### Example 3: Selection of an Emulsifier

Emulsifiers help to disperse the continuous oil phase into water when the OD formulation is diluted in water prior to being sprayed. Emulsifiers are characterized by a high HLB value of over 8. Screening for emulsifiers was performed in vegetable oils rapeseed and soyabean. The combinations are summarized in Table 2. In a traditional emulsion concentrate up to around 25% of emulsifier can be used, however for an oil dispersion formulation which requires the presence of a rheology modifier, these concentrations are too high and would not allow for sufficient headspace to include the active ingredient. For this reason, and for this example, screening is performed at an emulsifier concentration of about 10%.

Potent emulsifiers were screened for compatibility with rapeseed oil to see which emulsifier leads to the most stable emulsion. R1 and R2 presented a good emulsion, with clear creaming on top but some emulsion column also still present, which resulted in an unclear phase separation. R3 containing Atlas G-1086 was a very stable emulsion as no separation of phases took place. R4 presents a “multiple-emulsifier” system which is slightly improved over both R2 and R6 as the emulsion phase on top is bigger. However, the R4 emulsion was not completely stable. Potential improvements can come from increasing the amount of emulsifier and decrease the amount of Atlox 4914 (which is a non-aqueous dispersant). Further replacing Tween 23 by Tween 22, is seen as a potential improvement as Tween 22 creates a better emulsion compared to Tween 23. R6 is prepared for comparison with R4, and shows that dispersant Atlox 4914 is a poor emulsifier on its own, but can improve emulsion stability in combination with emulsifiers. All Tween emulsifiers and Atlas G-1086 handle well and can be used easily in OD preparation. They are easily incorporated into the oil, e.g. with a few shakes by hand, but this is done best at 300 rpm with a 4-bladed mixer.

Atlas G-1086 performs best in these tests in rapeseed oil it is however not OMRI-listed, while the emulsifiers Tween 22, Tween 23 and Tween 24 are. This makes it interesting to attempt to create an emulsifier system with the Tween emulsifiers. For a well-functioning system, a dispersant with a low HLB (below 8) needs to be combined with an emulsifier with a high HLB (above 8). The addition of a dispersant such as Atlox 4914 would improve the emulsion stability.

Emulsion stabilities can be assessed visually by observing the emulsion column to the total liquid column height or by using CIPAC method for emulsion stability MT 36.3.

TABLE 2
Summarizing table on screening for emulsifiers. This table
contains the formulation ID, total mass of the formulation,
the used emulsifier and it's mass percentage in the formulation,
and the used co-emulsifier with it's mass percentage.

| Formu- | Total | | | Co- | Stable |
|---|---|---|---|---|---|
| lation | mass | Oil | Emulsifier | emulsifier | after |
| ID | (g) | (mass %) | (mass %) | (mass %) | 3 h? |
| R1 | 22.09 | Rapeseed oil | Tween 22 | — | Medium |
| | | (90.81) | (9.19) | | |
| R2 | 21.71 | Rapeseed oil | Tween 23 | — | Medium |
| | | (90.93) | (9.07) | | |
| R3 | 23.36 | Rapeseed oil | Atlas G-1086 | — | Yes |
| | | (87.71) | (12.29) | | |
| R4 | 20.56 | Rapeseed oil | Tween 23 | Atlox 4914 | Medium |
| | | (86.77) | (6.71) | (6.52) | |
| R6 | 21.65 | Rapeseed oil | Atlox 4914 | — | No |
| | | (90.85) | (9.15) | | |
| S1 | 22.25 | Soyabean oil | AL-2575-LQ | — | No |
| | | (90.65) | (9.35) | | |
| S2 | 12.6 | Soyabean oil | Honeysurf HF | — | No |
| | | (90.79) | (9.21) | | |
| S3 | 11.43 | Soyabean oil | Honeysurf LF | — | No |
| | | (90.90) | (9.10) | | |
| S4 | 12.84 | Soyabean oil | Honeysurf AG | — | No |
| | | (90.81) | (9.19) | | |

### Example 4: Selection of a Dispersant

As was already exemplified in Example 3, dispersants (such as Atlox 4914) can help stabilizing the emulsion by interacting with the oil, the non-soluble protein-containing composition and water at the interface and as such help to further stabilize the oil dispersion. They are characterized by a low HLB value (<8) and a high molecular weight. Dispersants prevent flocculation of particles by adsorbing to the particle surface and use their long chains to increase steric hindrance. The dispersant was added in a low amount as it only needs to be present in concentrations up to about 5% w/w in the final formulation to be functional. Atlox 4914 is an OMRI-registered dispersant and was added to the oil dispersion formulation as no precipitation was be observed in both the concentrate and the emulsion. Combined with Atlas G-1086 and Tween-emulsifiers it increased emulsion stability. An alternative to Atlox 4914 is Zephrym-PD-2206. Differences between dispersions can be assessed with CIPAC method MT 180.

### Example 5: Complete Stable Self-Emulsifiable Composition

The self-emulsifiable compositions using Rheostrux 200 was made as follows. First the oil based gel was prepared by heating rapeseed oil and adding the rheology modifier Rheostrux 200 while stirring using a magnetic rod at 300 rpm. After cooling the oil-based gel, the emulsifier and dispersant were weighed on a plastic weighing boat and then added to the oil-based gel. The falcon containing the formulation was shaken by hand a few times and then placed on an overhead rotor (40 rpm) to mix everything thoroughly. Both the emulsifier and the dispersant mixed easily with the oil-based gel. Adding the emulsifier and dispersant increased flowability of the final formulation. Before adding the active ingredient, a first test on emulsion stability was performed. For this, 100 μL of each OD was diluted with water up to 10 mL. An emulsion formed spontaneously and remained stable for more than 3 hours. There was no precipitation of the emulsifier or the dispersant in the oil concentrate. The protein-containing composition was added as the last component. It was added as spray dried product with about 20% VHH content. The spray dried product was weighed in a plastic weighing boat and then added to the falcon containing the formulation. In some instance the powder had to be added in two steps. When the powder was added, a few shakes by hand were done and then the formulation was again placed on an overhead rotor at 40 rpm until all powder was suspended into the oil.

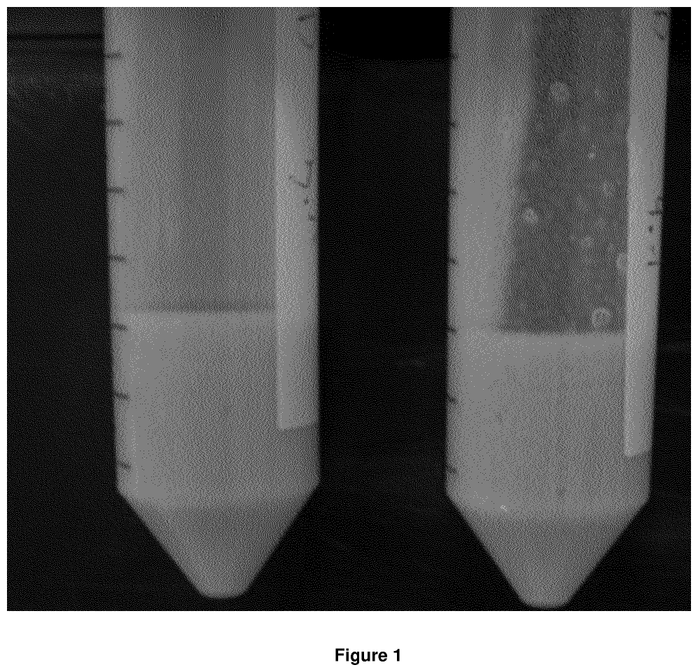

The spray dried product (SD product which is a solid protein containing composition) powder added some viscosity to the formulation. When the formulations were left to settle for a day, the small waxy residues from Rheostrux 200 were visible, possibly due to insufficient heating of the oil in the first phase. Later trials with Rheostrux 100 did not show the same residues. The spray dried product powder did not precipitate or flocculate and remained well dispersed within the oil. The final formulation is visible in FIG. 1.

Aerosil 200 was also selected as a good rheology modifier for soyabean oil (S1 see table 3). Aerosil 200 was incorporated into soyabean oil at a 1:19 ratio. It is important to note that for S1, the rheology modifier was added as the last ingredient and this does not require any heating. This strategy is preferred, but in the case of the Rheostrux-series, this is of course not possible due to the heating step.

Interestingly, the addition of the spray-dried protein-containing composition appeared to improve the stability of the oil formulation. The spray dried protein-containing composition was easily incorporated into the formulation when mixed with a 4-bladed mixer at 300 rpm and formed a nice and homogenous paste.

TABLE 3
A possible self-emulsifiable compositions with Aerosil 200.

| | | Protein based | Thickening | Oil | | |
|---|---|---|---|---|---|---|
| | A.I. | bioactive | agent | vehicle | Emulsifier | dispersant |
| Name | (w/w %) | (w/w %) | (w/w %) | (w/w %) | (w/w %) | (w/w %) |
| S1 | SD product | VHH | Aerosil 200 | Soyabean oil | Atlas G-1086 | Atlox 4914 |
| | (40.06) | (7.53) | (2.47%) | (47.39) | (7.04) | (3.04) |

¹The amount of VHH is part of the total amount of SD product, but the w/w % is expressed on the total amount of formulation.

### Example 6: Milling Step

The self-emulsifiable concentrates described here were further processed using a milling step whereby an equal volume of glass beads was added to the self-emulsifiable concentrate after the incorporation of the spray dried powder containing the VHH and mixed using for example a propeller mixer at 1500 rpm for 30 minutes or by using a bead mill.

### Example 7: Physical Stability & Carrier Oil

An enhanced storage stability test was performed with the S1 (Table 3). These results can be interpreted as an assessment for the formulation stability. The formulations were placed in an oven at 54° C. for 2 weeks, the results can be observed in FIG. 2.

No phase separation can be observed in the sample of S1, indicating a good compatibility between the soyabean oil and Aerosil 200.

### Example 8: The Protein-Containing Composition Stabilizes the Oil Dispersion Formulation

In order to show that the protein-containing composition stabilizes the stable self-emulsifiable formulation the amount of rheology modifier is lowered in a stepwise fashion and the amount of protein-containing composition is increased with the same amount. This shows that indeed, the protein-containing composition can stabilize the self-emulsifiable compositions.

### Example 9: Chemical Stability of Bioactive Protein in the Self-Emulsifiable Concentrate

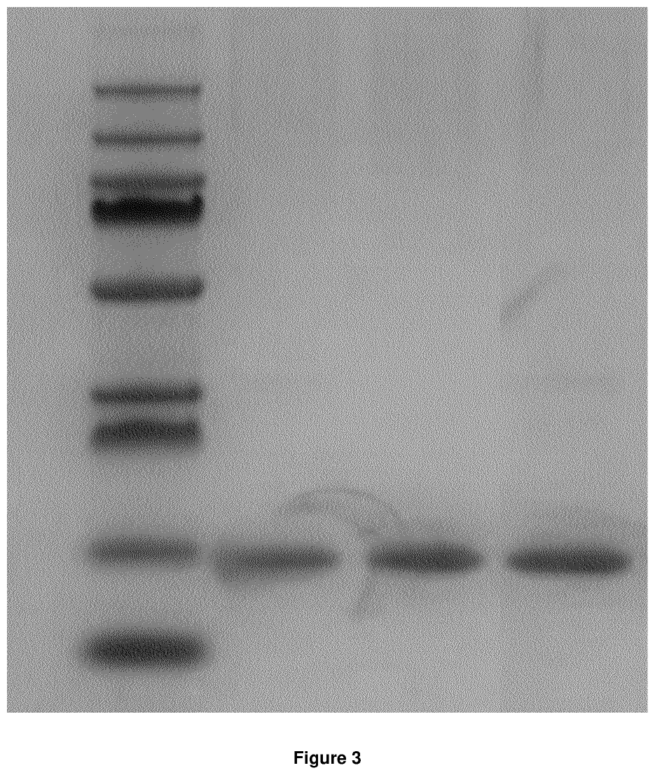

The active component in the self-emulsifiable concentrate S1 (Table 3) was tested for stability by SDS-PAGE analysis, see FIG. 3. The bioactive protein, in this case a VHH molecule, was surprisingly stable and showed no degradation on an SDS-PAGE analysis

### Example 10: Assessing Optimal Concentration of Thickening Agent

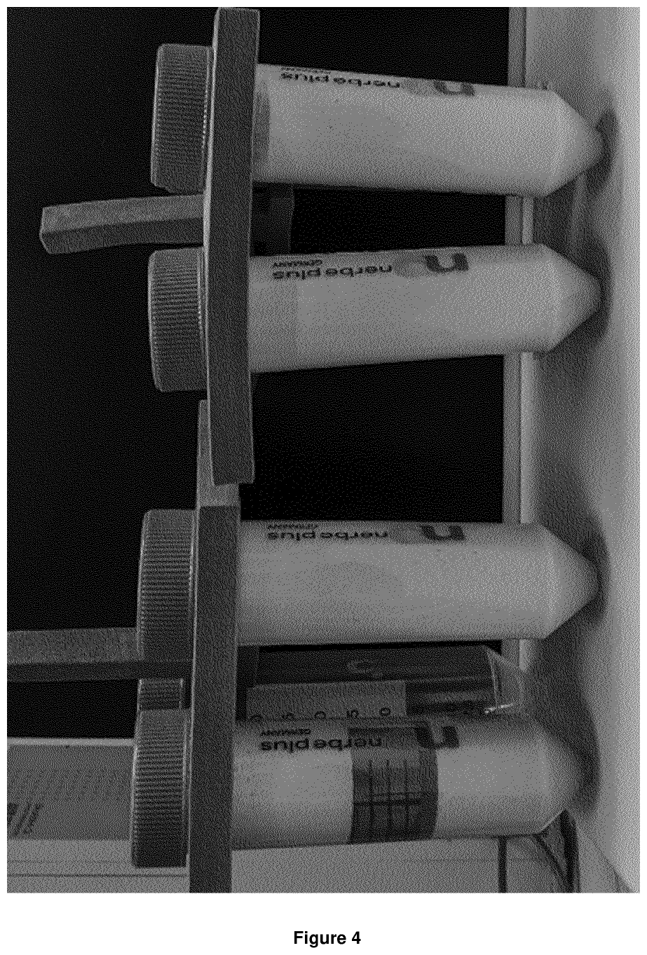

Several self-emulsifiable concentrates containing increasing amounts of thickening agents were formulated with a specific basic recipe containing soybean oil, Atlas G-1068 and Atlox 4914 with around 40% spray-dried protein-containing composition (Table 4). No components changed in quantity except the amount of oil vehicle, to make up for the change in quantity of the thickening agent. In this example, Aerosil 200 was selected as thickening agent and was added as last ingredient at the end of the final mixing step. FIG. 4 shows the results after 3.5 months of incubation.

TABLE 4
Self-emulsifiable concentrates with increasing amounts
of thickening agents (0%, 0.5%, 1%, 1.5%).

| | protein- | | | | | |
|---|---|---|---|---|---|---|
| | containing | bioactive | Thickening | Oil | | |
| | composition | protein | agent | vehicle | Emulsifier | dispersant |
| Name | (w/w %) | (w/w %) | (w/w %) | (w/w %) | (w/w %) | (w/w %) |
| S.0 | (39.96) | VHH | N.A. | Soyabean oil | Atlas G-1086 | Atlox 4914 |
| | | (7.51) | | (49.99) | (7.03) | (3.02) |
| S.0.5 | (39.96) | VHH | Aerosil 200 | Soyabean oil | Atlas G-1086 | Atlox 4914 |
| | | (7.51) | (0.56) | (49.44) | (7.01) | (3.04) |
| S.1.0 | (39.79) | VHH | Aerosil 200 | Soyabean oil | Atlas G-1086 | Atlox 4914 |
| | | (7.48) | (1.01) | (49.05) | (7.02) | (3.14) |
| S.1.5 | (39.90) | VHH | Aerosil 200 | Soyabean oil | Atlas G-1086 | Atlox 4914 |
| | | (7.50) | (1.54) | (48.57) | (6.99) | (3.00) |

For this specific basic recipe, 0% thickening agent resulted in clear phase separation with a compact upper layer inhibiting flowability. Shaking by hand did not break the upper layer. Adding a small amount of thickening agent resolved this issue. The optimal concentration lies between 0.5% w/w and 1.0% w/w. If the thickener concentration was increased further from 1.0% w/w onwards, the composition became more viscous. For 1.5% w/w, shaking by hand is required to get the composition flowing. The results are summarized in Table 5.

TABLE 5
Summary of the assessment stability and behavior of the self-emulsifiable
concentrates of Table 4. The scores in the table range from −−−
(very poor) to +++ (very good) with 0 as middle point.

| Parameter | S.0 | S.0.5 | S.1.0 | S.1.5 |
|---|---|---|---|---|
| Physical separation | −−− | +++ | +++ | +++ |
| Flowability | −−− | +++ | +++ | + |

### Example 11: Efficacy Testing

Phytotoxicity and efficacy of the self-emulsifiable concentrate are assessed in an in-house assay on bean leaf punches infected with, for example Botrytis cinerea or powdery mildew. Disease severity and disease incidence are assessed 7 days after application.

### Example 12: Stabilizing Effect of the Protein-Containing Composition

The self-emulsifiable concentrates used in this example are set out in Table. In all cases, the used oil was soyabean oil, the emulsifier was Atlas G-1086, the dispersant was Atlox 4914, and the used thickener was Aerosil 200.

The production process, was as follows:
1. Add the specified amount of oil to a mixing recipient.
2. Add the specified amount of emulsifier to the oil in the mixing recipient.
3. Add the specified amount of dispersant to the oil in the mixing recipient.
4. Mix the oil, emulsifier and dispersant at low speed (250 rpm) with a paddle mixer.
5. Turn off stir and add the specified amount of the protein-containing composition to the mixing recipient.
6. Start mixing at 250 rpm until all the protein-containing composition is incorporated.
7. Slowly increase the mixing speed to 1000 rpm. Leave the mixer for a few minutes at 1000 rpm, then decrease back to 250 rpm.
8. Turn off the mixer and add the specified amount of thickener (if any).
9. Mix at 250 rpm until all thickener is incorporated.
10. Slowly increase the mixing speed to 1000 rpm. Leave the mixer for a few minutes at 1000 rpm, then decrease back to 250 rpm.
1. Turn off the mixer and aliquot the mixture.

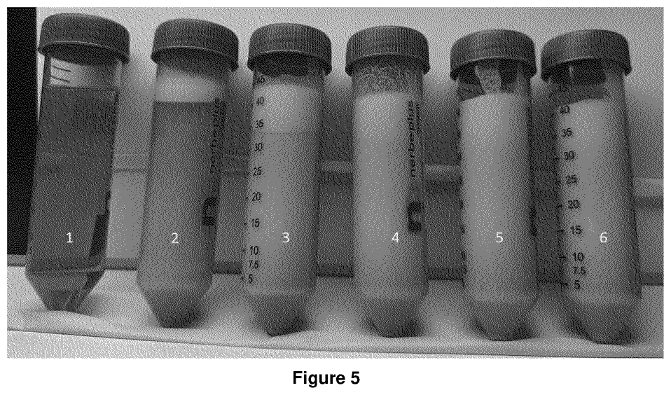

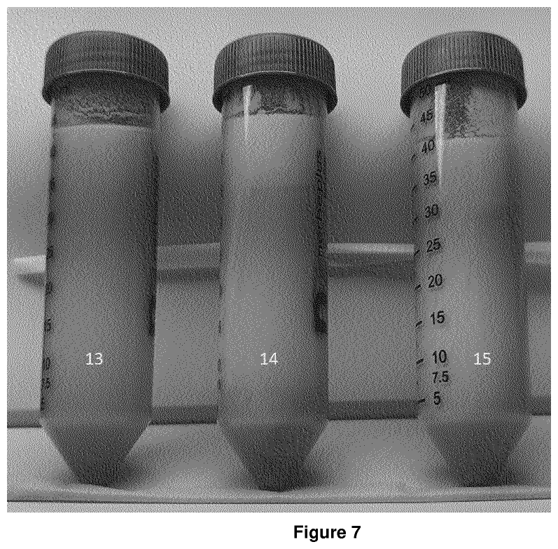

TABLE 6
Self-emulsifiable concentrates used in Example 12. In every case, oil is soyabean oil,
the emulsifier is Atlas G-1086, the dispersant is Atlox 4914 and the thickener used
is Aerosil 200. SD product is the spray dried protein-containing composition.

| | Oil | Emulsifier | Dispersant | SD product | Thickener | |
|---|---|---|---|---|---|---|
| Sample name (ID) | (% w/w) | (% w/w) | (% w/w) | (% w/w) | (% w/w) | Observation (FIG.) |
| Full blank (1) | 81.8 | 12.7 | 5.5 | 0.0 | 0 | Control, no separation |
| | | | | | | (FIG. 5 - 1) |
| Matrix 10% w/w (2) | 73.6 | 11.5 | 4.9 | 10.0 | 0 | Strong separation |
| | | | | | | (FIG. 5 - 2) |
| Matrix 20% w/w (3) | 65.5 | 10.2 | 4.4 | 20.0 | 0 | Separation |
| | | | | | | (FIG. 5 - 3) |
| Matrix 30% w/w (4) | 57.2 | 8.9 | 3.8 | 30.0 | 0 | Slight separation |
| | | | | | | (FIG. 5 - 4) |
| Matrix 40% w/w (5) | 48.8 | 7.6 | 3.3 | 40.4 | 0 | Very slight separation |
| | | | | | | (FIG. 5 - 5) |
| Matrix 44% w/w (6) | 45.8 | 7.1 | 3.1 | 44.1 | 0 | Very slight separation |
| | | | | | | (FIG. 5 - 6) |
| Combination 3 (13) | 56.5 | 8.8 | 3.9 | 30.2 | 0.7 | No separation |
| | | | | | | (FIG. 7 - 13) |
| Combination 4 (14) | 56.5 | 8.8 | 3.9 | 30.5 | 0.3 | Very slight separation |
| | | | | | | (FIG. 7 - 14) |
| Combination 5 (15) | 56.5 | 8.8 | 3.9 | 30.8 | 0 | Slight separation |
| | | | | | | (FIG. 7 - 15) |

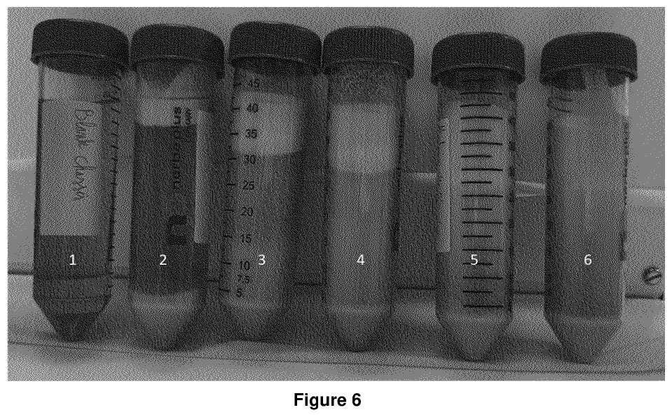

As shown in FIG. 5 phase separation decreased with an increased concentration of the protein containing composition. Here the protein containing composition comprises a bioactive protein, specifically a VHH and dry matter derived from a Pichia pastoris fermentation and the protein containing composition was added in the form of a spray-dried powder (SD). FIG. 5 illustrates stability of the samples with ID 1 to 6, where 1 is a blank, without protein-containing composition and from sample 2 to 6 increasing amounts of protein containing composition as a spray dried powder was added to the self-emulsifiable concentrates. FIG. 5 was taken after 2 days of storage at room temperature. FIG. 6 shows the exact same composition but after 7 days of storage at room temperature. This experiment surprisingly shows that the protein-containing composition increases the stability of the self-emulsifiable concentrates.

In the self-emulsifiable concentrates of combinations 3 and 4 (see table 6), small amounts of a rheology modifier or thickener (in this case Aerosil 200) was added in combination with approximately 30% protein-containing compositions. Where no rheology modifier added (combination 5), phase separation appears very slightly (see FIG. 7) and would not present a major problem for a commercial preparation as this slight separation can be resolved by simply shaking the container. This phase separation then further decreases as Aerosil 200 content increases, with combination 3 (0.70% w/w Aerosil 200) not showing any sign of phase separation occurring in the self-emulsifiable concentrate. This example further shows that the amount of rheology modifier can be greatly reduced and even omitted where a protein-containing composition as described herein is added to a self-emulsifiable concentrate.

### Example 13: Self-Emulsifiable Concentrates Composed of Different Combinations of Oil and Rheology Modifiers in the Presence of Protein-Containing Composition

Several different recipes of self-emulsifiable concentrates comprising a spray-dried protein-containing composition were made and tested for stability. As the oil and the rheology modifier were changes, the emulsifier (Atlas G-1086) and dispersant (Atlox 4914) remained the same. The results are summarized in Table 7.

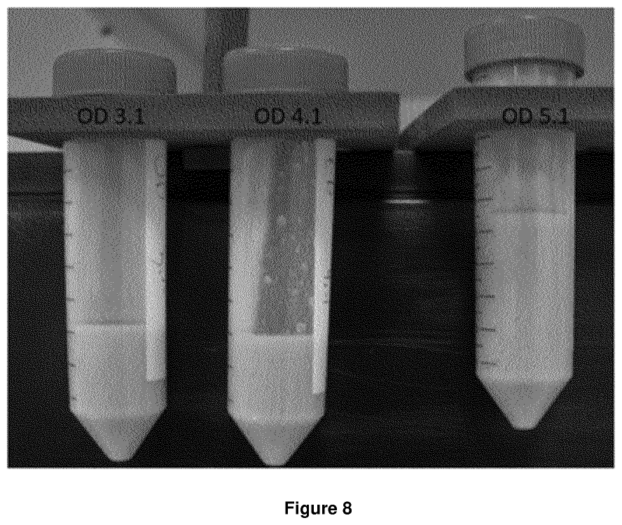

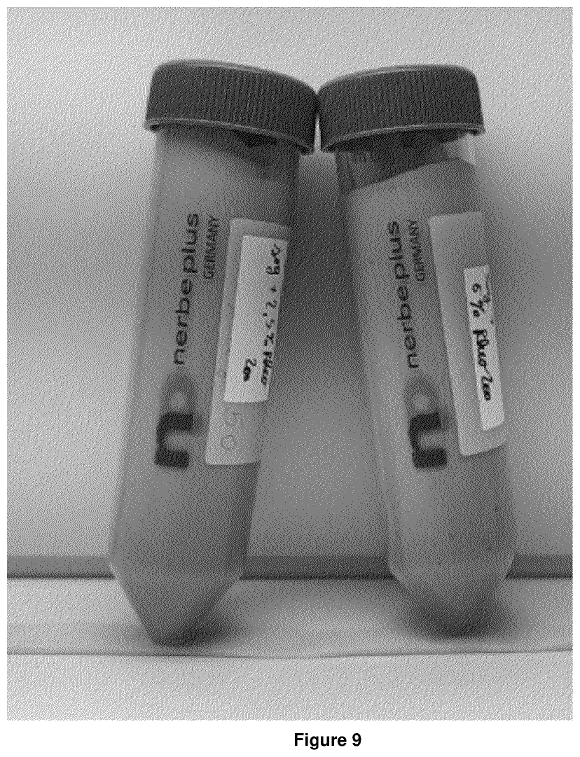

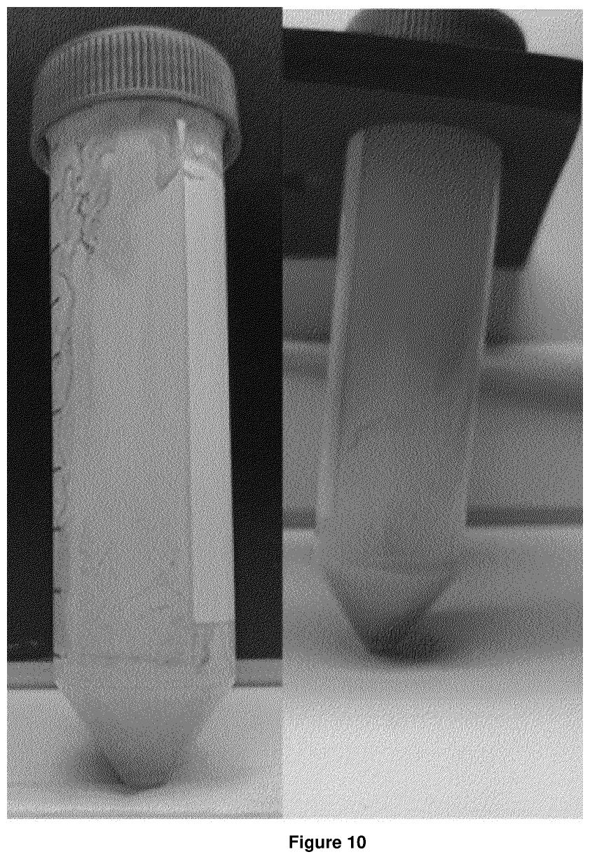

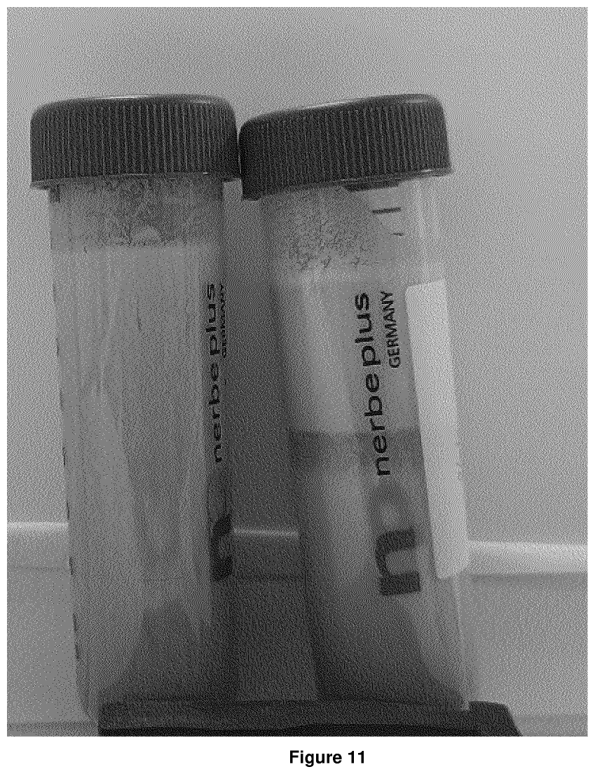

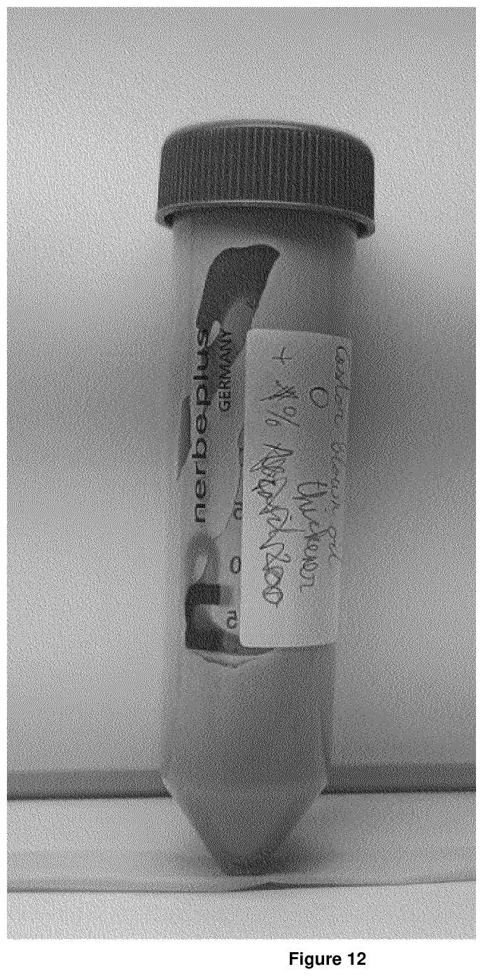

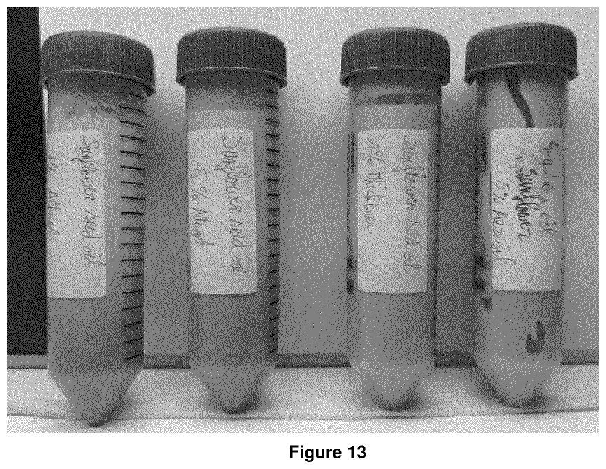

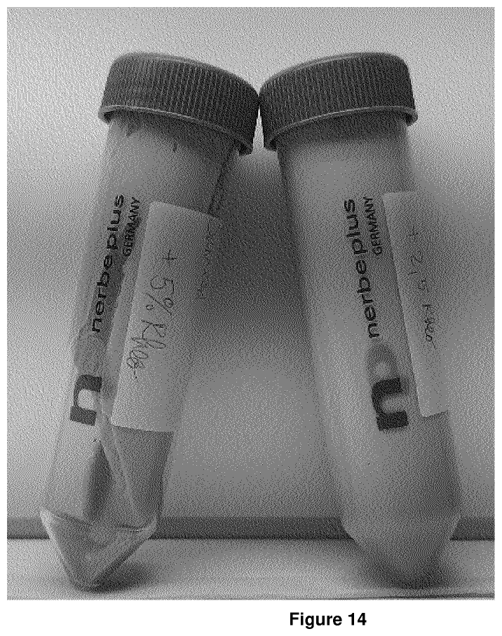

TABLE 7
Self-emulsifiable concentrates prepared with different combinations of carrier oils and rheology modifiers.

| | | | Protein | | | | |
|---|---|---|---|---|---|---|---|
| | | Rheology | containing | | | | |
| Sample | Oil | modifier | composition | Emulsifier | Dispersant | | |
| ID | (% w/w) | (% w/w) | (% w/w) | (% w/w) | (% w/w) | Observation | FIG. |
| OD 3.1 | Rapeseed oil | Rheostrux 200 | (20.0) | Atlas G-1086 | Atlox 4914 | good physical | FIG. 8 |
| | (66.6) | (2.6) | | (6.9) | (4.0) | properties with | |
| | | | | | | no separation | |
| OD 4.1 | Rapeseed oil | Rheostrux 200 | (20.0) | Atlas G-1086 | Atlox 4914 | good physical | FIG. 8 |
| | (66.7) | (3.3) | | (7.0) | (4.1) | properties with | |
| | | | | | | no separation | |
| OD 5.1 | Rapeseed oil | Rheostrux 200 | (20.0) | Atlas G-1086 | Atlox 4914 | good physical | FIG. 8 |
| | (66.3) | (4.0) | | (6.9) | (3.9) | properties with | |
| | | | | | | no separation | |
| 13-4 | Soybean oil | Rheostrux 200 | (40.1) | Atlas G-1086 | Atlox 4914 | good physical | FIG. 9 |
| | (46.5) | (2.5) | | (7.0) | (3.9) | properties with | |
| | | | | | | no separation | |
| 13-5 | Soybean oil | Rheostrux 200 | (39.8) | Atlas G-1086 | Atlox 4914 | No phase | FIG. 9 |
| | (44.4) | (5.0) | | (7.0) | (3.9) | separation but | |
| | | | | | | too viscous | |
| 13-6 | Soybean oil | Aerosil 200 | (40.1) | Atlas G-1086 | Atlox 4914 | good physical | FIG. 10 |
| | (47.4) | (2.5) | | (7.0) | (3.0) | properties with | |
| | | | | | | no separation | |
| | | | | | | (also see | |
| | | | | | | example 14) | |
| 13-7 | Soybean oil | Attagel 50 | (36.8) | Atlas G-1086 | Atlox 4914 | Good properties | FIG. 11 |
| | (48.8) | (0.9) | | (10.4) | (3.2) | but phase | |
| | | | | | | separation | |
| | | | | | | after 6 days | |
| 13-8 | Soybean oil | Attagel 50 | (34.5) | Atlas G- | Atlox 4914 | good physical | FIG. 11 |
| | (50.8) | (4.9) | | 1086 | (2.9) | properties with | |
| | | | | (6.9) | | no separation. | |
| 13-9 | Castor oil | NA | (39.9) | Atlas G- | Atlox 4914 | Thickening effect | FIG. 12 |
| | (49.9) | | | 1086 | (3.1) | of protein- | |
| | | | | (7.1) | | containing | |
| | | | | | | composition too | |
| | | | | | | strong with castor | |
| | | | | | | oil. Castor oil | |
| | | | | | | may be used as an | |
| | | | | | | additive to | |
| | | | | | | increase viscosity. | |
| 13-10 | Sunflower oil | Aerosil 200 | (40.0) | Atlas G-1086 | Atlox 4914 | good physical | FIG. 13 |
| | (48.9) | (1.0) | | (7.0) | (3.10) | properties with | |
| | | | | | | no separation. | |
| 13-11 | Sunflower oil | Aerosil 200 | (38.5) | Atlas G-1086 | Atlox 4914 | good physical | FIG. 13 |
| | (47.0) | (4.8) | | (6.8) | (3.0) | properties with | |
| | | | | | | no separation. | |
| 13-12 | Sunflower oil | Attagel 50 | (48.5) | Atlas G-1086 | Atlox 4914 | good physical | FIG. 13 |
| | (48.5) | (1.1) | | (7.4) | (3.3) | properties with | |
| | | | | | | no separation. | |
| 13-13 | Sunflower oil | Attagel 50 | (46.7) | Atlas G-1086 | Atlox 4914 | good physical | FIG. 13 |
| | (46.7) | (4.9) | | (7.1) | (3.2) | properties with | |
| | | | | | | no separation | |
| 13-14 | Sunflower oil | Rheostrux 200 | (39.8) | Atlas G-1086 | Atlox 4914 | Viscous but | FIG. 14 |
| | (46.7) | (2.5) | | (7.0) | (4.0) | remained fluid. | |
| | | | | | | No phase | |
| | | | | | | separation. | |
| 13-15 | Sunflower oil | Rheostrux 200 | (39.0) | Atlas G-1086 | Atlox 4914 | Rheostrux | FIG. 14 |
| | (45.5) | (4.8) | | (6.8) | (4.0) | difficult to | |
| | | | | | | incorporate | |
| | | | | | | completely. Too | |
| | | | | | | viscous after | |
| | | | | | | addition of | |
| | | | | | | protein-based | |
| | | | | | | composition | |

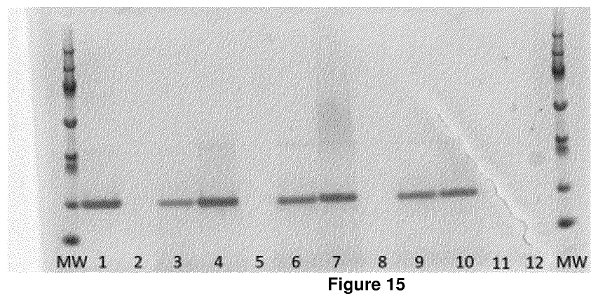

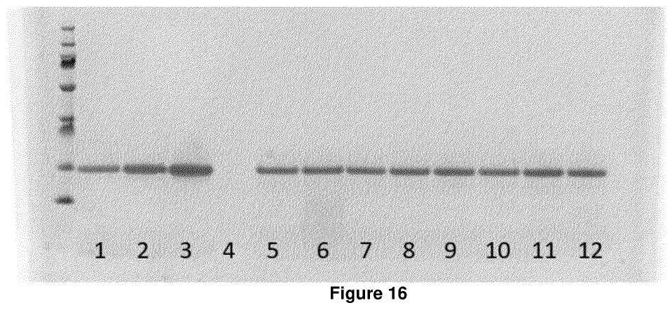

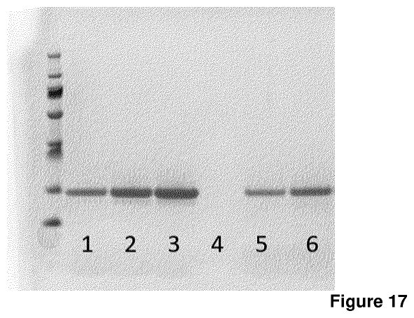

The above samples were tested for stability of the bioactive protein, here a VHH, by using SDS-PAGE analysis. The results are summarized in FIG. 15 for self-emulsifiable concentrates OD 3.1, 4.1 and 5.1 (Table 7). FIG. 16 displays the SDS-PAGE analysis of the bioactive protein, a VHH present in the self-emulsifiable concentrates identified by Sample IDs (according to Table 7) 13-4 and 13-5 (wells 5 and 6), 13-7 and 13-8 (wells 7 and 8), 13-10 and 13-11 (wells 9 and 10), 13-14 and 13-15 (wells 11 and 12). FIG. 17 displays the SDS-PAGE analysis of the bioactive protein, a VHH present in the self-emulsifiable concentrates identified by Sample IDs 13-12 and 13-13 (wells 5 and 6). In none of these SDS PAGE results a significant decay of the VHH is observed indicating compatibility of the VHH with the presented self-emulsifiable concentrates. All samples except sample 13-15 were stored for 7 days at room temperature prior to obtaining the SDS-PAGE sample. 13-15 was stored for 3 days at temperature prior to obtaining the SDS-PAGE sample.

### Example 14: Bioactive Protein Remains Stable for Up to 2 Years

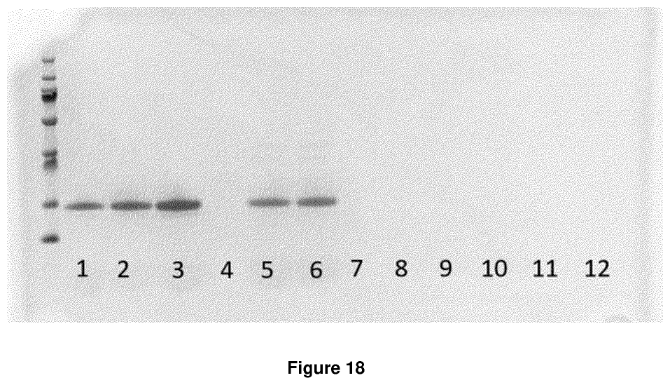

The self-emulsifiable concentrate as described in Table 7, sample 13.6, was stored for 2 years. No deterioration or phase separation of the self-emulsifiable concentrate was observed (FIG. 10). Furthermore, assessing protein content by quantifying the Coomassie stained gel and comparing the test samples with the standards (FIG. 18) revealed that the samples stored for 2 years still retained the same quantity of VHH antibody of around 1 mg/ml.

Statements (features) and embodiments of the methods and compositions as disclosed herein are set out herebelow. Each of the statements and embodiments as disclosed by the invention so defined may be combined with any other statement and/or embodiment unless clearly indicated to the contrary. In particular, any feature indicated as being preferred or advantageous may be combined with any other feature or features indicated as being preferred or advantageous.

### Embodiments

The present invention provides at least the following numbered statements of invention
1. A self-emulsifiable concentrate comprising
   i. an oil vehicle, and
   ii. one or more dispersants, and
   iii. one or more emulsifiers,
characterized in that the self-emulsifiable concentrate further comprises
   iv. a protein-containing composition,
      wherein the protein-containing composition is in an essentially solid state,
      wherein the protein-containing composition is dispersed in the oil vehicle, and
   v. no more than 10% w/w of a thickening agent other than the protein-containing composition.
2. The self-emulsifiable concentrate of statement 1, which comprises no more than 5% w/w of a thickening agent other than the protein-containing composition,
3. The self-emulsifiable concentrate of statement 1, which comprises no more than 2.5% w/w of a thickening agent other than the protein-containing composition.
4. The self-emulsifiable concentrate of statement 1, which comprises no more than 2% w/w of a thickening agent other than the protein-containing composition.
5. The self-emulsifiable concentrate of statement 1, which comprises no more than 1% w/w of a thickening agent other than the protein-containing composition.
6. The self-emulsifiable concentrate of statement 1, which comprises no more than 0.5% w/w of a thickening agent other than the protein-containing composition,
7. The self-emulsifiable concentrate of statement 1, further characterized by containing essentially no thickening agent other than the protein-containing composition.
8. The self-emulsifiable concentrate of any one of statements 1 to 7, wherein the protein-containing composition comprises dry matter derived from a microbial fermentation and where the dry matter comprises a bioactive protein.
9. The self-emulsifiable concentrate of statement 8, wherein the microbial fermentation is derived from a yeast fermentation, a filamentous fungi fermentation.
10. The self-emulsifiable concentrate of statement 8, wherein the microbial fermentation is derived from a bacterial fermentation.
11. The self-emulsifiable concentrate of any one of statements 8 to 10, wherein the bioactive protein is an antibody, an antibody fragment or a VHH.
12. The self-emulsifiable concentrate of any one of statements 8 to 10, wherein the bioactive protein is a VHH.
13. The self-emulsifiable concentrate of any one of statements 8 to 10, wherein the bioactive protein is a toxin such as a Bacillus thuringiensis (Bt) toxin, a crystal (Cry) toxin, a cytolytic (Cyt) toxin, a vegetative insecticidal protein (Vip), a secreted insecticidal protein (Sip), a Bin-like toxin or a spider toxin such as an agatoxin or a diguetoxin.
14. The self-emulsifiable concentrate of any one of statements 8 to 10, wherein the bioactive protein is an antimicrobial peptide.
15. The self-emulsifiable concentrate of any one of statements 8 to 14, wherein the bioactive protein is present in an amount of 5% to 25% (w/w) of the protein-containing composition.
16. The self-emulsifiable concentrate of any preceding statement, wherein the protein-containing composition comprises one or more wetting agents, humectants, stabilisers, buffering agents, sticker agents, antifoam agents, fillers, or combinations thereof.
17. The self-emulsifiable concentrate of any preceding statement, wherein the protein-containing composition comprises one or more or all of the following:
   a) a filler agent which is trisodium citrate dihydrate, or a silicon dioxide;
   b) a preservative which is a sorbate salt such as potassium sorbate, or an acid such as citric acid;
   c) an antifoam agent which is a silicone fluid such as polydimethylsiloxane, or a tertiary amine oxides such as decyldimethyl-aminoxide;
   d) a buffer agent which is a citrate salt, such as citric acid monophosphate, or a phosphate buffer, or a HEPES buffer;
   e) an anti-caking agent which is an anhydrous compound;
   f) a sticker which is a hydroxyethyl cellulose polymer, or guar gum or products based thereon,
   g) a humectant which is an attapulgite clay powder, such as magnesium aluminium phyllosilicate, or a silicon dioxide; and
   h) a surfactant which is an organic amphiphilic compound, such as Polyoxyethylene sorbitan monolaurate, or a polyether siloxane such as Polyoxyethylene (20) oleyl ether, or an alcohol ethoxylat such as Ethylene Oxide/Propylene Oxide Block Copolymers.
18. The self-emulsifiable concentrate of statement 16 wherein
   a) the filler agent is present in a concentration in the range of 1 and 40% w/w of the protein-containing composition,
   b) the preservative is present in a concentration in the range of 0.1 and 5% w/w of the protein-containing composition,
   c) the antifoam agent is present in a concentration in the range of 0.1 and 1.5% w/w of the protein-containing composition,
   d) the buffer agent is present in a concentration in the range of 0.1 and 4.5% w/w of the protein-containing composition,
   e) the anti-caking agent is present in a concentration in the range of 0.1 to 25% w/w of the protein-containing composition,
   f) the sticker is present in a concentration in the range of 0.1 and 1% w/w of the protein-containing composition,
   g) the humectant is present in a concentration in the range of 0.1 to 2.5% w/w of the protein-containing composition, and
   h) the surfactant is present in a concentration in the range of 0.1 to 10% w/w of the protein-containing composition.
19. The self-emulsifiable concentrate of statement 18, wherein the protein-containing composition further comprises from 0% to 15% w/w water.
20. The self-emulsifiable concentrate of any preceding statement, wherein the protein-containing composition is a spray-dried powder.
21. The self-emulsifiable concentrate of statement 20, wherein the protein-containing composition is a milled spray-dried powder.
22. The self-emulsifiable concentrate of any preceding statement, wherein the one or more dispersants are selected from the group consisting of high molecular weight polymers, ethoxylated anchoring groups, carboxylic acid based anchoring groups, polymeric dispersants and polyethers.
23. The self-emulsifiable concentrate of any preceding statement, wherein the one or more dispersants are selected from alkoxylated polyolefins, such as polyisobutylene succinic anhydride-polyethylene glycol.
24. The self-emulsifiable concentrate of any preceding statement, wherein the one or more emulsifiers are selected from the group consisting of fatty alcohol alkoxylates, polyalkoxylates, copolymers and block copolymers of glycerol with hydroxylated saturated and unsaturated fatty acids, ethoxylated glycerol esters of hydroxy fatty acids and their derivatives, polyether siloxanes, nonionic modified polyesters, polyglycerol fatty acid partial esters, ethoxylated sorbitans partial esters, peresters, alkoxylated fatty alcohols, alkyl-aryl-sulfonates, ethoxylated glycerol esters of hydroxy fatty acids and their derivatives, N-hydroxyalkyl amides of saturated and unsaturated fatty acids and fermentation products of glucose and rapeseed-oil fatty acids with yeast Starmerella bombicola.
25. The self-emulsifiable concentrate of any preceding statement wherein the one or more emulsifiers includes an ethoxylated sorbitan oleate.
26. The self-emulsifiable concentrate of any preceding statement wherein the one or more thickening agents are selected from the group consisting of natural polymers, synthetic polymers, inorganic material, polysaccharides, proteins, minerals, swellable polymers, associative thickeners, steric dispersants, polystyrene, polyacrylamide, polymethylacrylates, polyamides, polyesters, polyanhydrides, polyurethanes, amino resins, polycyanoacrylates, polyamide polymers, copolyimide, polyester block co-polymers, thermoplastic polyamides, silicon dioxides, hydrophilic fumed silicas and precipitated silicas.
27. The self-emulsifiable concentrate of any preceding statement wherein the one or more thickening agents are selected from the group consisting of natural polymers, synthetic polymers, inorganic material, polysaccharides, proteins, minerals, swellable polymers, associative thickeners, steric dispersants, polystyrene, polyacrylamide, polymethylacrylates, polyamides, polyesters, polyanhydrides, polyurethanes, amino resins, polycyanoacrylates, polyamide polymers, copolyimide, polyester block co-polymers, thermoplastic polyamides, silicon dioxides, hydrophilic fumed silicas, precipitated silicas and attapulgite clay powders.
28. The self-emulsifiable concentrate of any preceding statement wherein the one or more thickening agents include a hydrophilic fumed silica or a polyamide.
29. The self-emulsifiable concentrate of any preceding statement wherein the one or more thickening agents include a polyamide, attapulgite clay powder or a hydrophilic fumed silica.
30. The self-emulsifiable concentrate of any preceding statement, wherein the oil vehicle is selected from vegetable oils, synthetic oils, fatty acids or combinations thereof.
31. The self-emulsifiable concentrate of any preceding statement, wherein the oil vehicle comprises one or more vegetable oils.
32. The self-emulsifiable concentrate of statement 31, wherein the one or more vegetable oils are selected from linseed oil, soyabean oil, sunflower oil, rapeseed oil, olive oil, castor oil, colza oil, maize germ oil, cottonseed oil, canola oil, peanut oil and corn oil.
33. The self-emulsifiable concentrate of any preceding statement, additionally comprising one or more surface stabilizing agents, adjuvants, additives, filling materials, colorants, antioxidants, preservatives, antifoam substances, or combinations thereof.
34. The self-emulsifiable concentrate of any preceding statement where the self-emulsifiable concentrate comprises between 15% and 50% w/w protein-containing composition, between 0% and 10% w/w thickening agent, between 18% and 77% w/w oil vehicle, between 5% and 15% w/w emulsifier and between 3% and 7% w/w dispersant.
35. The self-emulsifiable concentrate of any preceding statement where the self-emulsifiable concentrate comprises from 15% to 50% w/w protein-containing composition, from 0% to 10% w/w thickening agent, from 18% to 77% w/w oil vehicle, from 5% to 15% w/w emulsifier and from 3% to 7% w/w dispersant.
36. The self-emulsifiable concentrate of any preceding statement where the self-emulsifiable concentrate comprises between 15% and 50% w/w protein-containing composition, between 0% and 5% w/w thickening agent, between 23% and 77% w/w oil vehicle, between 5% and 15% w/w emulsifier and between 3% and 7% w/w dispersant.
37. The self-emulsifiable concentrate of any preceding statement where the self-emulsifiable concentrate comprises from 15% to 50% w/w protein-containing composition, from 0% to 5% w/w thickening agent, from 23% to 77% w/w oil vehicle, from 5% to 15% w/w emulsifier and from 3% to 7% w/w dispersant.
38. The self-emulsifiable concentrate of any preceding statement where the self-emulsifiable concentrate comprises 40% w/w protein-containing composition, 2.5% thickening agent, 47.5% w/w oil vehicle, 7% w/w emulsifier, 3% w/w dispersant.
39. The self-emulsifiable concentrate of any preceding statement where the self-emulsifiable concentrate comprises 40% w/w protein-containing composition, 1.5% w/w thickening agent, 47% w/w oil vehicle, 8% w/w emulsifier, 3.5% w/w dispersant.
40. The self-emulsifiable concentrate of any preceding statement where the self-emulsifiable concentrate comprises 40% w/w protein-containing composition, 1.5% w/w thickening agent, 48.5% w/w oil vehicle, 7% w/w emulsifier, 3% w/w dispersant.
41. The self-emulsifiable concentrate of any preceding statement where the self-emulsifiable concentrate comprises 40% w/w protein-containing composition, 1% w/w thickening agent, 49% w/w oil vehicle, 7% w/w emulsifier, 3% w/w dispersant.
42. The self-emulsifiable concentrate of any preceding statement where the self-emulsifiable concentrate comprises 40% w/w protein-containing composition, 0.5% w/w thickening agent, 49.5% w/w oil vehicle, 7% w/w emulsifier, 3% w/w dispersant.
43. A method for producing the self-emulsifiable concentrate of any preceding statement, comprising the steps of
   i. optionally heating the oil vehicle to a temperature between 60° C. and 90° C., preferably to about 85° C. to 90° C.,
   ii. optionally incorporating no more than 10% w/w of the thickening agent, other than the protein-containing composition, by mixing it with the heated oil vehicle, optionally by mixing at low shear force,
   iii. if heated in step i., cooling the oil vehicle, optionally cooling to room temperature,
   iv. adding the one or more dispersants to the oil vehicle,
   v. adding the one or more emulsifiers to the oil vehicle,
   vi. optionally further adding one or more surface stabilizing agents, adjuvants, additives, filling materials, colorants, antioxidants, preservatives, antifoam substances, or combinations thereof, to the oil vehicle,
   vii. adding the protein-containing composition to the oil vehicle, wherein the protein-containing composition becomes dispersed in the oil vehicle.
44. A method for producing the self-emulsifiable concentrate of any preceding statement, comprising the steps of
   i. optionally heating the oil vehicle to a temperature in the range of 60° C. to 90° C., preferably about 85° C. to 90° C.,
   ii. optionally incorporating no more than 10% w/w, preferably no more than 5% w/w, even more preferably no more than 2.5% w/w, even more preferably no more than 2% w/w, most preferably no more than 1% w/w of the thickening agent, other than the protein-containing composition, by mixing it with the heated oil vehicle, optionally by mixing at low shear force,
   iii. if heated in step i., cooling the oil vehicle, optionally cooling to room temperature,
   iv. adding the one or more dispersants to the oil vehicle,
   v. adding the one or more emulsifiers to the oil vehicle,
   vi. optionally further adding one or more surface stabilizing agents, adjuvants, additives, filling materials, colorants, antioxidants, preservatives, antifoam substances, or combinations thereof, to the oil vehicle,
   vii. adding the protein-containing composition to the oil vehicle, wherein the protein-containing composition becomes dispersed in the oil vehicle.
45. A method for producing the self-emulsifiable concentrate of any one of statements 1 to 44, comprising the steps of
   i. providing the oil vehicle,
   ii. adding the one or more dispersants to the oil vehicle,
   iii. adding the one or more emulsifiers to the oil vehicle,
   iv. optionally further adding one or more emulsifier, surface stabilizing agent, adjuvant, filling material, colorant, antioxidant, preservative, antifoam substance, or combinations thereof, to the oil vehicle,
   v. adding the protein-containing composition to the oil vehicle, wherein the protein-containing composition becomes dispersed in the oil vehicle,
   vi. optionally incorporating no more than 10% w/w, preferably no more than 5% w/w, even more preferably no more than 2.5% w/w, even more preferably no more than 2% w/w, most preferably no more than 1% w/w of the thickening agent, other than the protein-containing composition, by mixing, optionally by mixing at low shear force.
46. The method of any one of statements 43 to 45, further comprising producing the protein-containing composition from a microbial fermentation.
47. The method of any one of statements 43 to 46, further comprising an additional milling step performed after the addition of the protein-containing composition.
48. A method of emulsifying the self-emulsifiable concentrate of any one of statements 1 to 42, the method comprising mixing the self-emulsifiable concentrate with an aqueous solution.
49. Use of the self-emulsifiable concentrate of any one of statements 1 to 42 for the treatment or prevention of a plant pathogenic infection.
50. Use of the self-emulsifiable concentrate of any one of statements 1 to 42 to improve the fitness of a crop, improve the stress resistance of a crop, improve the yield of a crop and/or improve the resistance of a crop to infections.
51. A method comprising
   a) emulsifying the self-emulsifiable concentrate of any one of statements 1 to 42 by mixing it with an aqueous solution, thereby producing an emulsified solution; and
   b) applying the emulsified solution to one or more plants.
52. The method of statement 51, which is a method for
   a) treating or preventing a pathogenic infection in one or more plants; and/or
   b) improving the fitness of a crop, improving the stress resistance of a crop, and/or improving the yield of a crop.
53. A kit of parts, comprising
   a) the self-emulsifiable concentrate of any one of statements 1 to 42; and
   b) an aqueous solution.
54. Kit of parts, comprising
   a) an oil vehicle,
   b) one or more dispersants,
   c) optionally one or more of surface stabilizing agents, adjuvants, additives, filling materials, colorants, antioxidants, preservatives, antifoam substances, or combinations thereof,
   d) a protein-containing composition, which is in an essentially solid state,
   e) optionally, a thickening agent other than the protein-containing composition,
   f) instructions for preparing a self-emulsifiable concentrate in which the protein-containing composition is dispersed in the oil vehicle and, if present, the thickening agent is present in an amount of no more than 10% w/w, preferably no more than 5% w/w, even more preferably no more than 2.5% w/w, even more preferably no more than 2% w/w, most preferably no more than 1% w/w.
55. An agrochemical composition comprising the self-emulsifiable concentrate of any one of statements 1 to 42 emulsified in water, and optionally one or more tank mix additives.
56. A method for protecting or treating a plant or a part of the plant from an infection or other biological interaction with a plant pathogen, at least comprising the step of applying directly or indirectly to the plant or to a part of the plant the agrochemical composition of statement 55, under conditions effective to protect or treat the plant or a part of the plant against the infection or biological interaction with the plant pathogen.
57. The method according to statement 56, wherein the agrochemical composition is directly or indirectly applied to the plant or to a part of the plant by spraying, atomizing, foaming, fogging, culturing in hydroculture, culturing in hydroponics, coating, submerging, and/or encrusting.
58. The method according to statement 56 or statement 57, wherein the agrochemical composition is directly or indirectly applied to the plant or to a part of the plant postharvest.
59. A post-harvest treatment method for protecting or treating a harvested plant or a harvested part of the plant from an infection or other biological interaction with a plant pathogen, at least comprising the step of applying directly or indirectly to the harvested plant or to a harvested part of the plant the agrochemical composition of statement 55, under conditions effective to protect or treat the harvested plant or a harvested part of the plant against the infection or biological interaction with the plant pathogen.
60. The self-emulsifiable concentrate of any one of statements 1 to 42, comprising (i) from 20% (w/w) to 50% w/w protein-containing composition, preferably wherein the protein containing composition comprises dry matter derived from a microbial fermentation and comprising a bioactive protein, preferably a VHH, (ii) from 1% (w/w) to 5% (w/w) thickening agent, wherein the thickening agent is selected from a polyamide, attapulgite clay powder or a silicon dioxide, preferably a silicon dioxides, (iii) from 40% (w/w) to 70% (w/w) oil vehicle, wherein the oil vehicle is selected from rapeseed oil, soybean oil or sunflower oil, preferably soybean oil, (iv) about 7% (w/w) of an ethoxylated sorbitan oleate as an emulsifier, and (v) from 3% (w/w) to 4% (w/w) polyisobutylene succinic anhydride-polyethylene glycol as a dispersant.
61. The self-emulsifiable concentrate of any one of statements 1 to 42, comprising around 40% (w/w) protein-containing composition comprising dry matter derived from a microbial fermentation and comprising a VHH, (ii) about 1% (w/w) of a silicon dioxide as a thickener, (iii) about 49% (w/w) soybean oil, (iv) about 7% ethoxylated sorbitan oleate as an emulsifier, and (v) about 3% (w/w) polyisobutylene succinic anhydride-polyethylene glycol as a dispersant.
62. The self-emulsifiable concentrate of any one of statements 1 to 42, comprising around 40% (w/w) protein-containing composition comprising dry matter derived from a microbial fermentation and comprising a VHH, (ii) about 1% (w/w) of an attapulgite clay powder as a thickener, (iii) about 49% (w/w) soybean oil, (iv) about 7% ethoxylated sorbitan oleate as an emulsifier, and (v) about 3% (w/w) polyisobutylene succinic anhydride-polyethylene glycol as a dispersant.

1-20. (canceled)

21. A self-emulsifiable concentrate comprising
i. an oil vehicle, and
ii. one or more dispersants, and
iii. one or more emulsifiers,
characterized in that the self-emulsifiable concentrate further comprises
iv. a protein-containing composition,
wherein the protein-containing composition is in an essentially solid state,
wherein the protein-containing composition is dispersed in the oil vehicle, and
v. no more than 10% w/w of a thickening agent other than the protein-containing composition.

22. The self-emulsifiable concentrate of claim 21, which comprises no more than 2% w/w of a thickening agent other than the protein-containing composition, optionally wherein the self-emulsifiable concentrate comprises essentially no thickening agent other than the protein-containing composition.

23. The self-emulsifiable concentrate of claim 21, wherein the protein-containing composition comprises dry matter derived from a microbial fermentation and where the dry matter comprises a bioactive protein, optionally wherein the bioactive protein is present in an amount of 10% to 50% (w/w) of the protein-containing composition and/or wherein the microbial fermentation is derived from a yeast fermentation, a filamentous fungi fermentation or a bacterial fermentation.

24. The self-emulsifiable concentrate of claim 23, wherein the bioactive protein is selected from
a) an antibody, an antibody fragment or a VHH;
b) a toxin such as a Bacillus thuringiensis (Bt) toxin, a crystal (Cry) toxin, a cytolytic (Cyt) toxin, a vegetative insecticidal protein (Vip), a secreted insecticidal protein (Sip), a Bin-like toxin or a spider toxin such as an agatoxin or a diguetoxin; or
c) an antimicrobial peptide.

25. The self-emulsifiable concentrate of claim 23, wherein the bioactive protein is a VHH.

26. The self-emulsifiable concentrate of claim 21, wherein the protein-containing composition is a spray-dried powder, optionally wherein the protein-containing composition is a milled spray-dried powder; and/or
wherein the one or more dispersants include an alkoxylated polyolefin, such as polyisobutylene succinic anhydride-polyethylene glycol; and/or
the one or more emulsifiers include an ethoxylated sorbitan oleate; and/or
the one or more thickening agents include a hydrophilic fumed silica, a polyamide or an attapulgite clay powder; and/or
the oil vehicle is selected from vegetable oils, synthetic oils, fatty acids or combinations thereof, optionally wherein the oil vehicle comprises one or more vegetable oils, further optionally wherein the one or more vegetable oils are selected from linseed oil, soyabean oil, sunflower oil, rapeseed oil, olive oil, castor oil, colza oil, maize germ oil, cottonseed oil, canola oil, peanut oil and corn oil.

27. The self-emulsifiable concentrate of claim 21, comprising
(i) from 20% (w/w) to 50% w/w of the protein-containing composition, preferably wherein the protein containing composition comprises dry matter derived from a microbial fermentation and comprising a bioactive protein, preferably a VHH,
(ii) from 1% (w/w) to 5% (w/w) of the thickening agent, wherein the thickening agent is selected from a polyamide, attapulgite clay powder or a silicon dioxide, preferably a silicon dioxide,
(iii) from 40% (w/w) to 70% (w/w) of the oil vehicle, wherein the oil vehicle is selected from rapeseed oil, soybean oil or sunflower oil, preferably soybean oil,
(iv) about 7% (w/w) of an ethoxylated sorbitan oleate as an emulsifier, and
(v) from 3% (w/w) to 4% (w/w) polyisobutylene succinic anhydride-polyethylene glycol as a dispersant.

28. A method for producing the self-emulsifiable concentrate of claim 21, comprising the steps of
i. optionally heating the oil vehicle to a temperature of from 60° C. to 90° C., preferably to from about 85° C. to 90° C.,
ii. optionally incorporating no more than 10% w/w, preferably no more than 5% w/w, even more preferably no more than 2.5% w/w, even more preferably no more than 2% w/w, most preferably no more than 1% w/w of the thickening agent, other than the protein-containing composition, by mixing it with the heated oil vehicle, optionally by mixing at low shear force,
iii. if heated in step i., cooling the oil vehicle, optionally cooling to room temperature,
iv. adding the one or more dispersants to the oil vehicle,
v. adding the one or more emulsifiers to the oil vehicle,
vi. optionally further adding one or more surface stabilizing agents, adjuvants, additives, filling materials, colorants, antioxidants, preservatives, antifoam substances, or combinations thereof, to the oil vehicle,
vii. adding the protein-containing composition to the oil vehicle, wherein the protein-containing composition becomes dispersed in the oil vehicle.

29. A method for producing the self-emulsifiable concentrate of claim 21, comprising the steps of
i. providing the oil vehicle,
ii. adding the one or more dispersants to the oil vehicle,
iii. adding the one or more emulsifiers to the oil vehicle,
iv. optionally further adding one or more emulsifier, surface stabilizing agent, adjuvant, filling material, colorant, antioxidant, preservative, antifoam substance, or combinations thereof, to the oil vehicle,
v. adding the protein-containing composition to the oil vehicle, wherein the protein-containing composition becomes dispersed in the oil vehicle,
vi. optionally incorporating no more than 10% w/w, preferably no more than 5% w/w, even more preferably no more than 2.5% w/w, even more preferably no more than 2% w/w, most preferably no more than 1% w/w of the thickening agent, other than the protein-containing composition, by mixing, optionally by mixing at low shear force.

30. The method of claim 29, further comprising producing the protein-containing composition from a microbial fermentation and/or an additional milling step performed after the addition of the protein-containing composition.

31. The method of claim 30, further comprising producing the protein-containing composition from a microbial fermentation and/or an additional milling step performed after the addition of the protein-containing composition

32. A method of emulsifying the self-emulsifiable concentrate of claim 21, the method comprising mixing the self-emulsifiable concentrate with an aqueous solution.

33. Use of the self-emulsifiable concentrate of claim 21 for
a) the treatment or prevention of a plant pathogenic infection, or
b) improving the fitness of a crop, improving the stress resistance of a crop, improving the yield of a crop and/or improving the resistance of a crop to infections.

34. A method comprising
a) emulsifying the self-emulsifiable concentrate of claim 21 by mixing it with an aqueous solution, thereby producing an emulsified solution; and
b) applying the emulsified solution to one or more plants.

35. A kit of parts, comprising
a) the self-emulsifiable concentrate of claim 21; and
b) an aqueous solution.

36. Kit of parts, comprising
a) an oil vehicle,
b) one or more dispersants,
c) optionally one or more of surface stabilizing agents, adjuvants, additives, filling materials, colorants, antioxidants, preservatives, antifoam substances, or combinations thereof,
d) a protein-containing composition, which is in an essentially solid state,
e) optionally, a thickening agent other than the protein-containing composition,
f) instructions for preparing a self-emulsifiable concentrate in which the protein-containing composition is dispersed in the oil vehicle and, if present, the thickening agent is present in an amount of no more than 10% w/w, preferably no more than 5% w/w, even more preferably no more than 2.5% w/w, even more preferably no more than 2% w/w, most preferably no more than 1% w/w.

37. An agrochemical composition comprising the self-emulsifiable concentrate of claim 21 emulsified in water, and optionally one or more tank mix additives.

38. A method for protecting or treating a plant or a part of the plant from an infection or other biological interaction with a plant pathogen, at least comprising the step of applying directly or indirectly to the plant or to a part of the plant the agrochemical composition of claim 37, under conditions effective to protect or treat the plant or a part of the plant against the infection or biological interaction with the plant pathogen.

39. The method according to claim 38, wherein the agrochemical composition is directly or indirectly applied to the plant or to a part of the plant, optionally postharvest, by spraying, atomizing, foaming, fogging, culturing in hydroculture, culturing in hydroponics, coating, submerging, and/or encrusting.

40. A post-harvest treatment method for protecting or treating a harvested plant or a harvested part of the plant from an infection or other biological interaction with a plant pathogen, at least comprising the step of applying directly or indirectly to the harvested plant or to a harvested part of the plant the agrochemical composition of claim 37, under conditions effective to protect or treat the harvested plant or a harvested part of the plant against the infection or biological interaction with the plant pathogen.


SEQUENCE LISTING (99 sequences)

SEQ ID NO: 1 - protein, 119 aa, synthetic construct
  REGION 1..119: note = Synthetic VHH sequence.
DVQLVESGGGLVQAGGSLRLSCAASRSIFSINAMDWYRQAPGKQREWVAGITRGGTTKYADSVKGRFTISRDNAKKKVYLQMNSLKPEDTAVYYCNVLRGEQPWTRDYWGQGTQVTVSS

SEQ ID NO: 2 - protein, 119 aa, synthetic construct
  REGION 1..119: note = Synthetic VHH sequence.
QVQLVESGGGLVQAGGSLRLSCAASRSIFSINAMDWYRQAPGKQREWVAGITRGGTTKYADSVKGRFTISRDNAKKKVYLQMNSLKPEDTAVYYCNVLRGEQPWTRDYWGQGTQVTVSS

SEQ ID NO: 3 - protein, 10 aa, synthetic construct
  REGION 1..10: note = Synthetic VHH sequence.
RSIFSINAMD

SEQ ID NO: 4 - protein, 9 aa, synthetic construct
  REGION 1..9: note = Synthetic VHH sequence.
GITRGGTTK

SEQ ID NO: 5 - protein, 11 aa, synthetic construct
  REGION 1..11: note = Synthetic VHH sequence.
LRGEQPWTRDY

SEQ ID NO: 6 - protein, 117 aa, synthetic construct
  REGION 1..117: note = Synthetic VHH sequence
QVQLQESGGGLVQAGGSLRLSCAASGTIFRPTAMGWYRQAPGKERELVATITTGGSTKYADSVKGRFTISRGNAKNTVYLQMSSLKPEDTAVYYCNAQWGVRTRDYWGQGTQVTVSS

SEQ ID NO: 7 - protein, 10 aa, synthetic construct
  REGION 1..10: note = Synthetic VHH sequence
GTIFRPTAMG

SEQ ID NO: 8 - protein, 9 aa, synthetic construct
  REGION 1..9: note = Synthetic VHH sequence.
TITTGGSTK

SEQ ID NO: 9 - protein, 9 aa, synthetic construct
  REGION 1..9: note = Synthetic VHH sequence.
QWGVRTRDY

SEQ ID NO: 10 - protein, 126 aa, synthetic construct
  REGION 1..126: note = Synthetic VHH sequence.
QVQLQESGGGLVQAGDSLRLSCAASISDRAFSRHVMGWFRQPPGKEREFVAAIGWTGRRTYYADSVKGRFTISRDNAMNTVYLQMNSLKPEDTAVYYCAASHFYSVSFEINDYDYWGQGTQVTVSS

SEQ ID NO: 11 - protein, 10 aa, synthetic construct
  REGION 1..10: note = Synthetic VHH sequence.
ISDRAFSRHV

SEQ ID NO: 12 - protein, 10 aa, synthetic construct
  REGION 1..10: note = Synthetic VHH sequence.
AIGWTGRRTY

SEQ ID NO: 13 - protein, 15 aa, synthetic construct
  REGION 1..15: note = Synthetic VHH sequence.
SHFYSVSFEINDYDY

SEQ ID NO: 14 - protein, 117 aa, synthetic construct
  REGION 1..117: note = Synthetic VHH sequence.
DVQLQESGGGLVQAGGSLRLSCAASGTIFRPTAMGWYRQAPGKERELVATITTGGSTKYADSVKGRFTISRGNAKNTVYLQMSSLKPEDTAVYYCNAQWGVRTRDYWGQGTQVTVSS

SEQ ID NO: 15 - protein, 126 aa, synthetic construct
  REGION 1..126: note = Synthetic VHH sequence.
DVQLQESGGGLVQAGDSLRLSCAASISDRAFSRHVMGWFRQPPGKEREFVAAIGWTGRRTYYADSVKGRFTISRDNAMNTVYLQMNSLKPEDTAVYYCAASHFYSVSFEINDYDYWGQGTQVTVSS

SEQ ID NO: 16 - protein, 118 aa, synthetic construct
  REGION 1..118: note = VHH sequence 40F07
QVQLQESGGGLVQAGGSLRLSCVASGTTFSSYTMGWYRQAPGKQRELLASIEGGGNTDYADSVKGRFTISRDNARNTVYLQMNSLKTEDTAVYYCNAARTWSIFRNYWGQGTQVTVSS

SEQ ID NO: 17 - protein, 115 aa, synthetic construct
  REGION 1..115: note = VHH sequence 41D01
QVQLQESGGGLVQAGGSLRLSCAASGRTFSRYGMGWFRQLPGKQRELVTSITRGGTTTYADSVKGRFTISRDNAKNTVYLQMNSLKPEDTAVYYCNARSIWRDYWGQGTQVTVSS

SEQ ID NO: 18 - protein, 116 aa, synthetic construct
  REGION 1..116: note = VHH sequence 41D06
QVQLQESGGGLVQAGGSLRLSCAASGGIFGINAMRWYRQAPGKQRELVASISSGGNTNYSESVKGRFTISRDDANYTVYLQMNSLKPEDTAVYYCNFVRLWFPDYWGQGTQVTVSS

SEQ ID NO: 19 - protein, 121 aa, synthetic construct
  REGION 1..121: note = VHH sequence 41G10
QVQLQESGGGLVQPGGSLTLSCAATKTGFSINAMGWYRQAPGKQREMVATITSGGTTNYADSVKGRFAISRDNAKNTVSLQMNTLKPEDTALYYCNTEARRYFTRASQVYWGQGTQVTVSS

SEQ ID NO: 20 - protein, 120 aa, synthetic construct
  REGION 1..120: note = VHH sequence 41H05
QVQLQESGGGLVQPGGSLRLSCAASGGIFSINAMGWYRQDPGKQREMVATITSGANTNYTDSVKGRFTISRDNAKNTVYLQMNSLKPEDTAVYYCNAVGRRWYGGYVELWGQGTQVTVSS

SEQ ID NO: 21 - protein, 119 aa, synthetic construct
  REGION 1..119: note = VHH sequence 42C11
QVQLQESGGGLVQPGGSLRLSCAASGSIFSTYVMGWYRQAIGKQRELVATITSSGKTNYAASVKGRFTVSRDITKNTMYLQMNSLKPEDTAVYYCGADRWVLTRWSNYWGQGTQVTVSS

SEQ ID NO: 22 - protein, 116 aa, synthetic construct
  REGION 1..116: note = VHH sequence 42C12
QVQLQESGGGLVQPGGSLRLSCAASGSISSLGWYRQAPGKQREFVASATSGGDTTYADSVKGRFTISRDNSKNTVYLQMNSLKPEDTAVYYCKGQRGVAWTRKEYWGQGTQVTVSS

SEQ ID NO: 23 - protein, 119 aa, synthetic construct
  REGION 1..119: note = VHH sequence 50D03
QVQLQESGGGLVQPGGSLRLSCAASGSIFSTYAMGWYRQAIGKQRELVATITSSGKTNYAASVKGRFTISRDITKNTMYLQMNSLKPEDTAVYYCGADRWVLTRWSNYWGQGTQVTVSS

SEQ ID NO: 24 - protein, 120 aa, synthetic construct
  REGION 1..120: note = VHH sequence 50D07
QVQLQESGGGLVQPGGSLRLSCTASGNIVNIRDMGWYRQVPGKQRELVATITSDQSTNYADSVKGRFTTTRDNAKKTVYLQMDSLKPEDTAGYYCNARVRTVLRGWRDYWGQGTQVTVSS

SEQ ID NO: 25 - protein, 119 aa, synthetic construct
  REGION 1..119: note = VHH sequence 50E02
QVQLQESGGGLVQPGGSLRLSCAASGSIFSINAMGWYRQAPGKQRELVAAITSDGSTNYADSVKGRFTISRDNAKNTAYLQMNSLKPEDTAVYYCNLRRRTFLKSSDYWGQGTQVTVSS

SEQ ID NO: 26 - protein, 123 aa, synthetic construct
  REGION 1..123: note = VHH sequence 51B08
QVQLQESGGGLVQAGDSLRLSCAASGRRFGSYAMGWFRQVPGKERELVAGISSGGSTKYADSVRGRFTISRDNAKNTVSLQMKSLKPEDTAVYYCNAKYGRWTYTGRPEYDSWGQGTQVTVSS

SEQ ID NO: 27 - protein, 116 aa, synthetic construct
  REGION 1..116: note = VHH sequence 51C06
QVQLQESGGGLVQPGGSLRLSCAASGSIFSSDTMGWYRRAPGKQRELVAAITTGGNTNYADSVKGRFTISRDNAKNTVYLQMNSLQPEDTAVYYCNCRRRWSRDFWGQGTQVTVSS

SEQ ID NO: 28 - protein, 119 aa, synthetic construct
  REGION 1..119: note = VHH sequence 51C08
QVQLQESGGGLVQPGGSLRLSCAASGTIFSIKTMGWYRQAPGKQRELVATISNGGSTNYADSVKGRFTISRDNAKNTVYLQMNSLKPEDTAVYYCNARQQFIGAPYEYWGQGTQVTVSS

SEQ ID NO: 29 - protein, 115 aa, synthetic construct
  REGION 1..115: note = VHH sequence 52A01
QVQLQESGGGLVQAGGSLRLSCTASGAITFSLGTMGWYRQAPGKQRELVASISTGSTNYADSVKGRFTISRDIIKNILYLQMNSLKPEDTAVYSCNARLLWSNYWGQGTQVTVSS

SEQ ID NO: 30 - protein, 117 aa, synthetic construct
  REGION 1..117: note = VHH sequence 52B01
QVQLQESGGGLVQAGESLRLSCAASGSTFSINVMGWYRQAPGEQRELVATISRGGSTNYADSVKGRFTISRDNAKVTVYLQMDSLKPEDTAVYYCNAAGWVGVTNYWGQGTQVTVSS

SEQ ID NO: 31 - protein, 117 aa, synthetic construct
  REGION 1..117: note = VHH sequence 52G05
QVQLQESGGGLVQAGGSLRLSCAASGSTGSISAMGWYRQAPGKQRELVASITRRGSTNYADSVKDRFTISRDNAWNTVYLQMNSLKPEDTAVYYCNARRYYTRNDYWGQGTQVTVSS

SEQ ID NO: 32 - protein, 114 aa, synthetic construct
  REGION 1..114: note = VHH sequence 53A01
QVQLQESGGGLGQAGGSLRLSCEVSGTTFSINTMGWHRQAPGKQRELVASISSGGWTNYADSVKGRFTISRDNAKKTVYLQMNNLKPEDTAVYYCRWGAIGNWYGQGTQVTVSS

SEQ ID NO: 33 - protein, 117 aa, synthetic construct
  REGION 1..117: note = VHH sequence 53F05
QVQLQESGGGLVQPGGSLRLSCAASVRIFGLNAMGWYRQGPGKQRELVASITTGGSTNYAEPVKGRFTISRDNANNTVYLQMNNLKPEDTAVYYCNAERRWGLPNYWGQGTQVTVSS

SEQ ID NO: 34 - protein, 126 aa, synthetic construct
  REGION 1..126: note = VHH sequence 54A02
QVQLQESGGGLVEAGGSLRLSCAASGRTFSRYGMGWFRQAPGKEREFVAANRWSGGSTYYADSVRGRFTISRDNAKNTVYLQMNSLKPEDTAVYYCAAYAHITAWGMRNDYEYDYWGQGTQVTVSS

SEQ ID NO: 35 - protein, 125 aa, synthetic construct
  REGION 1..125: note = VHH sequence 54B01
QVQLQESGGGLVQAGGSLRLSCAATGRTFSRYTMGWFRQAPGKERDFVAGITWTGGSTDYADSVKGRFTISRDNAKNTVYLQMNSLKPEDTAVYYCAAGNLLRLAGQLRRGYDSWGQGTQVTVSS

SEQ ID NO: 36 - protein, 129 aa, synthetic construct
  REGION 1..129: note = VHH sequence 54C01
QVQLQESGGGLVQAGGSLRLSCAASGRTGSRYAMGWFRQAPGKEREFVAAISWSGGSTYYADSVKDRFTISRDNAKNTVYLQMHSLKPEDTAVYYCATRNRAGPHYSRGYTAGQEYDYWGQGTQVTVSS

SEQ ID NO: 37 - protein, 121 aa, synthetic construct
  REGION 1..121: note = VHH sequence 54C04
QVQLQESGGGLVQPGGSLRLSCAASGRIFSINAMGWYRQGPGKERELVVDMTSGGSINYADSVSGRFTISRDNAKNTVYLQMNSLKPEDTAVYYCHANLRTAFWRNGNDYWGQGTQVTVSS

SEQ ID NO: 38 - protein, 115 aa, synthetic construct
  REGION 1..115: note = VHH sequence 54C08
QVQLQESGGGLVQPGGSLRLSCAASGSISSINAMGWYRQAPGKQRELVASITSGGSTNYADSVKGRFTISRDNAKNTVNLQMNSLKPEDTAVYYCSAGPWYRRSWGRGTQVTVSS

SEQ ID NO: 39 - protein, 116 aa, synthetic construct
  REGION 1..116: note = VHH sequence 54C10
QVQLQESGGGLVQPGESLRLSCAASASIFWVNDMGWYRQAPGKQRELVAQITRRGSTNYADSVKGRFTISRDNAKDEVYLQMNSLKPEDTAVYYCNADLAVRGRYWGQGTQVTVSS

SEQ ID NO: 40 - protein, 119 aa, synthetic construct
  REGION 1..119: note = VHH sequence 54C11
QVQLQESGGGLVQPGGSLRLSCAASGSFFPVNDMAWYRQALGNERELVANITRGGSTNYADSVKGRFTISRDNAKNTVYLQMNTLKPEDTAVYYCNVRIGFGWTAKAYWGQGTQVTVSS

SEQ ID NO: 41 - protein, 116 aa, synthetic construct
  REGION 1..116: note = VHH sequence 54D03
QVQLQESGGGLVQPGGSLRLSCAASGGIFGINAMRWYRQAPGKQRELVASISSGGNTNYSESVKGRFTISRDDANYTVYLQMNSLKPEDTAVYYCNFVRLWFPDYWGQGTQVTVSS

SEQ ID NO: 42 - protein, 116 aa, synthetic construct
  REGION 1..116: note = VHH sequence 54D06
QVQLQESGGGLVQPGGSLRLSCAASGSTIRINAMGWYRQAPGKQRELVATITRGGITNYADSVKGRFTISRDNAKFTVYLQMNSLKPEDTAVYYCNARSWVGPEYWGQGTQVTVSS

SEQ ID NO: 43 - protein, 120 aa, synthetic construct
  REGION 1..120: note = VHH sequence 54D10
QVQLQESGGGLVQPGGSLRLSCAASGMTYSIHAMGWYRQAPGKERELVAITSTSGTTDYTDSVKGRFTISRDGANNTVYLQMNSLKSEDTAVYYCHVKTRTWYNGKYDYWGQGTQVTVSS

SEQ ID NO: 44 - protein, 117 aa, synthetic construct
  REGION 1..117: note = VHH sequence 54E01
QVQLQESGGGLVQPGGSLRLSCTASGSIFSINPMGWYRQAPGKQRELVAAITSGGSTNYADYVKGRFTISRDNAKNVVYLQMNSLKPEDTAVYYCNGRSTLWRRDYWGQGTQVTVSS

SEQ ID NO: 45 - protein, 117 aa, synthetic construct
  REGION 1..117: note = VHH sequence 54E05
QVQLQESGGGLVQPGGSLRLSCAASGSIFSINTMGWYRQAPGKQRELVAAITNRGSTNYADFVKGRFTISRDNAKNTVYLQMNSLKPDDTAVYYCNAHRSWPRYDSWGQGTQVTVSS

SEQ ID NO: 46 - protein, 118 aa, synthetic construct
  REGION 1..118: note = VHH sequence 54E10
QVQLQESGGGLVQPGGSLRLSCAASGSIFSFNAMGWYRQAPGKQRELVAAITRGGSTNYADSVKGRFTISRDNANNTVYLQMNSLKPEDTAVYYCNAESRIFRRYDYWGPGTQVTVSS

SEQ ID NO: 47 - protein, 115 aa, synthetic construct
  REGION 1..115: note = VHH sequence 54F01
QVQLQESGGGLVQPGGSLRLSCVTSGSIFGLNLMGWYRQAPGKQRELVATITRGGSTNYADSVKGRFTISRDNAKKTVYLQMNSLKPEDTAVYYCNVDRGWSSYWGQGTQVTVSS

SEQ ID NO: 48 - protein, 119 aa, synthetic construct
  REGION 1..119: note = VHH sequence 54F02
QVQLQESGGGLVQPGGSLRLSCVTSGSIRSINTMGWYRQAPGNERELVATITSGGTTNYADSVKNRFTISRDNAKNTVYLQMNSLKPEDTAVYYCNLHQRAWARSYVYWGQGTQVTVSS

SEQ ID NO: 49 - protein, 117 aa, synthetic construct
  REGION 1..117: note = VHH sequence 54G01
QVQLQESGGGSVQPGGSLRLSCAASGSIFAVNAMGWYRQAPGHQRELVAIISSNSTSNYADSVKGRFTISRDNAKNTVYLQMNSLKPEDTAVYFCYAKRSWFSQEYWGQGTQVTVSS

SEQ ID NO: 50 - protein, 121 aa, synthetic construct
  REGION 1..121: note = VHH sequence 54G08
QVQLQESGGGLVQPGGSLRLSCAASGSIFSFNLMGWYRQAPGKQRELVAAITSSSNTNYADSVKGRFTISRDNAKNTVYLQMNSLKPEDTAVYYCNAQYTITPWGIKKDYWGQGTQVTVSS

SEQ ID NO: 51 - protein, 120 aa, synthetic construct
  REGION 1..120: note = VHH sequence 54G09
QVQLQESGGGLMQPGGSLRLSCTASGNIVNIRDMGWYRQVPGKQRELVATITSDQSTNYADSVKGRFTTTRDNAKKTVYLQMDSLKPEDTAGYYCNARVRTVLRGWRDYWGQGTQVTVSS

SEQ ID NO: 52 - protein, 117 aa, synthetic construct
  REGION 1..117: note = VHH sequence 55B02
QVQLQESGGGLVQPGESLRLSCVGSGSIFNINSMNWYRQASGKQRELVADMRSDGSTNYADSVKGRFTISRDNARKTVYLQMNSLKPEDTAVYYCHANSIFRSRDYWGQGTQVTVSS

SEQ ID NO: 53 - protein, 125 aa, synthetic construct
  REGION 1..125: note = VHH sequence 55B05
QVQLQESGGGVVQAGDSLRLSCAASGRTFGGYTVAWFRQAPGKEREFVARISWSGIMAYYAESVKGRFTISRDNAKNTVYLQMNSLKPEDTAVYYCASRSQIRSPWSSLDDYDRWGQGTQVTVSS

SEQ ID NO: 54 - protein, 116 aa, synthetic construct
  REGION 1..116: note = VHH sequence 55C05
QVQLQESGGGLVQPGGSLRLSCVVSGSISSMKAMGWHRQAPGKERELVAQITRGDSTNYADSVKGRFTISRDNAKNTVYLQMNSLKPDDTGVYYCNADRFFGRDYWGKGTQVTVSS

SEQ ID NO: 55 - protein, 120 aa, synthetic construct
  REGION 1..120: note = VHH sequence 55D08
QVQLQESGGGLVQPGGSLRLSCAASRSILSISAMGWYRQGPGKQREPVATITSAGSSNYSDSVKGRFTISRDNAKNTAYLQMNSLKPEDTAVYYCKTVYSRPLLGPLEVWGQGTQVTVSS

SEQ ID NO: 56 - protein, 115 aa, synthetic construct
  REGION 1..115: note = VHH sequence 55E02
QVQLQESGGGLVQTGGSLRLSCVASGSMFSSNAMAWYRQAPGKQRELVARILSGGSTNYADSVKGRFTISRGNAKNTVYLQMNSLKPEDTAVYYCNAVRYLVNYWGQGTQVTVSS

SEQ ID NO: 57 - protein, 121 aa, synthetic construct
  REGION 1..121: note = VHH sequence 55E07
QVQLQESGGGSVQVGDSLTLSCVASGRSLDIYGMGWFRQAPGKEREFVARITSGGSTYYADSVKGRFTLSRDNAKNTVYLQMNSLKPEDTAVYYCAAGVVVATSPKFYAYWGQGTQVTVSS

SEQ ID NO: 58 - protein, 116 aa, synthetic construct
  REGION 1..116: note = VHH sequence 55E09
QVQLQESGGGLVQAGGSLRLSCAASKRIFSTYTMGWFRQAPGKEREFVAAIIWSGGRTRYADSVKGRFTISRDNARNTVHLQMNSLEPEDTAVYYCYTRRLGTGYWGQGTQVTVSS

SEQ ID NO: 59 - protein, 115 aa, synthetic construct
  REGION 1..115: note = VHH sequence 55E10
QVQLQESGGGLVQAGGSLRLSCAASGSTFSIQTIGWYRQAPGKQRDRVATISSGGSTNYADSVKGRFTISRDNAKKTVYLQMNNLKPEDTAVYYCNLRYWFRDYWGQGTQVTVSS

SEQ ID NO: 60 - protein, 115 aa, synthetic construct
  REGION 1..115: note = VHH sequence 55F04
QVQLQESGGGLVQPGGSLRLSCAASGSTFSINVRGWYRQAPGKQRELVATITSDGSTNYADSVKGRFTISRDNAKNTAYLQMNSLKPEDTAVYYCNAVRLFRQYWGQGTQVTVSS

SEQ ID NO: 61 - protein, 125 aa, synthetic construct
QVQLQESGGGLVQPGGSLRLSCAASGSIFRLNAMGWYRQAPGKQRELVAAITPGGGNTTYADSVKGRFTISRDNALNTIYLQMNSLKPEDTAVYYCNAGGSSRWYSSRYYPGGYWGQGTQVTVSS

SEQ ID NO: 62 - protein, 126 aa, synthetic construct
  REGION 1..126: note = VHH sequence 55F10
QVQLQESGGGLVQAGGSLRLSCATSGGTFSRYAMGWFRQAPGKERELVATIRRSGSSTYYLDSTKGRFTISRDNAKNTVYLQMNSLKLEDTAVYYCAADSSARALVGGPGNRWDYWGQGTQVTVSS

SEQ ID NO: 63 - protein, 118 aa, synthetic construct
  REGION 1..118: note = VHH sequence 55G02
QVQLQESGGGLVQPGGSLRLSCAASGSIGSINVMGWYRQYPGKQRELVAFITSGGITNYTDSVKGRFAISRDNAQNTVYLQMNSLTPEDTAVYYCHLKNAKNVRPGYWGQGTQVTVSS

SEQ ID NO: 64 - protein, 116 aa, synthetic construct
  REGION 1..116: note = VHH sequence 55G08
QVQLQESGGGLVQPGGSLRLSCRASGGIFGINAMRWYRQAPGKQRELVASISSGGTTDYVESVKGRFTISRDNATNTVDLQMSALKPEDTAVYYCNFVRFWFPDYWGQGTQVTVSS

SEQ ID NO: 65 - protein, 116 aa, synthetic construct
  REGION 1..116: note = VHH sequence 56A05
QVQLQESGGGLVQAGGSLRLSCAASGITFMSNTMGWYRQAPGKQRELVASISSGGSTNYADSVKGRFTISRDNAKKTVYLQMNSLKPEDTAVYYCNARRNVFISSWGQGTQVTVSS

SEQ ID NO: 66 - protein, 114 aa, synthetic construct
  REGION 1..114: note = VHH sequence 56A06
QVQLQESGGGLVQPGGSLRLSCVASGSISVYGMGWYRQAPGKQRELVARITNIGTTNYADSVKGRFTISRDNAKNTVYLQMNSLQPEDTAVYYCNLRRLGRDYWGQGTQVTVSS

SEQ ID NO: 67 - protein, 118 aa, synthetic construct
QVQLQESGGGLVQPGGSLRLSCAASRTALRLNSMGWYRQAPGSQRELVATITRGGTTNYADSVKGRFTISREIGNNTVYLQMNSLEPEDTAVYYCNANFGILVGREYWGKGTQVTVSS

SEQ ID NO: 68 - protein, 116 aa, synthetic construct
  REGION 1..116: note = VHH sequence 56C09
QVQLQESGGGLVQAGGSLRLSCAVSGSIFSILSMAWYRQTPGKQRELVANITSVGSTNYADSVKGRFTISRDIAKKTLYLQMNNLKPEDTAIYYCNTRMPFLGDSWGQGTQVTVSS

SEQ ID NO: 69 - protein, 111 aa, synthetic construct
  REGION 1..111: note = VHH sequence 56C12
QVQLQESGGGLVQAGGSLRLSCAVSAFSFSNRAVSWYRQAPGKSREWVASISGIRITTYTNSVKGRFIISRDNAKKTVYLQMNDLRPEDTGVYRCYMNRYSGQGTQVTVSS

SEQ ID NO: 70 - protein, 117 aa, synthetic construct
  REGION 1..117: note = VHH sequence 56D06
QVQLQESGGGSVQPGGSLRLSCAASGTVFFSISAMGWYRQAPGKQRELVAGISRGGSTKYGDFVKGRFTISRDNGKKTIWLQMNNLQPEDTAIYYCRLTSITGTYLWGQGTQVTVSS

SEQ ID NO: 71 - protein, 114 aa, synthetic construct
  REGION 1..114: note = VHH sequence 56D07
QVQLQESGGGLVQPGGSLRLSCAASGSIFSMKVMGWYRQGPGKLRELVAVITSGGRTNYAESVKGRFTISRDNAKNTVSLQMNSLQPEDTAVYYCYYKTIRPYWGQGTQVTVSS

SEQ ID NO: 72 - protein, 120 aa, synthetic construct
  REGION 1..120: note = VHH sequence 56D10
QVQLQESGGGLVQAGGSLRLSCAASGITFRITTMGWYRQAPGKQRELVASSSSGGTTNYASSVKGRFTISRDNAKNTVYLQMNSLRPEDTAVYYCNARKFITTPWSTDYWGQGTQVTVSS

SEQ ID NO: 73 - protein, 116 aa, synthetic construct
  REGION 1..116: note = VHH sequence 56E04
QVQLQESGGGLVQPGDSLRLSCTPSGSIFNHKATGWYRQAPGSQRELVAKITTGGTTNYADSVKGRFTISRDNAKNTVYLQMSSLKPEDTAVYYCNAERYFATTLWGQGTQVTVSS

SEQ ID NO: 74 - protein, 119 aa, synthetic construct
  REGION 1..119: note = VHH sequence 56E05
QVQLQESGGGLVQAGGSLRLSCAASGITFSNNAGGWYRQAPGQQRELVARISSGGNTNYTDSVKGRFTISRDITKNTLSLQMNNLKPEDSAVYYCNAQRRVILGPRNYWGQGTQVTVSS

SEQ ID NO: 75 - protein, 121 aa, synthetic construct
  REGION 1..121: note = VHH sequence 56E08
QVQLQESGGGLVQAGGSLRLSCAASGNIFRINDMGWYRQAPGNQRELVATITSANITNYADSVKGRFTISRDNAKNTVYLQMNSLNPEDTAVYYCTAQAKKWRIGPWSDYWGQGTQVTVSS

SEQ ID NO: 76 - protein, 119 aa, synthetic construct
  REGION 1..119: note = VHH sequence 56F07
QVQLQESGGGLVQPGGSLRLSCAASGRIFSINDMAWYRQAPGKQRELVAIITNDDSTTYADSVKGRFTISRDNAKNTVYLQMNSLKPEDTAVYYCNADINTAIWRRKYWGQGTQVTVSS

SEQ ID NO: 77 - protein, 121 aa, synthetic construct
  REGION 1..121: note = VHH sequence 56F11
QVQLQESGGGLVQSGGSLRLSCVHSKTTFTRNAMGWYRQALGKERELVATITSGGTTNYADSVKGRFTISMDSAKNTVYLQMNSLKPEDTAVYYCNVNTRRIFGGTVREYWGQGTQVTVSS

SEQ ID NO: 78 - protein, 115 aa, synthetic construct
  REGION 1..115: note = VHH sequence 56G07
QVQLQESGGGLVQPGGSLRLSCAVSGSRIFIHDMGWHRQAPGEPRELVATITPFGRRNYSEYVKGRFTVSRDIARNTMSLQMSNLKAEDTGMYYCNVRVNGVDYWGQGTQVTVSS

SEQ ID NO: 79 - protein, 119 aa, synthetic construct
  REGION 1..119: note = VHH sequence 56G08
QVQLQESGGGLVQAGGSLRLSCAISGITFRRPFGISRMGWYRQAPGKERELVATLSRAGTSRYVDSVKGRFTISRDDAKNTLYLQMVSLNPEDTAVYYCYIAQLGTDYWGQGTQVTVSS

SEQ ID NO: 80 - protein, 117 aa, synthetic construct
  REGION 1..117: note = VHH sequence 56G10
QVQLQESGGGLVQAGGSLRLSCVASGITLRMYQVGWYRQAPGKQRELVAEISSRGTTMYADSVKGRFTISRDGAKNIVYLQMNSLEPEDTAVYYCNARAFAFGRNSWGQGTQVTVSS

SEQ ID NO: 81 - protein, 118 aa, synthetic construct
QVQLQESGGGSVQAGGSLRLSCAVSGGTFSNKAMGWYRQSSGKQRALVARISTVGTAHYADSVKGRFTVSKDNAGNTLYLQMNSLKPEDTAVYYCNAQAGRLYLRNYWGQGTQVTVSS

SEQ ID NO: 82 - protein, 119 aa, synthetic construct
  REGION 1..119: note = VHH sequence 56H05
QVQLQESGGGLVQPGESLRLSCVAAASTSITTFNTMAWYRQAPGKQRELVAQINNRDNTEYADSVKGRFIISRGNAKNTSNLQMNDLKSEDTGIYYCNAKRWSWSTGFWGQGTQVTVSS

SEQ ID NO: 83 - protein, 114 aa, synthetic construct
  REGION 1..114: note = VHH sequence 56H07
QVQLQESGGGLVQAGGSLRLSCTASGLTFALGTMGWYRQAPGKQRELVASISTGSTNYADSVKGRFTISRDIIKNILYLQMNSLKPEDTAVYSCNARLWWSNYWGQGTQVTVSS

SEQ ID NO: 84 - protein, 118 aa, synthetic construct
  REGION 1..118: note = VHH sequence 56H08
QVQLQESGGGLVQAGGSLRLSCTASGRTSSVNPMGWYRQAPGKQRELVAVISSDGSTNYADSVKGRFTVSRDNAKNTLYLQMNSLKPEDTAVYYCNANRRWSWGSEYWGQGTQVTVSS

SEQ ID NO: 85 - protein, 119 aa, synthetic construct
  REGION 1..119: note = VHH sequence 57A06
QVQLQESGGGLVQAGGSLRLSCAASGITFTNNAGGWYRQAPGQQRELVARISSGGNTNYTDSVKGRFTISRDITKNTLSLQMNNLKPEDSAVYYCNAQRRVILGPRNYWGQGTQVTVSS

SEQ ID NO: 86 - protein, 116 aa, synthetic construct
  REGION 1..116: note = VHH sequence 57B01
QVQLQESGGGLVQAGGSLRLSCEAPVSTFNINAMAWYRQAPGKSRELVARISSGGSTNYADSVKGRFTISRDNAKNTVYLQMNSLKPEDTAVYICYVNRHWGWDYWGQGTQVTVSS

SEQ ID NO: 87 - protein, 122 aa, synthetic construct
  REGION 1..122: note = VHH sequence 57B07
QVQLQESGGGLVQPGGTLRLSCVASGSFRSINAMGWYRQAPGKQRELVATVDSGGYTNYADSVKGRFTISRDNAKNTVYLQMSSLTPEDTAVYYCYAGIYKWPWSVDARDYWGQGTQVTVSS

SEQ ID NO: 88 - protein, 117 aa, synthetic construct
  REGION 1..117: note = VHH sequence 57B11
QVQLQESGGGLVQAGGSLRLSCAASGSSISMNSMGWYRQAPGKERERVALIRSSGGTYYADSVKGRFTISRDNAKNTVYLQMNNLKPEDTAVYYCQARRTWLSSESWGQGTQVTVSS

SEQ ID NO: 89 - protein, 122 aa, synthetic construct
  REGION 1..122: note = VHH sequence 57C07
QVQLQESGGGLVQAGGSLRLSCAVSGSTFGINTMGWYRQAPEKQRELVASISRGGMTNYADSVKGRFIISRDNAKNTVYLQMNSLKPEDTAVYVCNAGIRSRWYGGPITTYWGQGTQVTVSS

SEQ ID NO: 90 - protein, 121 aa, synthetic construct
  REGION 1..121: note = VHH sequence 57C09
QVQLQESGGGLVQAGGSLRLSCAASGSTGSINAMGWYRQGPGKQRDLVASISSGGATNYADSVKGRFTISRDNSKNTVYLQMSSLKPEDTAVYYCNAKKSRWSWSIVHDYWGQGTQVTVSS

SEQ ID NO: 91 - protein, 118 aa, synthetic construct
  REGION 1..118: note = VHH sequence 57D02
QVQLQESGGGSVQTGGSLTLSCTTSGSIFGRSDMGWYRQAPGKQRELVATITRRSRTNYAEFVKGRFTISRDSAKNLVTLQMNSLKPEDTNVYYCNARWGAGGIFSTWGQGTQVTVSS

SEQ ID NO: 92 - protein, 120 aa, synthetic construct
  REGION 1..120: note = VHH sequence 57D09
QVQLQESGGGLVQPGESLRLSCAASGSMSIDAMGWYRQAPGDQRELVASITTGGSTNYADSVKGRFTISRDNAKNTVWLQMNSLKPEDTAVYYCNAKVRLRWFRPPSDYWGQGTQVTVSS

SEQ ID NO: 93 - protein, 122 aa, synthetic construct
  REGION 1..122: note = VHH sequence 57D10
QVQLQESGGGLVQPGGSLRLSCAASGRLLSISTMGWYRRTPEDQREMVASITKDGTTNYADSVKGRLTISRDNAKNTVYLQMNSLKPDDTAVYVCNARATTWVPYRRDAEFWGQGTQVTVSS

SEQ ID NO: 94 - protein, 120 aa, synthetic construct
  REGION 1..120: note = VHH sequence 57E07
QVQLQESGGGLVQAGGSLRLSCAASGSIFGINDMGWYRQAPGKQRDLVADITRSGSTHYVDSVKGRFTISRDNAKNTVYLQMNSLKPEDTAVYYCNADSGSHWWNRRDYWGQGTQVTVSS

SEQ ID NO: 95 - protein, 118 aa, synthetic construct
  REGION 1..118: note = VHH sequence 57E11
QVQLQESGGGLVQPGGSLKLSCAASGFTFSINTMGWYRQAPGKQRELVARISRLRVTNYADSVKGRFTISRDNAKNTVYLQMNSLKPEDTAVYYCNAANWGLAGNEYWGQGTQVTVSS

SEQ ID NO: 96 - protein, 116 aa, synthetic construct
  REGION 1..116: note = VHH sequence 57G01
QVQLQESGGGLVQAGGSLRPSCTASGSTLLINSMGWYRQAPGKQRELVATISNSGTTNYVDAVKGRFAISRDNANHTVYLQMNSLEPEDTAVYYCNAQTFWRRNYWGQGTQVTVSS

SEQ ID NO: 97 - protein, 116 aa, synthetic construct
  REGION 1..116: note = VHH sequence 57G07
QVQLQESGGGLVQAGGSLRLSCAVSGSTSRINAMGWYRQAPGKKRESVATIRRGGNTKYADSVKGRFTISRDNANNTVYLQLNSLKPEDTAVYYCNAHSWLDYDYWGRGTQVTVSS

SEQ ID NO: 98 - protein, 114 aa, synthetic construct
  REGION 1..114: note = VHH sequence 57G08
QVQLQESGGGLVQAGGSLRLSCASRRRINGITMGWYRQAPGKQRELVATIDIHNSTKYADSVKGRFIISRDNGKSMLYLQMNSLKPEDTAVYYCNRIPTFGRYWGQGTQVTVSS

SEQ ID NO: 99 - protein, 118 aa, synthetic construct
  REGION 1..118: note = VHH sequence 57H08
QVQLQESGGGLVQAGGSLRLSCVASGSTFYTFSTKNVGWYRQAPGKQRELVAQQRYDGSTNYADSLQGRFTISRDNAKRTVYLQMNSLKPEDTAVYICNVNRGFISYWGQGTQVTVSS